(19) United States
(12) Patent Application Publication
(10) Pub. No.: US 2026/0024708 A1
(43) Pub. Date: Jan. 22, 2026

(54) METHOD FOR IMPROVING PERFORMANCE OF CAPACITORS AND CAPACITORS PRODUCED THEREBY

(71) Applicant: The Research Foundation for The State University of New York, Binghamton, NY (US)

(72) Inventors: Tara Prasad Dhakal, Vestal, NY (US); James N. Turner, Vestal, NY (US); Mahesh Nepal, Vestal, NY (US); Wendifer Reyes Ramos, Binghamton, NY (US)

(21) Appl. No.: 19/275,953

(22) Filed: Jul. 21, 2025

Related U.S. Application Data
(60) Provisional application No. 63/673,771, filed on Jul. 21, 2024.

(51) Int. Cl. H01G 11/26; H01G 11/36; H01G 11/86

(52) U.S. Cl. CPC H01G 11/26; H01G 11/36; H01G 11/86

(57) ABSTRACT

A capacitor comprising a nanostructured conductive electrode, having a 3D surface area at least 10 times a planar area of the nanostructured conductive electrode, a counter-electrode, a dielectric layer disposed between the nanostructured conductive electrode and the counter-electrode conformed to the nanostructured conductive material, and a stabilizing film adjacent to the dielectric layer, comprising a plurality of different layers formed by atomic layer deposition, including an insulating layer type and a semiconducting layer type. The stabilizing layer increases a breakdown voltage of the capacitor, without significantly altering the capacitance. The stabilizing layer comprises doublets of atomic layer deposition films insulating and/or semiconductive films having closely matched Gibbs free energy.

### CROSS REFERENCE TO RELATED APPLICATIONS

The present application is a non-provisional of, and claims benefit of priority under 35 U.S.C. § 119(c) from U.S. Provisional Patent Application No. 63/673,771, filed Jul. 21, 2024, the entirety of which is expressly incorporated herein by reference.

### STATEMENT REGARDING FEDERALLY SPONSORED RESEARCH OR DEVELOPMENT

The invention was made with U.S. government support under NSF contract number 2016481. The U.S. government has certain rights in the invention.

### FIELD OF THE INVENTION

The present invention relates to the field of stabilization of dielectric films in electrical devices, and more particularly to solid state capacitors and electronic devices.

### INCORPORATION BY REFERENCE AND INTERPRETATION OF LANGUAGE

Citation or identification of any reference herein, in any section of this application, shall not be construed as an admission that such reference is necessarily available as prior art to the present application. The disclosures of each reference disclosed herein, whether U.S. or foreign patent literature, or non-patent literature, are hereby incorporated by reference in their entirety, and shall be treated as if the entirety thereof forms a part of this application.

All cited or identified references are provided for their disclosure of technologies to enable practice of the present invention, to provide basis for claim language, and to make clear applicant's possession of the invention with respect to the various aggregates, combinations, and subcombinations of the respective disclosures or portions thereof (within a particular reference or across multiple references). The citation of references is intended to be part of the disclosure of the invention, and not merely supplementary background information. The express teachings in this specification shall override inconsistent teachings of incorporated references, which may provide evidence of a proper interpretation by persons of ordinary skill in the art of the terms, phrase and concepts discussed herein, without being limiting as the sole interpretation available.

The present specification is not to be interpreted by recourse to lay dictionaries in preference to field-specific dictionaries or usage. Where a conflict of interpretation exists, the hierarchy of resolution shall be the express specification, references cited for propositions, incorporated references, the inventors' prior publications relating to the field, academic literature in the field, commercial literature in the field, field-specific dictionaries, lay literature in the field, and general-purpose dictionaries.

### BACKGROUND OF THE INVENTION

Capacitors are a fundamental component of all electronic circuitry, and very large numbers of them are required across the electronics industry, e.g. each cell phone has over 400 capacitors. Electronics has revolutionized our world and further advances sought tied to improved performance, increased miniaturization, and process integration. The disclosed capacitors satisfy these general requirements using common materials as opposed to rare or strategic materials.

Supercapacitors are devices with high power density, moderate energy density, and long, stable life. These properties position these devices to replace or complement batteries to store and deliver electrical energy for use in electrical circuits, alone or as part of hybrid battery/capacitor devices. Supercapacitors can also serve as discrete components in electronic circuits of all types because of their small footprint. However, most supercapacitors lack sufficient energy density (i.e., per unit volume, per unit projected area, per unit mass) to work in many applications. Batteries therefore remain the most reliable source of stored energy.

See, Ahmad, Farooq, Muhammad Zahid, Huma Jamil, Muhammad Ahmed Khan, Shahid Atiq, Mubashira Bibi, Kanwal Shahbaz et al. “Advances in graphene-based electrode materials for high-performance supercapacitors: a review.” Journal of Energy Storage 72 (2023): 108731.

Capacitance (C), a fundamental quantity that determines the strength of a capacitor, can be expressed using the formula C=(ε×A)/d, where ε is the permittivity of the dielectric material between the capacitor electrodes, A is the area of the electrodes, and d is the thickness of dielectric material. This formula highlights the geometric and material properties influencing capacitance, emphasizing the significance of dielectric permittivity, surface area, and dielectric thickness in determining the overall capacitance of a capacitor.

In general, the energy density and the power density of energy storage devices are two crucial characteristics used to evaluate the effectiveness of the devices. Both the energy density and the power density relate to these parameters, which can be determined by using Eqs. (1) and (2), respectively.

$${E}_{d} = 1 / 2 {CV}^{2} \qquad ( 1 )$$

$${P}_{d} = {V}^{2} / 4 {R}_{s} \qquad ( 2 )$$

E_{d} and P_{d} are the energy and power densities, C is the capacitance, V is the effective voltage range, and Rₛ is the equivalent series resistance (ESR) of two conductors. These two equations suggest that the two variables E_{d} and P_{d} are influenced by three significant factors: “C,” “V,” and “Rₛ”.

Typical capacitors have a two-dimensional (2D) structure, with planar layers of electrodes and dielectric.

In addition to providing continuous channels to ensure excellent interaction with the electrolyte, a three-dimensional (3D) structure with well-interconnected pores speeds up charge transfer by decreasing the diffusion paths. The 3D wires have numerous advantages: (a) supplying a large effective surface area in a small volume, (b) decreasing the ion diffusion length between electrodes, (c) easing the transit of ions and electrons, and (d) enhancing the cycle stability of the electrodes. Ciszewski et al. made carbon aerogels with graphene, graphene oxide (GO), and carbon nanotube (CNT) modifications using resorcinol-formaldehyde as a base. It showed that specific capacitance could be significantly improved by incorporating graphene-like organized mass into conventional carbon aerogel.

Capacitors, with ceramic capacitors like Multi-Layer Ceramic Capacitors (MLCCs) at the forefront, are essential components in electronic circuits, serving to store and release electrical energy. MLCCs, in particular, are widely employed due to their compact size, high capacitance values, and low equivalent series resistance (ESR). Their applications span diverse industries, from consumer electronics to automotive systems, providing crucial roles in filtering, decoupling, and voltage regulation.

Advances in capacitor technology aim to replicate the energy density of batteries. However, no capacitor has yet to exhibit capacitance high enough to match the energy density of batteries or have other appropriate properties, like breakdown voltage, necessary to replace battery storage. Thin-film capacitors that use materials with high dielectric constant (k) (e.g., TiO₂, ZrO₂, HfO₂ and Al₂O₃), for example, may only achieve areal energy densities in a range of from 10 J/cm³ to 60 J/cm³. Material combinations, like TiO₂/Al₂O₃, show promise because of the enhanced dielectric constant, and energy density. Other materials, including ceramics like CaCu₃Ti₄O₁₂ (“CCTO”), also tend to exhibit very high dielectric constant (k), on the order of ˜10⁴ at room temperature. But these materials still suffer from high leakage current (or “losses’) that result in breakdown voltages far too low for the device to operate as a viable replacement for batteries or for many circuit applications.

Using supercapacitors can facilitate the integration of renewable energy sources, such as solar and wind, into the power grid. Excess energy generated during high renewable energy production periods can be stored and subsequently released during times of high demand. This facilitates the mitigation of the intermittency associated with renewable energy sources and improves the electrical grid's stability. It is essential that although supercapacitors based on graphene possessed several benefits, there still remain some obstacles to surmount, including scalability, cost efficiency, and mass production. Nevertheless, current activities in research and development are concentrated on resolving these concerns and revealing the complete capability of supercapacitors based on graphene in diverse applications. See:
A. I. Abdel-Salam, S. Y. Attia, S. G. Mohamed, F. I. El-Hosiny, M. A. Sadek, M. M. Rashad, “Designing a hierarchical structure of nickel-cobalt-sulfide decorated on electrospun N-doped carbon nanofiber as an efficient electrode material for hybrid supercapacitors”, Int. J. Hydrog. Energy, 48 (2023), pp. 5463-5477
A. Afif, S. M. Rahman, A. Tasfiah Azad, J. Zaini, M. A. Islam, A. K. Azad, “Advanced materials and technologies for hybrid supercapacitors for energy storage-a review”, J. Energy Storage, 25 (2019), Article 100852
A. Borenstein, O. Hanna, R. Attias, S. Luski, “Carbon-based composite materials for supercapacitor electrodes: a review”, J. Mater. Chem. A Mater. Energy Sustain., 5 (2017), pp. 12653-12672
V. Chabot, D. Higgins, A. Yu, X. Xiao, “Environmental Science Material Synthesis and Applications to Energy and”, “(2014), pp. 1564-1596, 10.1039/c3cc43385d
S. H. Choi, S. J. Yun, Y. S. Won, C. S. Oh, S. M. Kim, K. K. Kim, Y. H. Lee, “Large-scale synthesis of graphene and other 2D materials towards industrialization”, Nat. Commun., 13 (2022), pp. 1-5
F. Hennrich, S. Lebedkin, S. Malik, J. Tracy, M. Barczewski, H. Rösner, M. Kappes, “Preparation, characterization and applications of free-standing single walled carbon nanotube thin films”, Phys. Chem. Chem. Phys., 4 (2002), pp. 2273-2277
Q. Ke, J. Wang, “Graphene-based materials for supercapacitor electrodes-a review”, J. Mater., 2 (2016), pp. 37-54
J. Lee, S. Kim, J. Yoon, J. Jang, L. E. E. E. T. Al, “Chemical Vapor Deposition of Mesoporous Graphene Nanoballs for Supercapacitor”, (2013), pp. 6047-6055
B. C. Liu, F. Li, L. Ma, H. Cheng, “Advanced Materials for Energy Storage”, (2010), pp. 28-62
L. Liu, H. Zhao, Y. Lei, “Advances on three-dimensional electrodes for micro-supercapacitors: a mini-review”, (2019) 74-84.
K. Poonam, A. Sharma, S. K. Arora, “Tripathi, review of supercapacitors: materials and devices”, J. Energy Storage, 21 (2019), pp. 801-825
M. D. Stoller, C. W. Magnuson, Y. Zhu, S. Murali, J. W. Suk, R. Piner, R. S. Ruoff, “Interfacial capacitance of single layer graphene”, Energy Environ. Sci., 4 (2011), pp. 4685-4689
B. Zhao, D. Chen, X. Xiong, B. Song, R. Hu, Q. Zhang, B. H. Rainwater, G. H. Waller, D. Zhen, Y. Ding, Y. Chen, C. Qu, D. Dang, C. P. Wong, M. Liu, “A high-energy, long cycle-life hybrid supercapacitor based on graphene composite electrodes”, Energy Storage Mater., 7 (2017), pp. 32-39
H. C. Youn, S. H. Park, K. C. Roh, K. B. Kim, “Highly dispersible surface-unzipped multi-walled carbon nanotubes as binder-free electrodes for supercapacitor applications”, Curr. Appl. Phys., 15 (2015), pp. S21-S26
M. Liu, K. Zhang, M. Si, H. Wang, L. Chai, “Three-dimensional carbon nanosheets derived from micro-morphologically regulated biomass for ultrahigh-performance supercapacitors”, Carbon N. Y., 153 (2019), pp. 707-716
S. Zhang, L. Sui, H. Dong, W. He, L. Dong, L. Yu “High-performance supercapacitor of graphene quantum dots with uniform sizes”, ACS Appl. Mater. Interfaces, 10 (2018), pp. 12983-12991
E. Somesht, T. Demappa, “Tailoring of ternary nanocomposite films of poly (vinyl alcohol)/AgAlO2 @ reduced graphene oxide: an active material for flexible supercapacitors”, J. Solid State Chem., 309 (2022), Article 122824
Y. Liu, B. Soucaze-Guillous, P.-L. Taberna, P. Simon, Understanding of carbon-based supercapacitors ageing mechanisms by electrochemical and analytical methods. J. Power Sources 366, 123-130 (2017). doi.org/10.1016/j.jpowsour.2017.08.104
J. R. Miller, P. Simon, Materials science. Electrochemical capacitors for energy management. Science 321, 651-652 (2008). doi.org/10.1126/science.1158736
P. Simon, Y. Gogotsi, Materials for electrochemical capacitors. Nat. Mater. 7, 845-854 (2008). doi.org/10.1038/nmat2297
V. Augustyn, P. Simon, B. Dunn, Pseudocapacitive oxide materials for high-rate electrochemical energy storage. Energy Environ. Sci. 7, 1597-1614 (2014). doi.org/10.1039/c3ee44164d
N. Jabeen, A. Hussain, Q. Xia, S. Sun, J. Zhu, H. Xia, High-performance 2.6 V aqueous asymmetric supercapacitors based on in situ formed Na0.5Mn02 nanosheet assembled nanowall arrays. Adv. Mater. 29, 1700804 (2017). doi.org/10.1002/adma.201700804
W. Wei, X. Cui, W. Chen, D. G. Ivey, Manganese oxide-based materials as electrochemical supercapacitor electrodes. Chem. Soc. Rev. 40, 1697-1721 (2011). doi.org/10.1039/c0cs00127a
Y. Wu, Y. Yang, X. Zhao, Y. Tan, Y. Liu, Z. Wang, F. Ran, A novel hierarchical porous 3D structured vanadium nitride/carbon membranes for high-performance supercapacitor negative electrodes. Nano-Micro Lett. 10, 63 (2018). doi.org/10.1007/s40820-018-0217-1
L. L. Zhang, X. S. Zhao, Carbon-based materials as supercapacitor electrodes. Chem. Soc. Rev. 38, 2520-2531 (2009). doi.org/10.1039/b813846j
D. Landolt, Electrodeposition science and technology in the last quarter of the twentieth century. J. Electrochem. Soc. 149, S9 (2002). doi.org/10.1149/1.1469028
I. M. Dharmadasa, J. Haigh, Strengths and advantages of electrodeposition as a semiconductor growth technique for applications in macroelectronic devices. J. Electrochem. Soc. 153, G47-G52 (2006). doi.org/10.1149/1.2128120
M. F. Montemor, S. Eugénio, N. Tuyen, R. P. Silva, T. M. Silva, M. J. Carmezim, Nanostructured Transition Metal Oxides Produced by Electrodeposition for Application as Redox Electrodes for Supercapacitors (Springer, Berlin, 2016), pp. 681-714. doi.org/10.1007/978-3-319-15266-0_14
J. Wang, K. K. Manga, Q. Bao, K. P. Loh, High-yield synthesis of few-layer graphene flakes through electrochemical expansion of graphite in propylene carbonate electrolyte. J. Am. Chem. Soc. 133, 8888-8891 (2011). doi.org/10.1021/ja203725d
W. Chen, R. B. Rakhi, L. Hu, X. Xie, Y. Cui, H. N. Alshareef, High-performance nanostructured supercapacitors on a sponge. Nano Lett. 11, 5165-5172 (2011). doi.org/10.1021/n12023433
X. Lang, A. Hirata, T. Fujita, M. Chen, Nanoporous metal/oxide hybrid electrodes for electrochemical supercapacitors. Nat. Nanotechnol. 6, 232-236 (2011). doi.org/10.1038/nnano.2011.13
T. Liu, Y. Ling, Y. Yang, L. Finn, E. Collazo, T. Zhai, Y. Tong, Y. Li, Investigation of hematite nanorod-nanoflake morphological transformation and the application of ultrathin nanoflakes for electrochemical devices. Nano Energy 12, 169-177 (2015). doi.org/10.1016/j.nanoen.2014.12.023

In surface science, surface energy (also interfacial free energy or surface free energy) quantifies the disruption of intermolecular bonds that occurs when a surface is created. In solid-state physics, surfaces must be intrinsically less energetically favorable than the bulk of the material (the atoms on the surface have more energy compared with the atoms in the bulk), otherwise there would be a driving force for surfaces to be created, removing the bulk of the material (e.g., sublimation). The surface energy may therefore be defined as the excess energy at the surface of a material compared to the bulk, or it is the work required to build an area of a particular surface. Another way to view the surface energy is to relate it to the work required to cut a bulk sample, creating two surfaces. There is “excess energy” as a result of the now-incomplete, unrealized bonding between the two created surfaces. See, en.wikipedia.org/wiki/Surface_energy

Calculation of surface energy from first principles (for example, density functional theory) is an approach to measurement. Surface energy is estimated from the following variables: width of the d-band, the number of valence d-electrons, and the coordination number of atoms at the surface and in the bulk of the solid.

The presence of an interface influences generally all thermodynamic parameters of a system. There are two models that are commonly used to demonstrate interfacial phenomena: the Gibbs ideal interface model and the Guggenheim model. In order to demonstrate the thermodynamics of an interfacial system using the Gibbs model, the system can be divided into three parts: two immiscible liquids with volumes Vα and Vβ and an infinitesimally thin boundary layer known as the Gibbs dividing plane (σ) separating these two volumes.

All extensive quantities of the system can be written as a sum of three components: bulk phase α, bulk phase β, and the interface σ. Some examples include internal energy U, the number of molecules of the i^{th} substance nᵢ, and the entropy S. While these quantities can vary between each component, the sum within the system remains constant. At the interface, these values may deviate from those present within the bulk phases. Surface energy comes into play in wetting phenomena. To examine this, consider a drop of liquid on a solid substrate. If the surface energy of the substrate changes upon the addition of the drop, the substrate is said to be wetting.

The most commonly used surface modification protocols are plasma activation, wet chemical treatment, including grafting, and thin-film coating. Surface energy mimicking is a technique that enables merging the device manufacturing and surface modifications, including patterning, into a single processing step using a single device material. See:
Marshall, S. J.; Bayne, S. C.; Baier, R.; Tomsia, A. P.; Marshall, G. W. (2010). “A review of adhesion science”. Dental Materials. 26 (2): e11-e16. doi: 10.1016/j.dental.2009.11.157. PMID 20018362.
Laurén, S. “How To Measure Surface Free Energy?”. blog.biolinscientific.com. Biolin Scientific. Retrieved 2019 Dec. 31.
“Surface Free Energy: Measurements”. biolinscientific.com. Biolin Scientific. Retrieved 2019 Dec. 31.
Woodruff, D. P., ed. (2002). The Chemical Physics of Solid Surfaces. Vol. 10. Elsevier.[ISBN missing]
Contact Mechanics and Friction: Physical Principles and Applications. Springer. 2017. ISBN 9783662530801.
Popov, V. L.; Pohrt, R.; Li, Q. (September 2017). “Strength of adhesive contacts: Influence of contact geometry and material gradients”. Friction. 5 (3): 308-325.doi: 10.1007/s40544-017-0177-3.
Dept. of System Dynamics and Friction Physics (Dec. 6, 2017). “Science friction: Adhesion of complex shapes”. YouTube. Archived from the original on 2021 Dec. 12. Retrieved 2018 Jan. 28.
Owens, D. K.; Wendt, R. C. (1969). “Estimation of the Surface Free Energy of Polymers”. Journal of Applied Polymer Science. 13 (8): 1741-1747. doi: 10.1002/app.1969.070130815.
Wicks, Z. W. (2007). Organic Coatings: Science and Technology (3rd ed.). New York: Wiley Interscience. pp. 435-441.[ISBN missing]
Tracton, A. A. (2006). Coatings Materials and Surface Coatings (3rd ed.). Florida: Taylor and Francis Group. pp. 31-6-31-7.[ISBN missing]
Rhee, S.-K. (1977). “Surface energies of silicate glasses calculated from their wettability data”. Journal of Materials Science. 12 (4): 823-824. Bibcode: 1977JMatS..12..823R. doi: 10.1007/BF00548176. S2CID 136812418.
Udin, H. (1951). “Grain Boundary Effect in Surface Tension Measurement”. JOM. 3 (1): 63. Bibcode: 1951JOM.....3a..63U. doi: 10.1007/BF03398958.
Gilman, J. J. (1960). “Direct Measurements of the Surface Energies of Crystals”. Journal of Applied Physics. 31 (12): 2208. Bibcode: 1960JAP....31.2208G. doi: 10.1063/1.1735524.

Butt, H.-J.; Graf, Kh.; Kappl, M. (2006). Physics and Chemistry of Interfaces. Weinheim: Wiley-VCH.

Atomic layer deposition (ALD) is a thin-film deposition technique based on the sequential use of a gas-phase chemical process; it is a subclass of chemical vapor deposition (CVD). The majority of ALD reactions use two chemicals called precursors (also called “reactants”). These precursors react with the surface of a material one at a time in a sequential, self-limiting, manner. A thin film is slowly deposited through repeated exposure to separate precursors. ALD is a key process in fabricating semiconductor devices, and part of the set of tools for synthesizing nanomaterials. en.wikipedia.org/wiki/Atomic_layer_deposition

During ALD, a film is grown on a substrate by exposing its surface to alternate gaseous species (typically referred to as precursors or reactants). In contrast to CVD, the precursors are never present simultaneously in the reactor, but they are inserted as a series of sequential, non-overlapping pulses. In each of these pulses the precursor molecules react with the surface in a self-limiting way, so that the reaction terminates once all the available sites on the surface are consumed. Consequently, the maximum amount of material deposited on the surface after a single exposure to all of the precursors (a so-called ALD cycle) is determined by the nature of the precursor-surface interaction. By varying the number of cycles it is possible to grow materials uniformly and with high precision on arbitrarily complex and large substrates.

ALD is a deposition method with great potential for producing very thin, conformal films with control of the thickness and composition of the films possible at the atomic level. Some variants deviate from an ideal ALD process. The sister technique of atomic layer deposition, molecular layer deposition (MLD), uses organic precursors to deposit polymers. By combining the ALD/MLD techniques, it is possible to make highly conformal and pure hybrid films for many applications. Another technology related to ALD is sequential infiltration synthesis (SIS) which uses alternating precursor vapor exposures to infiltrate and modify polymers. SIS is also referred to as vapor phase infiltration (VPI) and sequential vapor infiltration (SVI).

In a prototypical ALD process, a substrate is exposed to two reactants A and B in a sequential, non-overlapping way. In contrast to other techniques such as chemical vapor deposition (CVD), where thin-film growth proceeds on a steady-state fashion, in ALD each reactant reacts with the surface in a self-limited way: the reactant molecules can react only with a finite number of reactive sites on the surface. Once all those sites have been consumed in the reactor, the growth stops. The remaining reactant molecules are flushed away and only then reactant B is inserted into the reactor. By alternating exposures of A and B, a thin film is deposited.

Thermal ALD requires temperatures ranging from room temperature (˜20° C.) to 350° C. for ligand exchange or combustion type surface reactions. It occurs through surface reactions, which enables accurate thickness control, no matter the substrate geometry (subject to aspect ratio) and reactor design.

The synthesis of Al₂O₃ from trimethylaluminum (TMA) and water is one of the best-known thermal ALD examples. During the TMA exposure, TMA dissociatively chemisorbs on the substrate surface and any remaining TMA is pumped out of the chamber. The dissociative chemisorption of TMA leaves a surface covered with AlCH₃. The surface is then exposed to H₂O vapor, which reacts with the surface —CH₃ forming CH₄ as a reaction byproduct and resulting in a hydroxylated Al₂O₃ surface.

In plasma-assisted ALD (PA-ALD), the high reactivity of the plasma species allows reduction of the deposition temperature without compromising the film quality; also, a wider range of precursors can be used and thus a wider range of materials can be deposited as compared to thermal ALD.

In photo assisted ALD, UV light is used to accelerate surface reactions on the substrate. Hence reaction temperature can be reduced, as in plasma-assisted ALD. As compared to plasma-assisted ALD, the activation is weaker, but is often easier to control by adjusting the wavelength, intensity and timing of illumination.

Copper metal ALD has attracted much attention due to the demand for copper as an interconnect material and the relative ease by which copper can be deposited thermally. Copper has a positive standard electrochemical potential and is the most easily reduced metal of the first-row transition metals. Thus, numerous ALD processes have been developed, including several using hydrogen gas as the coreactant. Ideally, copper metal ALD should be performed at ≤100° C. to achieve continuous films with low surface roughness, since higher temperatures can result in agglomeration of deposited copper. Some metals can be grown by ALD via fluorosilane elimination reactions using a metal halide and a silicon precursor (e.g. SiH_{4,} Si₂H₆) as the reactants. These reactions are very exothermic due to the formation of stable Si—F bonds. Metals deposited by fluorosilane elimination include tungsten and molybdenum.

Without catalysts, surface reactions leading to the formation of SiO₂ are generally slow and only occur at high temperatures. Typical catalysts for SiO₂ ALD include Lewis bases such as NH₃ or pyridine and SiO₂; ALD can also be initiated when these Lewis bases are coupled with other silicon precursors such as tetraethoxysilane (TEOS). Hydrogen bonding is believed to occur between the Lewis base and the SiOH* surface species or between the H₂O based reactant and the Lewis base. Oxygen becomes a stronger nucleophile when the Lewis base hydrogen bonds with the SiOH* surface species because the SiO—H bond is effectively weakened. As such, the electropositive Si atom in the SiCl₄ reactant is more susceptible to nucleophilic attack. Similarly, hydrogen bonding between a Lewis base and an H₂O reactant make the electronegative O in H₂O a strong nucleophile that is able to attack the Si in an existing SiCl* surface species. The use of a Lewis base catalyst is more or less a requirement for SiO₂ ALD, as without a Lewis base catalyst, reaction temperatures must exceed 325° C. and pressures must exceed 103 torr. Generally, the most favorable temperature to perform SiO₂ ALD is at 32° C. and a common deposition rate is 1.35 angstroms per binary reaction sequence.

ALD is a useful process for the fabrication of microelectronics due to its ability to produce accurate thicknesses and uniform surfaces in addition to high quality film production using various different materials. In microelectronics, ALD is studied as a potential technique to deposit high-K (high permittivity) gate oxides, high-K memory capacitor dielectrics, ferroelectrics, and metals and nitrides for electrodes and interconnects.

Deposition of the high-K oxides Al₂O₃, ZrO₂, and HfO₂ has been one of the most widely examined areas of ALD. The motivation for high-k oxides comes from the problem of high tunneling current through the commonly used SiO₂ gate dielectric in MOSFETs when it is downscaled to a thickness of 1.0 nm and below. With the high-k oxide, a thicker gate dielectric can be made for the required capacitance density, thus the tunneling current can be reduced through the structure.

Transition-metal nitrides, such as TiN and TaN, find potential use both as metal barriers and as gate metals. Metal barriers are used to encase the copper interconnects used in modern integrated circuits to avoid diffusion of Cu into the surrounding materials, such as insulators and the silicon substrate, and also, to prevent Cu contamination by elements diffusing from the insulators by surrounding every Cu interconnect with a layer of metal barriers. The metal barriers have strict demands: they should be pure, dense, conductive, conformal, thin, and have good adhesion towards metals and insulators. The requirements concerning process technique can be fulfilled by ALD.

DRAM capacitors are yet another application of ALD. An individual DRAM cell can store a single bit of data and consists of a single MOS transistor and a capacitor. Major efforts are being put into reducing the size of the capacitor which will effectively allow for greater memory density. In order to change the capacitor size without affecting the capacitance, different cell orientations are being used. Some of these include stacked or trench capacitors. With the emergence of trench capacitors, the problem of fabricating these capacitors comes into play, especially as the size of semiconductors decreases. ALD allows trench features to be scaled to beyond 100 nm. The ability to deposit single layers of material allows for a great deal of control over the material. Except for some issues of incomplete film growth (largely due to insufficient amount or low temperature substrates), ALD provides an effective means of depositing thin films like dielectrics or barriers.

The process of ALD is very slow, and this is known to be its major limitation. For example, Al₂O₃ is deposited at a rate of 0.11 nm per cycle, which can correspond to an average deposition rate of 100-300 nm per hour, depending on cycle duration and pumping speed. This problem can be overrun by using Spatial ALD, where the substrate is moved in space below a special ALD showerhead, and both the precursor gasses are separated by gas curtains/bearings. In this way, deposition rates of 60 nm per minute could be reached. ALD is typically used to produce substrates for microelectronics and nanotechnology, and therefore, thick atomic layers are not needed. See:
“2.3 Adsorption Kinetics—The Rate of Adsorption”. www.chem.qmul.ac.uk.
“2018 Millennium Technology Prize for Tuomo Suntola-Finnish physicist's innovation enables manufacture and development of information technology products” (Press release). Technology Academy Finland. 22 May 2018. Retrieved 22 May 2018.
“Molecular Beam Epitaxy & Atomic Layer Deposition Systems”. SVT Associates.
Ahuja, Kunal, Valentin Sallaz, Ramsay Blake Nuwayhid, Frederic Voiron, Patrick Mccluskey, Gary W. Rubloff, and Keith E. Gregorczyk. “Ultra-thin on-chip ALD LiPON capacitors for high frequency application.” Journal of Power Sources 575 (2023): 233056.
Ahuja, Kunal. “Ultra-Thin On-Chip ALD Lipon as Solid-State Electrolyte for High Energy and High Frequency Capacitor Applications.” PhD diss., University of Maryland, College Park, 2022.
Ahvenniemi, Esko; Akbashev, Andrew R.; Ali, Saima; Bechelany, Mikhael; Berdova, Maria; Boyadjiev, Stefan; Cameron, David C.; Chen, Rong; Chubarov, Mikhail (2016). “Review Article: Recommended reading list of early publications on atomic layer deposition—Outcome of the “Virtual Project on the History of ALD””. Journal of Vacuum Science & Technology A: Vacuum, Surfaces, and Films. 35 (1): 010801. Bibcode: 2017JVSTA..35a0801A. doi: 10.1116/1.4971389. S2CID 209855960.
Aleskovskii, V. B. Zh. Prikl. Khim. 47, 2145 (1974); [J. Appl. Chem. USSR. 47, 2207, (1974)].
Ansari, Mohd Zahid, Iftikhar Hussain, Debananda Mohapatra, Sajid Ali Ansari, Reza Rahighi, Dip K. Nandi, Wooseok Song, and Soo-Hyun Kim. “Atomic Layer Deposition—A Versatile Toolbox for Designing/Engineering Electrodes for Advanced Supercapacitors.” Advanced Science (2023): 2303055.
Blakeney, Kyle J.; Winter, Charles H. (27 Mar. 2018). “Atomic Layer Deposition of Aluminum Metal Films Using a Thermally Stable Aluminum Hydride Reducing Agent”. Chemistry of Materials. 30 (6): 1844-1848. doi: 10.1021/acs.chemmater.8b00445. ISSN 0897-4756.

Brown, S.; Howe, J. Y.; Ma, Z.; Et (2008). “Surface Modification of Au/TiO₂ Catalysts by SiO₂ via Atomic Layer Deposition”. The Journal of Physical Chemistry C. 112 (25): 9448-9457. doi: 10.1021/jp801484h.
Butt, Hans-Jurgen; Graf, Karlheinz; Kappl, Michael (2013). Physics and Chemistry of Interfaces (Third, Revised ed.). John Wiley & Sons. ISBN 978-3-527-41216-7.
Elam, J. W; Nelson, C. E; Grubbs, R. K; George, S. M (May 2001). “Kinetics of the WF₆ and Si₂H₆ surface reactions during tungsten atomic layer deposition”. Surface Science. 479 (1-3): 121-135. Bibcode: 2001SurSc.479..121E. doi: 10.1016/S0039-6028(01)00969-4.
Elers, K.-E.; Saanila, V.; Soininen, P. J.; Li, W.-M.; Kostamo, J. T.; Haukka, S.; Juhanoja, J.; Besling, W. F. A. (2002). “Diffusion Barrier Deposition on a Copper Surface by Atomic Layer Deposition”. Chemical Vapor Deposition. 8 (4): 149. doi: 10.1002/1521-3862 (20020704) 8:4<149::AID-CVDE149>3.0.CO;2-F.
Fabreguette, F. H.; Sechrist, Z. A.; Elam, J. W.; George, S. M. (September 2005). “Quartz crystal microbalance study of tungsten atomic layer deposition using WF₆ and Si₂H₆”. Thin Solid Films. 488 (1-2): 103-110. Bibcode: 2005TSF...488..103F. doi: 10.1016/j.tsf.2005.04.114.
Falidas, Konstantinos Efstathios, Kati Kühnel, Matthias Rudolph, Maximilian B. Everding, Malte Czernohorsky, and Johannes Heitmann. “Three-Dimensional Metal-Insulator-Metal Decoupling Capacitors with Optimized ZrO2 ALD Properties for Improved Electrical and Reliability Parameters.” Materials 15, no. 23 (2022): 8325.
George, S. M. (2010). “Atomic Layer Deposition: An Overview”. Chem. Rev. 110 (1): 111-131. doi: 10.1021/cr900056b. PMID 19947596.
Gordon, Peter G.; Kurek, Agnieszka; Barry, Seán T. (2015). “Trends in Copper Precursor Development for CVD and ALD Applications”. ECS Journal of Solid State Science and Technology. 4 (1): N3188-N3197. doi: 10.1149/2.0261501jss. ISSN 2162-8769. S2CID 97668427.
Greer, Frank; Fraser, D.; Coburn, J. W. and Graves, David B. (2002) “Fundamental Vacuum Beam Studies of Radical Enhanced Atomic Layer Chemical Vapor Deposition (REAL-CVD) of TiN”. NCCAVS.
Groner, M. D., and S. M. George. “High-k dielectrics grown by atomic layer deposition: Capacitor and gate applications.” Interlayer Dielectrics for Semiconductor Technologies (2003): 327-348.
Grubbs, R. K.; Steinmetz, N. J.; George, S. M. (2004). “Gas phase reaction products during tungsten atomic layer deposition using WF₆ and Si₂H₆”. Journal of Vacuum Science & Technology B: Microelectronics and Nanometer Structures. 22 (4): 1811.Bibcode: 2004JVSTB..22.1811G. doi: 10.1116/1.1767105.
Güder, Firat (2012). Atomlagenabscheidung unterstützt Nanostrukturelle Transformationen [Atomic layer deposition assisted nanostructural transformations] (Doctoral thesis) (in German). University of Freiburg.
Guo, Yuan, Shixin Wang, Xianfeng Du, Shuaizhong Liang, Shan Huang, Shengjun Peng, Yuchong Xie, Mingbo Ma, and Lilong Xiong. “Construction of Ultrahigh Capacity Density Carbon Nanotube Based MIM Capacitor.” Energy Storage Materials (2023): 103064.
Guo, Zheng; Li, Hao; Chen, Qiang; Sang, Lijun; Yang, Lizhen; Liu, Zhongwei; Wang, Xinwei (8 Sep. 2015). “Low-Temperature Atomic Layer Deposition of High Purity, Smooth, Low Resistivity Copper Films by Using Amidinate Precursor and Hydrogen Plasma”. Chemistry of Materials. 27 (17): 5988-5996. doi: 10.1021/acs.chemmater.5b02137. ISSN 0897-4756.
Gupta, Rajeev, Adesh Kumar, A. Biswas, Rajesh Singh, Anita Gehlot, Shaik Vaseem Akram, and Ajay Singh Verma. “Advances in micro and nano-engineered materials for high-value capacitors for miniaturized electronics.” Journal of Energy Storage 55 (2022): 105591.
Gutsche, M. (2003). “Atomic Layer Deposition for Advanced DRAM Applications”. Future Fab Intl. 14. Archived from the original on 8 Sep. 2005.
Heikkinen, Ismo T. S.; Marin, Giovanni; Bihari, Nupur; Ekstrum, Craig; Mayville, Pierce J.; Fei, Yuhuan; Hu, Yun Hang; Karppinen, Maarit; Savin, Hele; Pearce, Joshua M. (March 2020). “Atomic layer deposited aluminum oxide mitigates outgassing from fused filament fabrication-based 3-D printed components”. Surface and Coatings Technology. 386:125459. doi: 10.1016/j.surfcoat.2020.125459. S2CID 212841294.
Hirvikorpi, Terhi; Laine, Risto; Vähä-Nissi, Mika; Kilpi, Väinö; Salo, Erkki; Li, Wei-Min; Lindfors, Sven; Vartiainen, Jari; Kenttä, Eija; Nikkola, Juha; Harlin, Ali (January 2014). “Barrier properties of plastic films coated with an A12O3 layer by roll-to-toll atomic layer deposition”. Thin Solid Films. 550:164-169. Bibcode: 2014TSF...550..164H. doi: 10.1016/j.tsf.2013.10.148.
Kalutarage, Lakmal C.; Martin, Philip D.; Heeg, Mary Jane; Winter, Charles H. (28 Aug. 2013). “Volatile and Thermally Stable Mid to Late Transition Metal Complexes Containing a-Imino Alkoxide Ligands, a New Strongly Reducing Coreagent, and Thermal Atomic Layer Deposition of Ni, Co, Fe, and Cr Metal Films”. Journal of the American Chemical Society. 135 (34): 12588-12591. doi: 10.1021/ja407014w. ISSN 0002-7863. PMID 23947400.
Kessels, W. M. M. (2019). “ALD Database”. Eindhoven University of Technology. doi: 10.6100/alddatabase.
Kim, H. (2003). “Atomic layer deposition of metal and nitride thin films: Current research efforts and applications for semiconductor device processing”. Journal of Vacuum Science and Technology. 21 (6): 2231. Bibcode: 2003JVSTB..21.2231K. doi: 10.1116/1.1622676.
Kim, Se Eun, Ju Young Sung, Jae Deock Jeon, Seo Young Jang, Hye Min Lee, Sang Mo Moon, Jun Goo Kang, Han Jin Lim, Hyung-Suk Jung, and Sang Woon Lee. “Toward advanced high-k and electrode thin films for DRAM capacitors via atomic layer deposition.” Advanced Materials Technologies 8, no. 20 (2023): 2200878.
Klaus, J. W; Ferro, S. J; George, S. M (February 2000). “Atomic layer deposition of tungsten using sequential surface chemistry with a sacrificial stripping reaction”. Thin Solid Films. 360 (1-2): 145-153. Bibcode: 2000TSF...360..145K. doi: 10.1016/S0040-6090 (99) 01076-7.
Klesko, Joseph P.; Thrush, Christopher M.; Winter, Charles H. (28 Jul. 2015). “Thermal Atomic Layer Deposition of Titanium Films Using Titanium Tetrachloride and 2-Methyl-1,4-bis(trimethylsilyl)-2,5-cyclohexadiene or 1,4-Bis(trimethylsilyl)-1,4-dihydropyrazine”. Chemistry of Materials. 27 (14): 4918-4921. doi: 10.1021/acs.chemmater.5b01707. ISSN 0897-4756.
Klootwijk, J. H., K. B. Jinesh, W. Dekkers, J. F. Verhoeven, F. C. Van Den Heuvel, H-D. Kim, D. Blin et al. “Ultrahigh capacitance density for multiple ALD-grown MIM capacitor stacks in 3-D silicon.” IEEE Electron Device Letters 29, no. 7 (2008): 740-742.
Klootwijk, Johan, Anton Kemmeren, R. O. B. Wolters, Fred Roozeboom, J. A. N. Verhoeven, and Eric Van Den Heuvel. “Extremely high-density capacitors with ALD high-k dielectric layers.” In Defects in High-k Gate Dielectric Stacks: Nano-Electronic Semiconductor Devices, pp. 17-28. Springer Netherlands, 2006.
Klootwijk, Johan, Anton Kemmeren, R. O. B. Wolters, Fred Roozeboom, J. A. N. Verhoeven, and Eric Van Den Heuvel. “Extremely high-density capacitors with ALD high-k dielectric layers.” In Defects in High-k Gate Dielectric Stacks: Nano-Electronic Semiconductor Devices, pp. 17-28. Springer Netherlands, 2006.
Knisley, Thomas J.; Ariyasena, Thiloka C.; Sajavaara, Timo; Saly, Mark J.; Winter, Charles H. (25 Oct. 2011). “Low Temperature Growth of High Purity, Low Resistivity Copper Films by Atomic Layer Deposition”. Chemistry of Materials. 23 (20): 4417-4419. doi: 10.1021/cm202475c. ISSN 0897-4756.
Knisley, Thomas J.; Kalutarage, Lakmal C.; Winter, Charles H. (December 2013). “Precursors and chemistry for the atomic layer deposition of metallic first row transition metal films”. Coordination Chemistry Reviews. 257 (23-24): 3222-3231.

doi: 10.1016/j.ccr.2013.03.019.
Knoops, Harm C. M.; Bracken, Eline M. J.; de Peuter, Koen; Potts, Stephen E.; Haukka, Suvi; Pore, Viljami; Kessels, Wilhelmus M. M. (9 Sep. 2015). “Atomic Layer Deposition of Silicon Nitride from Bis(tert-butylamino)silane and N2 Plasma” (PDF). ACS Applied Materials & Interfaces. 7 (35): 19857-19862. doi: 10.1021/acsami.5b06833. PMID 26305370.
Knoops, Harm C. M.; Faraz, Tahsin; Arts, Karsten; Kessels, Wilhelmus M. M. (Erwin) (May 2019). “Status and prospects of plasma-assisted atomic layer deposition”. Journal of Vacuum Science & Technology A. 37 (3): 030902. Bibcode: 2019JVSTA..37c0902K. doi: 10.1116/1.5088582. S2CID 108003079.
Langereis, E.; Knoops, H. C. M.; Mackus, A. J. M.; Roozeboom, F.; van de Sanden, M. C. M.; Kessels, W. M. M. (15 Oct. 2007). “Synthesis and in situ characterization of low-resistivity TaNx films by remote plasma atomic layer deposition”. Journal of Applied Physics. 102 (8): 083517-083517-11. Bibcode: 2007JAP...102h3517L. doi: 10.1063/1.2798598.
Lee, Sang Woon, Jeong Hwan Han, Sora Han, Woongkyu Lee, Jae Hyuck Jang, Minha Seo, Seong Keun Kim et al. “Atomic layer deposition of SrTiO3 thin films with highly enhanced growth rate for ultrahigh density capacitors.” Chemistry of Materials 23, no. 8 (2011): 2227-2236.
Lei Wenwen; Li Xingcun; Chen Qiang; Wang Zhengduo (February 2012). “Plasma-Assisted ALD of an Al₂O₃ Permeation Barrier Layer on Plastic”. Plasma Science and Technology. 14 (2): 129. Bibcode: 2012PIST...14..129L. doi: 10.1088/1009-0630/14/2/09. ISSN 1009-0630. S2CID 250740101.
Leskelä, M.; Ritala, M. (2003). “Atomic layer deposition chemistry: Recent developments and future challenges”. Angewandte Chemie. 42 (45): 5548-54. doi: 10.1002/anie.200301652. PMID 14639717.
Leskelä, Markku (2010). “Industrial Applications of Atomic Layer Deposition (ALD)”. 10th MIICS Conference. Archived from the original on 30 May 2012.
Li, Yuzhu, Tian Liang, Rui Wang, Beibei He, Yansheng Gong, and Huanwen Wang. “Encapsulation of Fe3O4 between copper nanorod and thin TiO₂ film by ALD for lithium-ion capacitors.” ACS applied materials & interfaces 11, no. 21 (2019): 19115-19122.
Mackus, Adriaan J. M.; Garcia-Alonso, Diana; Knoops, Harm C. M.; Bol, Ageeth A.; Kessels, Wilhelmus M. M. (2013). “Room-Temperature Atomic Layer Deposition of Platinum”. Chemistry of Materials. 25 (9): 1769-1774. doi: 10.1021/cm400274n.
Mackus, Adriaan J. M.; Schneider, Joel R.; MacIsaac, Callisto; Baker, Jon G.; Bent, Stacey F. (10 Dec. 2018). “Synthesis of Doped, Ternary, and Quaternary Materials by Atomic Layer Deposition: A Review”. Chemistry of Materials. 31 (4): 1142-1183. doi: 10.1021/acs.chemmater.8b02878. S2CID 104385650.
Malygin, Anatolii A.; Drozd, Victor E.; Malkov, Anatolii A.; Smirnov, Vladimir M. (2015). “From V. B. Aleskovskii's “Framework” Hypothesis to the Method of Molecular Layering/Atomic Layer Deposition ”. Chemical Vapor Deposition. 21 (10-11-12): 216-240. doi: 10.1002/cvde.201502013.
Mao, Zhifei, Huanwen Wang, Dongliang Chao, Rui Wang, Beibei He, Yansheng Gong, and Hong Jin Fan. “Al2O3-Assisted confinement synthesis of oxide/carbon hollow composite nanofibers and application in metal-ion capacitors.” Small 16, no. 33 (2020): 2001950.
Matas, Brian; de Suberbasaux, Christian (1997). “Ch. 7. DRAM Technology” Memory, 1997: Complete Coverage of DRAM, Sram, EPROM, and Flash Memory IC's. Scottsdale, AZ, USA: Integrated Circuit Engineering Corp. ISBN 978-1877750595.
Miikkulainen, Ville; Leskelä, Markku; Ritala, Mikko; Puurunen, Riikka L. (14 Jan. 2013). “Crystallinity of inorganic films grown by atomic layer deposition: Overview and general trends”. Journal of Applied Physics. 113 (2): 021301-021301-101. Bibcode: 2013JAP...113b1301M. doi: 10.1063/1.4757907.
Mistry, K.; Allen, C.; Auth, C.; Beattie, B.; Bergstrom, D.; Bost, M.; Brazier, M.; Buchler, M.; Cappellani, A.; Chau, R.; Choi, C.-H.; Ding, G.; Fischer, K.; Ghani, T.; Grover, R.; Han, W.; Hanken, D.; Hattendorf, M.; He, J.; Hicks, J.; Huessner, R.; Ingerly, D.; Jain, P.; James, R.; Jong, L.; Joshi, S.; Kenyon, C.; Kuhn, K.; Lee, K.; et al. (2007). “A 4 5nm Logic Technology with High-k+Metal Gate Transistors, Strained Silicon, 9 Cu Interconnect Layers, 193 nm Dry Patterning, and 100% Pb-free Packaging” (PDF). 2007 IEEE International Electron Devices Meeting. pp. 247-250. doi: 10.1109/IEDM.2007.4418914. ISBN 978-1-4244-1507-6. S2CID 12392861. Archived from the original (PDF) on 18 Feb. 2008.
Oviroh, Peter Ozaveshe; Akbarzadeh, Rokhsarch; Pan, Dongqing; Coetzee, Rigardt Alfred Maarten; Jen, Tien-Chien (2019). “New Development of Atomic Layer Deposition: Processes, Methods, and Applications”. Science and Technology of Advanced Materials. 20 (1): 465-496. Bibcode: 2019STAdM..20..465O. doi: 10.1080/14686996.2019.1599694. PMC 6534251. PMID 31164953.open access
Park, Sang-Hee Ko; Oh, Jiyoung; Hwang, Chi-Sun; Lee, Jeong-Ik; Yang, Yong Suk; Chu, Hye Yong; Kang, Kwang-Yong (14 Oct. 2005). “Ultra Thin Film Encapsulation of OLED on Plastic Substrate”. ETRI Journal. 27 (5): 545-550. doi: 10.4218/etrij.05.0905.0006. ISSN 1225-6463. S2CID 58156645.
Park, Sang-Hee Ko; Oh, Jiyoung; Hwang, Chi-Sun; Yang, Yong Suk; Lee, Jeong-Ik; Chu, Hye Yong (January 2004). “Ultra thin film encapsulation of OLED on plastic substrate”. Journal of Information Display. 5 (3): 30-34. doi: 10.1080/15980316.2004.9651953. ISSN 1598-0316. S2CID 135967211.
Parsons, Gregory N.; Elam, Jeffrey W.; George, Steven M.; Haukka, Suvi; Jeon, Hyeongtag; Kessels, W. M. M. (Erwin); Leskelä, Markku; Poodt, Paul; Ritala, Mikko (2013). “History of atomic layer deposition and its relationship with the American Vacuum Society”. Journal of Vacuum Science & Technology A. 31 (5): 050818. Bibcode: 2013JVSTA..31e0818P. doi: 10.1116/1.4816548. S2CID 97676893.
Potts, S. E.; Kessels, W. M. M. (December 2013). “Energy-enhanced atomic layer deposition for more process and precursor versatility”. Coordination Chemistry Reviews. 257 (23-24): 3254-3270. doi: 10.1016/j.ccr.2013.06.015.
Puurunen, Riikka L. (15 Jun. 2005). “Surface chemistry of atomic layer deposition: A case study for the trimethylaluminum/water process”. Journal of Applied Physics. 97 (12): 121301-121301-52. Bibcode: 2005JAP....9711301P. doi: 10.1063/1.1940727.
Puurunen, Riikka L. (15 Jun. 2005). “Surface chemistry of atomic layer deposition: A case study for the trimethylaluminum/water process”. Journal of Applied Physics. 97 (12): 121301-121301-52. Bibcode: 2005JAP....9711301P. doi: 10.1063/1.1940727.
Puurunen, Riikka L. (2014). “A Short History of Atomic Layer Deposition: Tuomo Suntola's Atomic Layer Epitaxy”. Chemical Vapor Deposition. 20 (10-11-12): 332-344. doi: 10.1002/cvde.201402012. S2CID 137543630.
Puurunen, Riikka. “Learnings from an Open Science Effort: Virtual Project on the History of ALD”. ecsarxiv.org. doi: 10.1149/osf.io/exyv3. S2CID 240379307. Retrieved 26 Dec. 2018.
Roozeboom, F., Johan Klootwijk, Jan Verhoeven, Eric van den Heuvel, Wouter Dekkers, Stephan Heil, Hans van Hemmen et al. “ALD options for Si-integrated ultrahigh-density decoupling capacitors in pore and trench designs.” ECS Transactions 3, no. 15 (2007): 173.
Sandhu, Gurtej; Doan, Trung T. “Atomic layer doping apparatus and method”. US20030073318A1.
Schilirò, Emanuela, Raffaella Lo Nigro, Fabrizio Roccaforte, and Filippo Giannazzo. “Recent advances in seeded and seed-layer-free atomic layer deposition of high-K dielectrics on graphene for electronics.” C 5, no. 3 (2019): 53.
Schmidt, J.; Merkle, A.; Brendel, R.; Hoex, B.; de Sanden, M. C. M. van; Kessels, W. M. M. (September 2008). “Surface passivation of high-efficiency silicon solar cells by atomic-layer-deposited Al₂O₃”. Progress in Photovoltaics: Research and Applications. 16 (6): 461-466. doi: 10.1002/pip.823. S2CID 97771156.
Seghete, D.; Rayner, G. B.; Cavanagh, A. S.; Anderson, V. R.; George, S. M. (12 Apr. 2011). “Molybdenum Atomic Layer Deposition Using MoF₆ and Si₂H₆ as the Reactants”. Chemistry of Materials. 23 (7): 1668-1678. doi: 10.1021/cm101673u. ISSN 0897-4756.
Seo, Seongrok; Jeong, Seonghwa; Park, Hyoungmin; Shin, Hyunjung; Park, Nam-Gyu (2019). “Atomic layer deposition for efficient and stable perovskite solar cells”. Chemical Communications. 55 (17): 2403-2416. doi: 10.1039/C8CC09578G. ISSN 1359-7345. PMID 30719523. S2CID 73448015.
Stevens, Eric C.; Mousa, Moataz Bellah M.; Parsons, Gregory N. (November 2018). “Thermal atomic layer deposition of Sn metal using SnCl₄ and a vapor phase silyl dihydropyrazine reducing agent”. Journal of Vacuum Science & Technology A. 36 (6): 06A106. Bibcode: 2018JVSTA..36fA106S. doi: 10.1116/1.5055212. ISSN 0734-2101. S2CID 104844454.
van Delft, J A; Garcia-Alonso, D; Kessels, W M M (11 Jul. 2012). “Atomic layer deposition for photovoltaics: applications and prospects for solar cell manufacturing”. Semiconductor Science and Technology. 27 (7): 074002. Bibcode: 2012SeScT..27g4002V. doi: 10.1088/0268-1242/27/7/074002. ISSN 0268-1242. S2CID 55670928.
Waechtler, T.; et al. (2011). “ALD-grown seed layers for electrochemical copper deposition integrated with different diffusion barrier systems” (PDF). Microelectron. Eng. 88 (5): 684-689. doi: 10.1016/j.mee.2010.07.004.

Wang, Hai, Jinxia Huang, Xiaobo Wang, Zhiguang Guo, and Weimin Liu. “Fabrication of TiN/CNTs on carbon cloth substrates via a CVD-ALD method as free-standing electrodes for zinc ion hybrid capacitors.” New Journal of Chemistry 46, no. 31 (2022): 15175-15184.
Werner, Florian; Stals, Walter; Gortzen, Roger; Veith, Boris; Brendel, Rolf; Schmidt, Jan (2011). “High-rate atomic layer deposition of A1203 for the surface passivation of Si solar cells”. Energy Procedia. 8:1301-306. doi: 10.1016/j.egypro.2011.06.140.
Wu, Xudong, Xin Chen, Q. M. Zhang, and Daniel Q. Tan. “Advanced dielectric polymers for energy storage.” Energy Storage Materials 44 (2022): 29-47.
Wu, Xudong, Yichen Liu, Xiaotian Lin, Enling Huang, Guanghui Song, and Daniel Q. Tan. “Atomic layer deposition coated polymer films with enhanced high-temperature dielectric strength suitable for film capacitors.” Surfaces and Interfaces 28 (2022): 101686.
Xiong, Li, Jin Hu, Zhao Yang, Xianglin Li, Hang Zhang, and Guanhua Zhang. “Dielectric properties investigation of metal-insulator-metal (MIM) capacitors.” Molecules 27, no. 12 (2022): 3951.
Xu, Wanxing, Paul C. Lemaire, Kashish Sharma, Dennis M. Hausmann, and Sumit Agarwal. “Status And Prospects Of Area-Selective Atomic Layer Deposition Of Dielectrics For Semiconductor Manufacturing.” Area-Selective Atomic Layer Deposition Of Dielectrics For Semiconductor Manufacturing (2021): 1.
Yu, Xiongfei, Chunxiang Zhu, Hang Hu, Albert Chin, M. F. Li, Byung Jin Cho, Dim-Lee Kwong, P. D. Foo, and Ming Bin Yu. “A high-density MIM capacitor (13 fF/μm 2) using ALD HfO₂ dielectrics.” IEEE Electron Device Letters 24, no. 2 (2003): 63-65.
Zhang, Qiu-Xiang, Bao Zhu, Shi-Jin Ding, Hong-Liang Lu, Qing-Qing Sun, Peng Zhou, and Wei Zhang. “Full ALD Al 2 O 3/ZrO 2/SiO 2/ZrO 2/Al 2 O 3 stacks for high-performance MIM capacitors.” IEEE Electron Device Letters 35, no. 11 (2014): 1121-1123.
See U.S. Patent and Application Nos. 20030178693; 20040057193; 20040058504; 20040112964; 20040144972; 20050095780; 20050286293; 20060166474; 20070001231; 20070004224; 20070080387; 20070100086; 20070105333; 20070122986; 20070148857; 20070176248; 20070176824; 20070254488; 20070277735; 20070281082; 20070281105; 20080101121; 20080157126; 20080157127; 20080157257; 20080157314; 20080160734; 20080170429; 20080180883; 20080197399; 20080209876; 20080212361; 20080220153; 20080230826; 20080231931; 20090014803; 20090017572; 20090027280; 20090052827; 20090090939; 20090093133; 20090095950; 20090108252; 20090140801; 20090162560; 20090163647; 20090163656; 20090176347; 20090184346; 20090184389; 20090184392; 20090194839; 20090315644; 20100001267; 20100012922; 20100024732; 20100038729; 20100102380; 20100109130; 20100135937; 20100140591; 20100158544; 20100158548; 20100207245; 20100214012; 20100273166; 20100289064; 20100291749; 20100295138; 20100320437; 20110001175; 20110003453; 20110006353; 20110026232; 20110049577; 20110049673; 20110073827; 20110073837; 20110080686; 20110084314; 20110092030; 20110101471; 20110104426; 20110108888; 20110121366; 20110126929; 20110207328; 20110220875; 20110254141; 20110260228; 20110291166; 20110315961; 20120034410; 20120091593; 20120129301; 20120187375; 20120251802; 20120306082; 20120313227; 20120319209; 20130004778; 20130016452; 20130032929; 20130043455; 20130056820; 20130140649; 20130146953; 20130146959; 20130158378; 20130178021; 20130210211; 20130273261; 20130320453; 20130328161; 20140073093; 20140099764; 20140106523; 20140145191; 20140145272; 20140154858; 20140174927; 20140175422; 20140175432; 20140175604; 20140183664; 20140183694; 20140185260; 20140203400; 20140203434; 20140206133; 20140226260; 20140233152; 20140241487; 20140264747; 20140335918; 20140353590; 20150001533; 20150003033; 20150036132; 20150053973; 20150069385; 20150072085; 20150076495; 20150084043; 20150084044; 20150087110; 20150091067; 20150091134; 20150097181; 20150102341; 20150108474; 20150115259; 20150131205; 20150138692; 20150144945; 20150155313; 20150162452; 20150171115; 20150179774; 20150179786; 20150179810; 20150200058; 20150211126; 20150214143; 20150221499; 20150221678; 20150221679; 20150243738; 20150255518; 20150287831; 20150303217; 20150311142; 20150311260; 20150318359; 20150325701; 20150340505; 20150348909; 20150364610; 20150372023; 20150372065; 20160005873; 20160006433; 20160027851; 20160032475; 20160056179; 20160056410; 20160064402; 20160093641; 20160118463; 20160154268; 20160155759; 20160163708; 20160189797; 20160190314; 20160190494; 20160204208; 20160204276; 20160218071; 20160233235; 20160233343; 20160268144; 20160284823; 20160284854; 20160290957; 20160290958; 20160293627; 20160300853; 20160300900; 20160308020; 20160315138; 20160365416; 20160372543; 20160379982; 20170005669; 20170008914; 20170012052; 20170012115; 20170012194; 20170040172; 20170040344; 20170040424; 20170062205; 20170084684; 20170084754; 20170086505; 20170098656; 20170104018; 20170117290; 20170117291; 20170125122; 20170141130; 20170148885; 20170154909; 20170160801; 20170162603; 20170170211; 20170170325; 20170178975; 20170179032; 20170179119; 20170179155; 20170179160; 20170179241; 20170179242; 20170179293; 20170186365; 20170186473; 20170186751; 20170186779; 20170186829; 20170186843; 20170186875; 20170194326; 20170200715; 20170200716; 20170205874; 20170207214; 20170213821; 20170213833; 20170221429; 20170221547; 20170222056; 20170229486; 20170229554; 20170233579; 20170236842; 20170236844; 20170236949; 20170250680; 20170256558; 20170263782; 20170278874; 20170278973; 20170287928; 20170288011; 20170288023; 20170301684; 20170309856; 20170310277; 20170336347; 20170345643; 20170346010; 20170350012; 20170358503; 20180026055; 20180040695; 20180052205; 20180053830; 20180061766; 20180061995; 20180102442; 20180106796; 20180138289; 20180158670; 20180166432; 20180174647; 20180175034; 20180175174; 20180182898; 20180190619; 20180197793; 20180197812; 20180197946; 20180219047; 20180222933; 20180254218; 20180269229; 20180277530; 20180277669; 20180294167; 20180294225; 20180308696; 20180315838; 20180331073; 20180342391; 20180350823; 20180350994; 20180358232; 20180358386; 20180358442; 20180374660; 20190006192; 20190006230; 20190006506; 20190006515; 20190013213; 20190013246; 20190013388; 20190019693; 20190024227; 20190051591; 20190103312; 20190115409; 20190115444; 20190115474; 20190130956; 20190130957; 20190140080; 20190148286; 20190148362; 20190157158; 20190157256; 20190157283; 20190157310; 20190165118; 20190172826; 20190187087; 20190189518; 20190189735; 20190189755; 20190198319; 20190198617; 20190198635; 20190198671; 20190212586; 20190221649; 20190244933; 20190245155; 20190288132; 20190304790; 20190305138; 20190312123; 20190319191; 20190326290; 20190334009; 20190341300; 20190348415; 20190348500; 20190348501; 20190348511; 20190355721; 20190355727; 20190363008; 20190378765; 20190378794; 20190385916; 20190393350; 20200006229; 20200006478; 20200006488; 20200006525; 20200006559; 20200007114; 20200013770; 20200013800; 20200020702; 20200027504; 20200028155; 20200028498; 20200035562; 20200044087; 20200052079; 20200052117; 20200058771; 20200066629; 20200083340; 20200091065; 20200091287; 20200098685; 20200098753; 20200098756; 20200098757; 20200105617; 20200105754; 20200105761; 20200105889; 20200105902; 20200114164; 20200118996; 20200119003; 20200119012; 20200135561; 20200141897; 20200168462; 20200168708; 20200168722; 20200168742; 20200176449; 20200194416; 20200203215; 20200203358; 20200212194; 20200219774; 20200220014; 20200220017; 20200224745; 20200243487; 20200251474; 20200258778; 20200258918; 20200266055; 20200273857; 20200273861; 20200286685; 20200286686; 20200286687; 20200286992; 20200292490; 20200292491; 20200294908; 20200335610; 20200348576; 20200364600; 20200365447; 20200365585; 20200365704; 20200373165; 20200378916; 20200381545; 20200395069; 20200395460; 20200411513; 20200411667; 20200411691; 20210005753; 20210013106; 20210013322; 20210020449; 20210020457; 20210020628; 20210020744; 20210028010; 20210028274; 20210036025; 20210036122; 20210043607; 20210050369; 20210050417; 20210057544; 20210066100; 20210066452; 20210066506; 20210066627; 20210082747; 20210083116; 20210091104; 20210098311; 20210098588; 20210098604; 20210098605; 20210098634; 20210104396; 20210104397; 20210104433; 20210118699; 20210118882; 20210119131; 20210126097; 20210126113; 20210126122; 20210126134; 20210133528; 20210134681; 20210134721; 20210134797; 20210134800; 20210134970; 20210140048; 20210167056; 20210175334; 20210193454; 20210193508; 20210202238; 20210202497; 20210202498; 20210202507; 20210202510; 20210202697; 20210202709; 20210202747; 20210202756; 20210202758; 20210217889; 20210225663; 20210233764; 20210233901; 20210234017; 20210242092; 20210242093; 20210242206; 20210242327; 20210249424; 20210249509; 20210249530; 20210257016; 20210257260; 20210257357; 20210265264; 20210265349; 20210265350; 20210265489; 20210265501; 20210273070; 20210273072; 20210273078; 20210273096; 20210273098; 20210273100; 20210273102; 20210273104; 20210273114; 20210305063; 20210305084; 20210305389; 20210305408; 20210313320; 20210313333; 20210313419; 20210320106; 20210335657; 20210335674; 20210335676; 20210335690; 20210335709; 20210335783; 20210336020; 20210336024; 20210336029; 20210336033; 20210336063; 20210343600; 20210343639; 20210343713; 20210343853; 20210343858; 20210351135; 20210351183; 20210357561; 20210358750; 20210358842; 20210358891; 20210359096; 20210359109; 20210366822; 20210367034; 20210367063; 20210367078; 20210375683; 20210375687; 20210375688; 20210375761; 20210375837; 20210375858; 20210375861; 20210375864; 20210375888; 20210375921; 20210375930; 20210375931; 20210375933; 20210375937; 20210376072; 20210376076; 20210376094; 20210376096; 20210376101; 20210376105; 20210376129; 20210376133; 20210376155; 20210376163; 20210383881; 20210384128; 20210384193; 20210384198; 20210384316; 20210384355; 20210391325; 20210391331; 20210391354; 20210391435; 20210391436; 20210391439; 20210391447; 20210391449; 20210391466; 20210391477; 20210398568; 20210398861; 20210399015; 20210399016; 20210399017; 20210399052; 20210399102; 20210407569; 20210407795; 20210407847; 20210407980; 20210407991; 20210408014; 20210408022; 20210408247; 20210408249; 20210408266; 20220005830; 20220005937; 20220011375; 20220013288; 20220013305; 20220013412; 20220013485; 20220013523; 20220020774; 20220020865; 20220021376; 20220028752; 20220028786; 20220028811; 20220028983; 20220028994; 20220028999; 20220029011; 20220029023; 20220036931; 20220036935; 20220037192; 20220037193; 20220037320; 20220037321; 20220037465; 20220037496; 20220037498; 20220037529; 20220037530; 20220044937; 20220045125; 20220045178; 20220045182; 20220051939; 20220051949; 20220051950; 20220052043; 20220052045; 20220052075; 20220052162; 20220052169; 20220052173; 20220052181; 20220052201; 20220052206; 20220059668; 20220059700; 20220069243; 20220084830; 20220084889; 20220085067; 20220093448; 20220093472; 20220093612; 20220093758; 20220093770; 20220102142; 20220102152; 20220102210; 20220102339; 20220102344; 20220102352; 20220102494; 20220102519; 20220107223; 20220115376; 20220115387; 20220115508; 20220122893; 20220122996; 20220123111; 20220123115; 20220123123; 20220123124; 20220130684; 20220130738; 20220130847; 20220130971; 20220130979; 20220131006; 20220134131; 20220138983; 20220139934; 20220140097; 20220140098; 20220149176; 20220157967; 20220157983; 20220165311; 20220165659; 20220172988; 20220173106; 20220173224; 20220173246; 20220179301; 20220179323; 20220180159; 20220190125; 20220199462; 20220199621; 20220209045; 20220216060; 20220216070; 20220216239; 20220216830; 20220223536; 20220223587; 20220223590; 20220223594; 20220223604; 20220223622; 20220223732; 20220230922; 20220230926; 20220231022; 20220231050; 20220231051; 20220231052; 20220231124; 20220237440; 20220238429; 20220238521; 20220238647; 20220238648; 20220238649; 20220238678; 20220238679; 20220238686; 20220238687; 20220238688; 20220238699; 20220238713; 20220238717; 20220246180; 20220246479; 20220246611; 20220246742; 20220254401; 20220254402; 20220254882; 20220262649; 20220262792; 20220262911; 20220262925; 20220262958; 20220270970; 20220271163; 20220277958; 20220277994; 20220277995; 20220277998; 20220278097; 20220278098; 20220278197; 20220285159; 20220285345; 20220285435; 20220285495; 20220285513; 20220285528; 20220285561; 20220293521; 20220293731; 20220301858; 20220301928; 20220301929; 20220302143; 20220302144; 20220302389; 20220310445; 20220310472; 20220310477; 20220310489; 20220310638; 20220310785; 20220310787; 20220310816; 20220310819; 20220319931; 20220319934; 20220319989; 20220319990; 20220320064; 20220320088; 20220320116; 20220320293; 20220320307; 20220320309; 20220320337; 20220328363; 20220328411; 20220328500; 20220328614; 20220328623; 20220328627; 20220328631; 20220328646; 20220328647; 20220336231; 20220336279; 20220336291; 20220336448; 20220336459; 20220336583; 20220336584; 20220336614; 20220336619; 20220336625; 20220336636; 20220336637; 20220336662; 20220336677; 20220336742; 20220344151; 20220344204; 20220344206; 20220344259; 20220344403; 20220344460; 20220344484; 20220344490; 20220344508; 20220344516; 20220351976; 20220352073; 20220352170; 20220352179; 20220352180; 20220352312; 20220352334; 20220352338; 20220352348; 20220359066; 20220359298; 20220359308; 20220359311; 20220359368; 20220359369; 20220359375; 20220359396; 20220359414; 20220359517; 20220359546; 20220359570; 20220359653; 20220359679; 20220359699; 20220359700; 20220359711; 20220366114; 20220367187; 20220367253; 20220367361; 20220367410; 20220367454; 20220367479; 20220367515; 20220367620; 20220367622; 20220367625; 20220367627; 20220367656; 20220367659; 20220367683; 20220367685; 20220367686; 20220367703; 20220367717; 20220367720; 20220367727; 20220368149; 20220374203; 20220375844; 20220375941; 20220376044; 20220376088; 20220376111; 20220376114; 20220384179; 20220384403; 20220384429; 20220384450; 20220384456; 20220384459; 20220384599; 20220384609; 20220384611; 20220384617; 20220384660; 20220392889; 20220392998; 20220395827; 20220399231; 20220399310; 20220399439; 20220406350; 20220406598; 20220406606; 20220406648; 20220406653; 20220406655; 20220406774; 20220406900; 20220406913; 20220406920; 20220415786; 20230005797; 20230006031; 20230006051; 20230008127; 20230008315; 20230008409; 20230008413; 20230008494; 20230008893; 20230008994; 20230009347; 20230009485; 20230011783; 20230013047; 20230013764; 20230013976; 20230014471; 20230015372; 20230016381; 20230017100; 20230018223; 20230018480; 20230019633; 20230019692; 20230020099; 20230020251; 20230027789; 20230028591; 20230028653; 20230029354; 20230030448; 20230030826; 20230032703; 20230033289; 20230033790; 20230034125; 20230035444; 20230035580; 20230037526; 20230037719; 20230038762; 20230039661; 20230040606; 20230040843; 20230042196; 20230042726; 20230043635; 20230043910; 20230044771; 20230045665; 20230047194; 20230047598; 20230049938; 20230049977; 20230050645; 20230052883; 20230054372; 20230055147; 20230055272; 20230055499; 20230060742; 20230060757; 20230060825; 20230061497; 20230061501; 20230061815; 20230062128; 20230063039; 20230063087; 20230063463; 20230063975; 20230063984; 20230064078; 20230064457; 20230064735; 20230064844; 20230065195; 20230065446; 20230065476; 20230066230; 20230066477; 20230066828; 20230066861; 20230067027; 20230067331; 20230067425; 20230067859; 20230067886; 20230067988; 20230068279; 20230068312; 20230068354; 20230068359; 20230068434; 20230068505; 20230068568; 20230068664; 20230068668; 20230068951; 20230069187; 20230069198; 20230069421; 20230075019; 20230075180; 20230078026; 20230080922; 20230082313; 20230086080; 20230091621; 20230099053; 20230101278; 20230103349; 20230105495; 20230110073; 20230113269; 20230114216; 20230114507; 20230115634; 20230118779; 20230120117; 20230121210; 20230122339; 20230123670; 20230123987; 20230124549; 20230131688; 20230132059; 20230132910; 20230134741; 20230134971; 20230135172; 20230135509; 20230137528; 20230137766; 20230139258; 20230141523; 20230142628; 20230144099; 20230146353; 20230147809; 20230154791; 20230154984; 20230155002; 20230155004; 20230155005; 20230155006; 20230155008; 20230155018; 20230157002; 20230157003; 20230163075; 20230163084; 20230163129; 20230163162; 20230163191; 20230163197; 20230163198; 20230163212; 20230165013; 20230170400; 20230178361; 20230178418; 20230178427; 20230178433; 20230178587; 20230178600; 20230178601; 20230180456; 20230187307; 20230187442; 20230187507; 20230187548; 20230189496; 20230189531; 20230189532; 20230189538; 20230197004; 20230197521; 20230197640; 20230197716; 20230197820; 20230197822; 20230200055; 20230204819; 20230207317; 20230207398; 20230207560; 20230207663; 20230209835; 20230215928; 20230223302; 20230223344; 20230223439; 20230223469; 20230225098; 20230225130; 20230231014; 20230231025; 20230238271; 20230238275; 20230238324; 20230238448; 20230240072; 20230253034; 20230253313; 20230253445; 20230253478; 20230260790; 20230260826; 20230260832; 20230260836; 20230260849; 20230260850; 20230260998; 20230261045; 20230261048; 20230261052; 20230261069; 20230261076; 20230261077; 20230266291; 20230268223; 20230268225; 20230268408; 20230268416; 20230268423; 20230268426; 20230273637; 20230274769; 20230274779; 20230274977; 20230275044; 20230275123; 20230276633; 20230282524; 20230282656; 20230282702; 20230282723; 20230282739; 20230282750; 20230282751; 20230283276; 20230290688; 20230290859; 20230292525; 20230292526; 20230299106; 20230299136; 20230301068; 20230301114; 20230307153; 20230307241; 20230307298; 20230307366; 20230307457; 20230309317; 20230317125; 20230317469; 20230317566; 20230317593; 20230317714; 20230317785; 20230317790; 20230317859; 20230320075; 20230320230; 20230326491; 20230326503; 20230326999; 20230327025; 20230328956; 20230328997; 20230329013; 20230335173; 20230335436; 20230335498; 20230335535; 20230335551; 20230335600; 20230335616; 20230337412; 20230337439; 20230339198; 20230343822; 20230345696; 20230352477; 20230352560; 20230352567; 20230353163; 20230354582; 20230354605; 20230354677; 20230369146; 20230369329; 20230369398; 20230369428; 20230369452; 20230369458; 20230369468; 20230369502; 20230371228; 20230371268; 20230377624; 20230377989; 20230377999; 20230378000; 20230378001; 20230378030; 20230378256; 20230378260; 20230378261; 20230378262; 20230378294; 20230378297; 20230378298; 20230378302; 20230378304; 20230378308; 20230378318; 20230378339; 20230378363; 20230378371; 20230380175; 20230380257; 20230380310; 20230386544; 20230386890; 20230386901; 20230386935; 20230386936; 20230386971; 20230386993; 20230386994; 20230387012; 20230387115; 20230387117; 20230387122; 20230387123; 20230387126; 20230387198; 20230387200; 20230387202; 20230387212; 20230387228; 20230387235; 20230387236; 20230387240; 20230387243; 20230387246; 20230387253; 20230387273; 20230387296; 20230387299; 20230387311; 20230387326; 20230387328; 20230389324; U.S. Pat. Nos. 4,058,430; 4,389,973; 6,660,660; 6,709,989; 6,794,284; 6,946,394; 6,967,159; 6,995,081; 7,074,623; 7,105,390; 7,199,005; 7,208,413; 7,259,388; 7,279,375; 7,304,004; 7,307,273; 7,316,962; 7,326,656; 7,344,982; 7,396,711; 7,402,506; 7,427,794; 7,456,476; 7,479,421; 7,504,704; 7,510,942; 7,517,702; 7,517,753; 7,521,356; 7,544,563; 7,547,637; 7,550,333; 7,557,013; 7,642,546; 7,659,158; 7,662,729; 7,682,924; 7,794,544; 7,798,096; 7,825,481; 7,835,170; 7,847,341; 7,858,481; 7,858,816; 7,859,053; 7,879,675; 7,897,453; 7,902,014; 7,915,167; 7,972,978; 7,978,504; 7,989,280; 8,030,637; 8,058,137; 8,088,293; 8,216,951; 8,274,777; 8,283,258; 8,294,159; 8,3295,41; 8,367,506; 8,405,138; 8,431,492; 8,481,121; 8,501,563; 8,507,390; 8,520,425; 8,535,952; 8,545,936; 8,558,304; 8,574,929; 8,613,975; 8,617,945; 8,618,612; 8,674,470; 8,686,428; 8,686,490; 8,724,369; 8,735,280; 8,741,733; 8,766,258; 8,766,404; 8,803,206; 8,828,138; 8,840,981; 8,841,182; 8,860,137; 8,883,634; 8,940,579; 8,945,912; 8,993,055; 9,023,688; 9,099,424; 9,230,985; 9,344,090; 9,349,789; 9,356,098; 9,373,677; 9,379,011; 9,379,327; 9,394,609; 9,421,087; 9,459,234; 9,461,126; 9,496,376; 9,513,244; 9,523,148; 9,540,729; 9,543,315; 9,564,493; 9,577,110; 9,601,498; 9,607,842; 9,613,879; 9,614,107; 9,620,611; 9,634,106; 9,640,531; 9,640,669; 9,653,480; 9,684,236; 9,685,322; 9,689,835; 9,711,607; 9,716,137; 9,721,897; 9,786,491; 9,786,492; 9,790,238; 9,799,570; 9,829,485; 9,840,735; 9,871,034; 9,881,998; 9,911,651; 9,916,791; 9,923,080; 9,941,211; 9,941,425; 9,966,473; 9,978,479; 9,984,949; 9,997,637; 10,002,936; 10,003,317; 10,023,960; 10,079,229; 10,115,830; 10,170,627; 10,211,109; 10,211,308; 10,249,577; 10,249,765; 10,297,290; 10,297,667; 10,312,055; 10,319,535; 10,347,744; 10,418,595; 10,441,185; 10,458,018; 10,460,944; 10,490,328; 10,529,620; 10,541,374; 10,580,692; 10,600,637; 10,601,074; 10,615,288; 10,629,752; 10,643,895; 10,643,925; 10,658,705; 10,665,796; 10,672,643; 10,714,350; 10,763,160; 10,784,362; 10,790,379; 10,804,098; 10,832,916; 10,847,757; 10,872,771; 10,883,175; 10,896,820; 10,910,262; 10,950,599; 10,950,731; 10,978,125; 10,978,640; 10,985,278; 10,989,664; 11,018,116; 11,018,222; 11,024,523; 11,031,394; 11,060,922; 11,063,024; 11,069,684; 11,087,997; 11,088,246; 11,107,919; 11,114,374; 11,119,272; 11,145,657; 11,158,500; 11,158,513; 11,158,598; 11,211,452; 11,217,565; 11,232,963; 11,233,118; 11,244,871; 11,274,369; 11,282,940; 11,286,558; 11,295,980; 11,296,189; 11,306,395; 11,309,292; 11,315,794; 11,315,869; 11,339,476; 11,342,216; 11,345,999; 11,355,338; 11,361,990; 11,362,172; 11,378,337; 11,387,120; 11,390,945; 11,390,946; 11,390,950; 11,393,690; 11,396,702; 11,401,605; 11,410,851; 11,411,088; 11,414,760; 11,417,545; 11,424,119; 11,424,362; 11,430,640; 11,430,674; 11,430,813; 11,437,241; 11,443,926; 11,447,861; 11,447,864; 11,450,529; 11,453,943; 11,456,182; 11,473,195; 11,476,109; 11,476,261; 11,482,412; 11,482,418; 11,482,533; 11,488,819; 11,488,854; 11,492,703; 11,493,476; 11,495,459; 11,499,222; 11,499,226; 11,501,968; 11,502,104; 11,515,187; 11,515,188; 11,521,851; 11,527,403; 11,527,774; 11,530,483; 11,530,876; 11,532,757; 11,538,520; 11,551,912; 11,551,925; 11,557,474; 11,562,901; 11,569,366; 11,572,620; 11,574,818; 11,581,186; 11,587,814; 11,587,815; 11,587,821; 11,594,450; 11,594,600; 11,605,528; 11,610,774; 11,610,775; 11,615,970; 11,615,980; 11,626,308; 11,626,316; 11,629,407; 11,637,011; 11,637,014; 11,639,548; 11,639,811; 11,643,724; 11,644,758; 11,646,184; 11,646,197; 11,646,204; 11,646,205; 11,649,546; 11,658,029; 11,658,035; 11,659,714; 11,664,199; 11,664,245; 11,664,267; 11,674,220; 11,676,812; 11,680,839; 11,682,572; 11,685,991; 11,688,603; 11,694,892; 11,695,054; 11,697,183; 11,705,333; 11,718,913; 11,725,277; 11,725,280; 11,735,414; 11,735,422; 11,741,428; 11,742,189; 11,742,198; 11,749,562; 11,763,989; 11,767,589; 11,769,682; 11,769,790; 11,773,480; 11,776,846; 11,781,221; 11,781,243; 11,784,169; 11,791,397; 11,795,545; 11,798,830; 11,798,834; 11,798,999; 11,799,002; 11,800,747; 11,802,338; 11,804,364; 11,804,388; 11,804,486; 11,814,747; 11,821,078; 11,823,866; 11,823,876; 11,827,981; 11,828,707; 11,830,730; 11,830,738; and 11,830,954.

### SUMMARY OF THE INVENTION

The subject matter of this disclosure relates to improvements in performance of capacitors and electronic devices which is achieved using a unique dielectric stacking. A capacitor embodiment improves upon or substitutes in many supercapacitor applications.

The technology, in one embodiment, provides a capacitor having a thin high surface area dielectric between two electrodes, with a nanolaminate cushion as a stabilizing film adjacent to the dielectric to stabilize the dielectric.

In a second embodiment, a stabilized dielectric structure is provided between a gate of an electronic device, e.g., a field effect transistor or other field effect device, and the body or channel of the device which is modulated by the gate.

Embodiments of the technology achieve both high energy density and high breakdown voltage by utilizing a unique dielectric stacking which is made up of a stable thin-film dielectric layer supported by a stabilizing film, composed of a plurality of different layers of ALD oxides. This feature makes the device usable for many applications such as electric automobiles, rapid-charge technologies, and energy harvesting. The capacitor according to the present technology is also much smaller and lighter than most commercial capacitors. For use in circuitry or as circuit components, the technology offers a light weight, low footprint device that may conform to the geometry around it to provide enhanced embedded ability. Plus, with the capacitors' large surface area, improved dielectric constant, and enhanced breakdown strength may result in higher energy density.

The nanolaminate cushion is made up of alternating layers of two or more oxides, which could include but are not limited to, one insulating oxide and one semiconducting oxide. The insulating oxide could be Al₂O₃, SiO₂, or other options, while the semiconducting oxide could be TiO₂ or other oxides. These two layers are repeated multiple times, to form nanolaminate film. The nanolaminate possesses properties that enable it to behave like a “dielectric cushion”. These unique properties arise from the optimized thickness of each individual oxide layer. Typically, the Al₂O₃ type oxide layer is very thin (˜0.1 to ˜2 nm), while the TiO₂ type oxide layer can vary in thickness (˜0.1 nm to ˜500 nm). The repeated layering of these oxides results in the desired thickness for the nanolaminate cushion. By using a defective Al₂O₃ layer and a semiconducting TiO₂ layer, the nanolaminate is able to acquire conductive properties without affecting the capacitance when combined with the dielectric, thus appearing as if no additional substance has been introduced. The capacitance results from the dielectric thickness. The breakdown voltage is stabilized or increased by the nanolaminate cushion. Increasing the nanolaminate thickness does not substantially affect the capacitance or the breakdown voltage.

Atomic layer deposition is a preferred method for growing the nanolaminate cushion, although molecular beam epitaxy (MBE) and other methods are also possible.

The capacitor is made on a planar or nanostructure surface. The basic device structure is conductive electrode followed by nanolaminate cushion, the dielectric layer and the second conductive electrode. The dielectric layer can be placed before the nanolaminate cushion, after the nanolaminate cushion or in between the two nanolaminate cushions.

The structure may optimize stored energy E according to Equation (1). The embodiments may, for example, employ a dielectric with parameters (e.g., surface area, dielectric thickness, dielectric constant, etc.) adapted to increase the capacitance (C). These embodiments may also comprise materials that improve the dielectric breakdown strength to increase voltage (V). In this regard, some embodiments may comprise solid-state electronic components, for example, carbon nanotubes (CNTs) and a dielectric “nano-laminate” that conformally coats the CNTs.

Both the CNTs and the nano-laminate address several key factors to improve capacitance C of the device. The CNTs increase the surface area of the embodiments within a given footprint. Material for the nano-laminate forms a stack of alternating layers with properties (e.g., dielectric constant, energy bandgap, Gibbs free energy, thickness, etc.) tailored to achieve very high dielectric constant (k) with low leakage current. These features afford the device with high breakdown voltage that is critical given the V² dependence of energy density E. That is, the energy density per unit area of the capacitor is increased by increasing the capacitance (linear) and operating voltage (quadratic). See equation (1).

The result, in turn, is a thin-film capacitor that marries favorable power density (of capacitors) with enhanced energy density in a lightweight, flexible, stable device. These properties can also improve operation and application of the capacitors in electronic circuitry.

A major challenge limiting cutting-edge electronics is to produce capacitors with improved specific capacitance, breakdown strength, frequency response, reliability, and lifetime while advancing their miniaturization. A second challenge is that the total global production of capacitors fell short of last year's demand, and the demand is growing. Two technologies are provided according to the present technology, which when combined, will produce reliable miniaturized ultrathin ceramic capacitors (UTCCs, having a nanolaminate cushion and dielectric film, according to the present technology) with significant advances in all five requirements. UTCCs are disruptive and will replace multilayer ceramic capacitors (MLCCs) and electrolytic capacitors, including tantalum. UTCCs are composed of common non-strategic materials. UTCC manufacturing processes involve fewer steps and lower costs than MLCCs, while being physically smaller, and having higher specific capacitance and improved frequency response.

UTCCs are presented with two distinct approaches: planar and nanostructured. In the planar category, there are two options-a single-layer UTCC structure for streamlined design and monolithic multilayer UTCC for enhanced performance. Furthermore, we introduce a high-capacity miniaturized 3D nanostructured UTCC, combining advanced capabilities with a compact form factor.

The UTCCs may include barium strontium titanate (BST) (Ba,Sr) TiO₃-based ALD dielectrics. This can elevate UTCC capacitance by a factor of 40× by virtue of increased dielectric constant. This nanostructured device can be stacked in parallel to further increase the capacitance by hundreds of times without significantly increasing overall volume of the device, given the small height of each layer and the comparatively thick substrate.

MLCC capacitors have found extensive use in high-frequency decoupling applications, primarily due to their lower overall impedance that results in rapid current response. Decoupling capacitors for managing high-frequency noise typically range from 0.01 μF to 0.1 μF. Furthermore, capacitors with small pF values play a vital role in signal filtering and conditioning. However, these capacitors face limitations in ultra-high-frequency domains, such as 5G-enabled smartphones, mainly due to significant parasitic inductance. This inductance stems from the greater use of metal electrodes in manufacturing MLCCs, necessitated by the parallel connection of multiple metal electrode layers, resulting in increased parasitic inductance.

UTCC's frequency range may be increased by minimizing the inherent inductance by forming the capacitor in a small area planar single-layer configuration. This increases the UTCCs' resonant frequency. The present technology permits fabrication of single-layer UTCCs, with minimum metal and with capacitance levels comparable or better than MLCCs where desired, with lower cost. This is accomplished by producing a nanoscale thickness dielectric that is stabilized by a two-component nanolaminate layer. Thus, UTCC's have dielectrics with nanoscale thicknesses as opposed to the current micron level thicknesses of MLCCs, thereby increasing capacitance by at least 100× due to the inverse relationship of capacitance and dielectric thickness.

The key feature of UTCCs is that the ultrathin dielectric is ruggedized by the multilayered nanolaminate, which protects or cushions the ultrathin dielectric (FIG. 1A). This occurs because the nanolaminate is specifically designed to be a current carrying element between the metal electrode and the ultrathin dielectric. The nanolaminate is composed of many alternating layers of Al₂O₃ and TiO₂ deposited by atomic layer deposition (ALD) method. Each individual layer is of sub-nanometer thickness. The UTCCs have the capacitance corresponding to the ultrathin, a few nanometers, dielectric alone. Without the nanolaminate, the ultrathin dielectric performs poorly and unreliably. FIGS. 1B and 1C illustrate the capacitance and breakdown voltage range of UTCCs for various dielectric thicknesses. For instance, the UTCC displays approximately 3 nF/mm2 with a breakdown voltage of 20 V. The equations depicted in the plots provide the means to estimate the capacitance/breakdown for any dielectric thickness.

The protective effect of the nanolaminate cushion is shown in FIGS. 2A-2D, which compares the performance of a planar capacitor (5×5 mm²) made with a 4 nm thick Al₂O₃ ultrathin dielectric, both with and without the incorporation of the nanolaminate cushion composed of Al₂O₃ (0.3 nm)/TiO₂ (0.3 nm)×166 layers (˜100 nm total). All of the layers are deposited by ALD. Rapid cycle time ALD makes this method practical, and these instruments are already being used in high-end chip manufacturing.

Capacitors without the nanolaminate cushion exhibited rapid breakdown and very high leakage current (FIG. 2D), and inconsistent performance (FIG. 2C). In contrast, the nanolaminate cushion-supported ultrathin dielectrics demonstrated stable and repeatable performance, with a higher yield (FIG. 2A) and increased breakdown voltage (FIG. 2B).

FIGS. 2A-2D thus depict plots of disclosed capacitor performance with a 4 nm Al₂O₃ thin-dielectric, and with and without a protective nanolaminate. FIGS. 2A and 2C depict capacitor performance as capacitance vs frequency. FIG. 2A is with protective nanolaminate, and FIG. 2C is without a protective nanolaminate. FIGS. 2B and 2D depict electrical current vs voltage. FIG. 2B, with protective nanolaminate, depicts essentially no current until typical and repeatable breakdown voltage. FIG. 2D, without protective nanolaminate, depicts unreliable performance with significant current that increases with voltage.

FIG. 2A shows that in the 5 mm² sample with nanolaminate cushion, over multiple repetitions, the capacitance as a function of frequency displays a sigmoidal response starting at 350 nF below 1 kHz, dropping near zero above 100 kHz. The curve shows a crossover of 175 nF at about 20 kHz. FIG. 2B shows a leakage current below 1 μA at 3.5V, rising exponentially.

FIG. 2C shows that in the 5 mm² sample without nanolaminate cushion, over multiple repetitions, the capacitance as a function of frequency displays a sigmoidal response for each run, but inconsistent results starting at ˜30-300 nF below 1 kHz, each dropping near zero above 100 kHz. The curves show a crossover at about 20-80 kHz. FIG. 2D shows inconsistent results, with a leakage current rising linearly up to 0.5-0.8V. One run showed a linear rise in current from 0 mA to 10 mA over the range 0V to 0.5V. A second run showed a linear rise in current from 0 mA to 6 mA over a range of 0V to 0.7V, and then a non-monotonic increase to 10 mA up to 0.9V. A third run showed a linear rise in current from 0 mA to 3 mA over a range of 0V to 0.8V, and then a non-monotonic increase to 10 mA up to 0.9V.

Together, FIGS. 2A to 2D show that the nanolaminate cushion reduces leakage current, increases breakdown voltage, increases capacitance, and increases performance consistency.

FIGS. 3A and 3B demonstrate that the nanolaminate cushion has no adverse effect on UTCC performance by varying cushion thickness. Different cushion thicknesses (50 nm, 100 nm, and 200 nm) were achieved by repeating ALD cycles (83, 166, and 332 cycles of Al₂O₃ (0.3 nm)/TiO₂ (0.3 nm)). The ultrathin dielectric material was the same for each UTCC and was comprised of 4 nm of Al₂O₃ also deposited by ALD. The results showed that all capacitors exhibited the same capacitance and breakdown voltage, and both can be optimized by adjusting the thickness of the dielectric layer alone, without the need to modify the nanolaminate cushion. Since this manufacturing process is monolithic, it ensures a streamlined and efficient production. A wide range of dielectric thicknesses, for example spanning from a few nanometers to several microns, can be grown to obtain desired values of breakdown voltage and capacitance.

The plots shown in FIGS. 3C and 3D demonstrate the performance of UTCCs with varying thickness (4 nm, 5 nm, and 6 nm of Al₂O₃) of the ultrathin dielectric, while keeping the nanolaminate thickness constant. It can be observed that thicker dielectric films exhibit higher breakdown voltage, highlighting the impact of dielectric thickness on capacitor performance.

Table 1 below provides estimation of capacitance density, breakdown voltage, breakdown field and energy density for various thickness of dielectric layer in the UTCC.

TABLE 1

| Dielectric | | Breakdown | Breakdown | Areal Energy | Energy |
|---|---|---|---|---|---|
| thickness | Capacitance | voltage | field | density | density |
| (nm) | (F/cm²) | (V) | (V/cm) | (J/cm²) | (J/cm³) |
| 5 | 1.1603E−06 | 4.4127 | 8.83E+06 | 1.12964E−05 | 22.59282009 |
| 10 | 5.8661E−07 | 9.4497 | 9.45E+06 | 2.61911E−05 | 26.19112598 |
| 20 | 2.9658E−07 | 19.5237 | 9.76E+06 | 5.65235E−05 | 28.26173808 |
| 50 | 1.2038E−07 | 49.7457 | 9.95E+06 | 14.8951E−05 | 29.79015285 |
| 100 | 6.0862E−08 | 100.1157 | 1.00E+07 | 30.5016E−05 | 30.50159174 |
| 200 | 3.0771E−08 | 200.8557 | 1.00E+07 | 62.0687E−05 | 31.03437029 |

The synthesis of UTCC supported by ALD can be scaled up for mass production. FIGS. 4A-4H and 41-4L show the production flow starting with substrate to final packaging for single layer and multilayer UTCC, respectively. Notably, this process doesn't necessitate high-temperature sintering steps, unlike in MLCC, which minimizes thermal impact and cost. Additionally, the process is compatible with flexible substrates due to its low growth temperature (<300° C.), making it conducive for flexible electronics applications.

FIG. 4A shows the substrate. FIG. 4B shows a patterned metal film formed on the substrate. FIG. 4C shows an ALD dielectric coating over the patterned metal film. FIG. 4D shows an additional patterned metal film formed on the ALD dielectric coating, forming a capacitor. FIG. 4E shows the dicing pattern that exposes both the top and bottom electrodes on one side of each capacitor, allowing easy electrical access. FIG. 4F shows the substrate with single layer structure diced into individual devices. FIG. 4G shows contact pad formation on the dice. FIG. 4H shows the application of a resin coating on the completed single layer capacitor. FIG. 4I shows repeated deposition of patterned metal layers and ALD dielectric coating to form a multilayer structure. The number of layers desired can be monolithically placed as shown in FIG. 4I to the desired values of capacitance and breakdown voltage. FIG. 4J shows the substrate with multilayer structure diced into individual devices. FIG. 4K shows contact pad formation on the dice. FIG. 4L shows the application of a resin coating on the completed multilayer capacitor.

The linear relationship between capacitance and area by producing electrodes with 3-D nanostructures dramatically increases the effective area of the capacitor. The UTCCs are fabricated by conformally coating the nanostructured electrodes with the nanolaminate cushion and ultrathin dielectric followed by the second conductive electrode. This maximizes the specific capacitance by dramatically decreasing the separation of the two electrodes with the cushioned ultrathin nanolaminate/dielectric stack and dramatically increases the UTCC's area while minimizing its footprint.

The capacitance for planar configurations falls within the range of a few nano-farads per square millimeter, requiring further enhancement to effectively rival high-energy decoupling MLCC capacitors, which typically span from 0.01 μF to 0.1 μF. The solution in this scenario involves the fabrication of 3D nanostructures, aimed at amplifying the effective area of UTCCs in comparison to their footprint area, given that capacitance is directly tied to surface area.

Nanorods may be grown via hydrothermal methods. Cu pillars may be synthesized through templated growth. Several other nanostructures may be fashioned using photolithography techniques. Examples of nanostructures that can achieve this 3-D effect include zinc oxide (ZnO) nanorods (FIG. 5A), (Cu) nanorods (FIG. 5B), and carbon nanotubes (CNT) (FIG. 5C).

Nanostructures have a larger surface area compared to planar counterparts. This increase in surface area is due to the sidewalls of nanostructures, and it depends on two factors: (a) aspect ratio and (b) density of nanostructures as shown in FIG. 19. For instance, a 200:1 aspect ratio (height to diameter ratio) and nanostructures occupying ¼ of the total space can result in a 200-fold increase in surface area. At least a 100-fold increase in surface area is feasible with a 100:1 aspect ratio of nanorods. FIGS. 6A schematically shows the configuration of 3-D UTCCs, featuring nanostructures that are either grown directly on a substrate or positioned on a patterned substrate, initially using hydrothermal, templating, or photolithography methods. If the substrate is an insulator, a bottom electrode is first applied particularly in the case of non-conductive nanostructures. Subsequently, nanolaminate cushion and ultrathin dielectric oxide layers are deposited followed by a top contact electrode. The UTCCs can also be built into trenches built into the thickness of the substrate as shown in FIG. 6B.

Tantalum capacitors find common use in electronics due to their high capacitance, ranging from a few nano-farads to tens of milli-farads. However, a notable drawback of using tantalum capacitors is their susceptibility to unfavorable failure modes, which might lead to thermal runaway, fires, and even explosions. Due to their polarity, these capacitors are sensitive to voltage spikes, potentially leading to thermal runaway. Moreover, their limited tolerance for temperature and humidity exacerbates their limitations. Notably, tantalum is a scarce strategic material, contributing to potential supply chain challenges that affect availability and pricing. Given these inherent issues, the pursuit of an alternative becomes of utmost importance.

High-k materials may be used to create non-polar and safe ceramic capacitors as replacements for tantalum capacitors. Among these, perovskite materials like BaTiO₃ (BTO), SrTiO₃ (STO), or (Ba,Sr) TiO₃ (BST) stand out due to their impressive dielectric constants (>100), even in thin films. Initially deposited ALD films tend to be amorphous due to the relatively low process temperature (typically <400° C.). However, this lack of crystallinity results in substantially lower dielectric constants compared to their single-crystalline counterparts. Thus, significant efforts have been focused on crystallizing these initially amorphous ALD films using diverse in-situ or ex-situ methods. One method demonstrated by An et al. involves post-deposition remote oxygen plasma treatment at a low process temperature (250° C.). This treatment raised the dielectric constant from 51 (as deposited) to 122, while reducing leakage current density by an order of magnitude. The improved properties were attributed to film crystallization and densification through high-energy ion bombardment during the plasma treatment. Le and Ekerdt pursued a similar path, employing ALD to grow thin BaxSr₁₋ₓTiO₃ (BST) films. The as-deposited films were amorphous and required post-deposition vacuum annealing at 650-710° C. for crystallization. Their measurements revealed dielectric constants ranging from 210 for Ba_{0.71}Sr_{0.26}TiO₃ to 368 for Ba_{0.48}Sr_{0.43}TiO₃.
J. An, T. Usui, M. Logar, J. Park, D. Thian, S. Kim, K. Kim, and F. B. Prinz, “Plasma processing for crystallization and densification of atomic layer deposition BaTiO₃ thin films,” ACS Appl. Mater. Interfaces 6(13), 10656-10660 (2014).
T. T. Le, and J. G. Ekerdt, “Epitaxial growth of high-k BaₓSr₁₋ₓTiO₃ thin films on SrTiO₃ (001) substrates by atomic layer deposition,” J. Vac. Sci. Technol. A 38(3), 032401 (2020).

One important aspect of the laminate is that it can be placed after the dielectric coating so that the nanolaminate doesn't have to be exposed to the process conditions of the dielectric material.

For example, using BST crystallized through plasma treatment, avoids the need for high process temperatures. This plasma treatment facilitates crystallization through kinetic energy transfer from ions bombarding the film surface. BST films are grown using barium bis(triisopropylcyclopentadienyl), strontium bis(triisopropylcyclopentadienyl), titanium tetraisopropoxide, and H₂O, with composition controlled by altering ALD cycles. This shift from a k value of 7-8.5 for Al₂O₃ to approximately 350 for BST promises a capacitance increase of around 40-fold or more. Alongside BST, an Al₂O₃ and TiO₂ nanolaminate cushion may be used to safeguard the thin dielectric. Without the protection of the nanolaminate cushion, thinner dielectric capacitors wouldn't be reliable. With BST dielectric coated conformally on 3D nanostructures, at least a 4000× increase in the capacitance of our UTCCs is achievable. For the planar device with 3 nF/mm2 at 20V would essentially get a capacitance of at least 12 μF/mm². Just for perspective, a capacitor device on a 10 cm×10 cm sheet can have capacitance in the mF range, which is a significant amount of energy stored for dry dielectric capacitors.

A nanostructure-based, single packaged device per FIGS. 7A-7I has capability of capacitance in the several mF range. Since the individual devices are less than 1 millimeter in height, and may be, for example, 250 μm, several of them (FIG. 71) can be stacked in parallel without significantly increasing the overall height of a larger device that includes them. In fact, scale up to 1000× increase in capacitance is possible.

It is therefore an object to provide a capacitor, comprising: a nanostructured conductive electrode, having a surface having a 3D surface area at least ten times greater than a planar area of the surface; a counter-electrode; a dielectric layer, conformed to the surface and being disposed between the nanostructured conductive electrode and the counter-electrode; and a stabilizing film adjacent to the dielectric layer, comprising a plurality of different layers, formed by atomic layer deposition, the plurality of different layers comprising an insulating layer and a semiconducting layer.

It is also an object to provide a capacitor, comprising a nanostructured conductive electrode comprising protrusions or invaginations, having a surface having a 3D surface area at least ten times greater than a planar area of the surface; a counter-electrode; a dielectric layer; and a stabilizing film adjacent to the dielectric layer, comprising a plurality of different layers, formed by atomic layer deposition, the plurality of different layers comprising an insulating layer and a semiconducting layer, the dielectric layer and the stabilizing film being between the nanostructured conductive electrode and the counter-electrode.

The capacitor may further comprise a set of axially-aligned carbon nanotubes having a diameter of 10-100 nm and length of at least 10 μm provided as nanostructured features of the nanostructured conductive electrode; and a conformal conductive layer is formed over the set of axially-aligned carbon nanotubes; wherein the dielectric layer comprises a conformal dielectric has a thickness of between 2 nm and 1,000 nm; the conformal stabilizing film comprises the at least one insulating layer having a thickness less than 1 nm and a band gap of at least 5 eV; the counter electrode comprises a conductive layer formed over the conformal dielectric and the conformal stabilizing layer; the at least one semiconducting layer has a thickness of less than 1 nm and a band gap of less than 4 eV; and the at least one insulating layer and the at least one semiconducting layer have a respective difference in Gibbs free energy of more than 2%.

It is a further object to provide a capacitor, comprising a substrate having a surface; an array of nanotubes extending from the surface; a first electrode conformal to a shape of the array of nanotubes extending from the surface; a dielectric layer, formed by atomic layer deposition, having a shape of the array of nanotubes extending from the surface; a stabilizing layer, adjacent to the dielectric layer, comprising alternating layers of an insulating metal oxide and a semiconducting metal oxide; and a second electrode, wherein the nanotubes have a height of at least 100 μm, and the dielectric layer and the stabilizing layer are between the first electrode and the second electrode.

Another object provides an electronic device, comprising: a substrate; a conductive electrode; a dielectric layer; and a conformal stabilizing film adjacent to the dielectric layer, comprising a plurality of alternating layers at least one insulating layer and at least one semiconducting layer, wherein the dielectric layer and the conformal stabilizing film are disposed between the substrate and the conductive electrode, and wherein a potential applied to the conductive electrode modulates a property of the substrate. The substrate may be a semiconductive or doped semiconductor field effect device, having electronic properties such as conductance modulated by an electric field supplied by the conductive electrode through the dielectric layer.

It is a further object to provide a device, comprising: a lower layer; a conductive electrode; a dielectric layer; and a conformal stabilizing film adjacent to the dielectric layer, comprising a plurality of alternating layers comprising at least one insulating layer and at least one semiconducting layer, wherein the dielectric layer and the conformal stabilizing film are disposed between the substrate and the lower layer.

A potential applied to the conductive electrode modulates a property of the lower layer. For example, the lower layer is a silicon or other semiconductor substrate, and the conductive electrode serves as a gate for a field effect modulation of the silicon or other semiconductor substrate.

The device may comprise a second device, comprising: a second conductive electrode; a second dielectric layer; and a second conformal stabilizing film adjacent to the second dielectric layer, comprising a second plurality of alternating layers comprising at least one insulating layer and at least one semiconducting layer, wherein the second dielectric layer and the second conformal stabilizing film are disposed between the second lower layer and the conductive electrode, and the device and the second device are each capacitors, and are formed in a monolithic stack. The conductive electrode and the second conductive electrode may be nanostructured or without surface area enhancement features.

The conductive or semiconducting lower layer may be a conducting lower layer, and at least one second device provided on the device, each second device comprising: a second conductive electrode; a second dielectric layer; and a second conformal stabilizing film adjacent to the second dielectric layer, comprising a second plurality of alternating layers comprising at least one insulating layer and at least one semiconducting layer, wherein the second dielectric layer and the second conformal stabilizing film are disposed between the second conductive lower layer and an underlying structure, and the device and the at least one second device each being capacitors, formed in a monolithic stack, the monolithic stack having a number of second device adapted to achieve a desired capacitance value.

It is a still further object to provide a capacitor, comprising a set of axially-aligned carbon nanotubes having a diameter of 50 nm and length of at least 100 μm; a conformal conductive layer formed over the set of nanotubes; a conformal dielectric having a thickness of e.g., between 4 nm and 6 nm, but generally within a range of 2-1,000 nm; a conformal stabilizing layer comprising at least one insulating layer less than 1 nm thick having a band gap of at least 5 eV and at least one semiconducting layer having a band gap of less than 4 eV, the insulating layer and the semiconducting layer having a difference in Gibbs free energy of more than 2%; and a conductive layer formed over the conformal dielectric and the conformal stabilizing layer.

Another object provides a capacitor comprising an insulating substrate; a plurality of nanostructures, comprising nanotubes, nanowires, or nano-recesses formed on the substrate, the nanostructures having an aspect ratio of at least 10 and a fill ratio of at least 20%, the plurality of nanostructures having a conductive surface; a series of atomic layer deposition layers, comprising at least: a dielectric layer having a thickness of at least 4 nm, and a stabilizing layer of at least 20 nm, comprising repeating sets of adjacent different atomic layer deposition deposited films; and, a second conductive conformal coating on the series of atomic layer deposition layers.

It is also an object to provide a capacitor, comprising: a nanostructured conductive electrode comprising protrusions or invaginations, having a surface, the surface having a 3D surface area at least ten times greater than a planar area of the surface; a counter-electrode; a dielectric layer; and a stabilizing film adjacent to the dielectric layer, comprising a plurality of different layers, formed by atomic layer deposition, the plurality of different layers comprising at least a set of separated insulating layers and a set of separated semiconducting layers, the dielectric layer and the stabilizing film being between the nanostructured conductive electrode and the counter-electrode, a capacitance of the capacitor being dependent on a thickness of the dielectric layer and the 3D surface area, and being at least 90% independent of the stabilizing film, the stabilizing film and dielectric together having a leakage current of less than 1 mA at a voltage of 1 V.

It is an object to provide a method of forming a capacitor comprising providing a nanostructured conductive electrode, having a 3D surface area at least 10 times a planar area of the nanostructured conductive electrode, on a substrate; depositing a dielectric layer conformed to the nanostructured conductive material by atomic layer deposition and a stabilizing film comprising a plurality of different alternating layer types comprising an insulating layer type and a semiconducting layer type, by atomic layer deposition; forming a counter-electrode over the deposited dielectric layer and stabilizing film; and forming isolated electrical connections to the nanostructured conductive electrode and the counter-electrode.

The dielectric layer may comprise at least one of TiO₂, Al₂O₃, SiO₂, Si₃N₄, SiO₂₋ₓNₓ, TIN, TiO₂₋ₓNₓ, Ta₂O₅, SrTiO₃, ZrO₂, HfO₂, HfSiO₄, ZnSiO₄, La₂O₃, Y₂O₃, a-LaAlO₃, Pr₂O₃, Gd₂O₃, Lu₂O₃, BaTiO₃, Sr, Ba—TiO₃ (SBT), Ba, Sr—TiO₃)BST), SrO, CaO, BaO, ZnO, MgO, and mixtures thereof.

The dielectric layer may have a thickness of at least 2 nm, e.g., 2 nm, 3 nm, 4 nm, 5 nm, 6 nm, 7 nm, 8 nm, 9 nm or 10 nm, or thicker.

The stabilizing layer may be formed as repeated sets of the different layers each preferably having a thickness of 1 nm or less, e.g., 1.0 nm, 0.9 nm. 0.8 nm, 0.7 nm, 0.6 nm, 0.5 nm, 0.4 nm, 0.3 nm, 0.25 nm, 0.2 nm, 0.15 nm.

The dielectric layer alone may have a characteristic leakage current of >1 mA at 1 V, while the dielectric layer plus stabilizing layer may have a leakage current of <100 μA and 2 V.

The stabilizing film may be formed of alternating layers of 0.3 nm TiO₂ and 0.3 nm Al₂O₃, with e.g., 80-110 layers, 110-140 layers, 140-180 layers, 180-220 layers, 220-280 layers, 280-350 layers, or 350-500 layers formed of each.

The stabilizing film may be at least 12 nm thick, 12-18 nm thick, 18-20 nm thick, 20-22 nm thick, 22-25 nm thick, 25-30 nm thick, 30-40 nm thick, 40-50 nm thick, 50-75 nm thick, or 75-100 nm thick.

The dielectric layer may be formed by atomic layer deposition on the nanostructured conductive electrode, and the stabilizing film may be formed by atomic layer deposition over the dielectric layer. Alternately, the stabilizing film may be formed by atomic layer deposition over the nanostructured conductive electrode, and the dielectric layer is formed by atomic layer deposition on the stabilizing film.

The stabilizing film may be formed adjacent to the nanostructured conductive electrode and a second stabilizing film may be formed adjacent to the counter-electrode.

The dielectric layer may be formed adjacent to the nanostructured conductive electrode and a second dielectric layer may be formed adjacent to the counter-electrode.

The stabilizing film may be a nanolaminate comprising alternating layers of at least two materials including at least one insulator, e.g., Al₂O₃, and at least one semiconductor, e.g., TiO₂.

The at least one insulator and at least one semiconductor may each have a Gibbs free energy that differs by less than 5%, 4%, 3%, 2%, 1%, or 0.5%. The Gibbs free energy difference may also be more than 2%, 3%, 4%, 5%, 7.5%, 10%, 15%, or 20%. The Gibbs free energy of a layer may be tuned by doping of a layer or mixing of components. Because the stabilizing film is formed by ALD, the opportunity arises to transition between layers using a mix of the later components or using a different interfacial layer.

The nanolaminate cushion of the stabilizing film comprises at least one of insulating dielectric like Al₂O₃, SiO₂, ZrO₂, HfO₂ and one of semiconducting material like TiO₂, ZnO.

The nanostructured conductive electrode may have a surface conformation dependent on zinc oxide nanorods, copper nanorods, or carbon nanotubes, for example. If the material is non-conducting, a conductive layer (typically metal) may be formed on top of the structures.

The surface of the nanostructured conductive electrode may comprise a set of recesses and/or protrusions. The recesses or protrusions may extend at least 10μ, 20μ, 30μ, 40μ, 50μ, 60μ, 70μ, 80μ, 90μ, 100μ, 110μ, 120μ, 130μ, 140μ, 150μ, 160μ, 170μ, 180μ, 190μ, 200μ, 210μ, 220μ, 230μ, 240μ, 250μ, 300μ, 350μ, 400μ, 450μ, 500μ, 600μ, 700μ, 800μ, 900μ, 1000μ or more, and may have varying heights or depths. For example, as nanotubes grow long, they may curl, and therefore may have heterogeneous lengths to avoid tangling. If a nanotube is excessively long, it may interfere with an adjacent layer of a multi-layer structure. Therefore, after a layer is formed, it may be planarized, for example using a chemical mechanical polishing to sever long fibers, and then capped with an insulating layer, before a subsequent layer is formed.

A substrate may be provided below the nanostructured conductive electrode.

The capacitor may be a stacked multilayer capacitor comprising a second capacitor, the second capacitor comprising: wherein the counter-electrode comprises a second nanostructured conductive electrode, having a second surface comprising nanostructured features, having a second 3D surface area at least ten times greater than a projected surface area of the second surface; a second counter-electrode; a second dielectric layer, conformed to the second surface and being disposed between the second nanostructured conductive electrode and the second counter-electrode; and a second stabilizing film adjacent to the second dielectric layer, comprising a plurality of different layers, formed by atomic layer deposition, wherein the second planar area may be superposed on the planar area. Multiple capacitor layers may be formed in sequence superposed on the same substrate. These are typically connected in parallel to increase capacitance, though in some cases a series connection, or series-parallel connection is provided.

The surface of the nanostructured conductive electrode may have an aspect ratio of at least 10, 20, 30, 40, 50, 60, 70, 80, 90, 100, 125, 150, 175, 200, 233, 266, 300, 350, 400, 450, 500, 600, 700, 800, 900, 1000, 2000, 3000, 4000, or 5000 for example. A carbon nanotube with a diameter of 50 nm and a length of 200 μ has an aspect ratio of 4,000.

The surface of the nanostructured conductive electrode may have an areal fill ratio of at least 10%, 12.5%, 15%, 17.5%, 20%, 22.5%, 25%, 27.5%, 30%, 32.5%, 35%, 37.5%, 40%, 45%, 50%, 55%, 60%, 65%, or 70%, for example.

The surface of the nanostructured conductive electrode may comprise an aspect ratio of at least 10, e.g., 10, 20, 30, 40, 50, 60, 70, 80, 90, 100, or more, and an areal fill ratio of at least 10%. The surface of the nanostructured conductive electrode may comprise an aspect ratio of at least 100, and an areal fill ratio of at least 20%, e.g., 20%, 21%, 22%, 23%, 24%, 25%, 27.5%, 30%, 35%, 40%, 45%, 50%, etc.

The nanostructured conductive electrode may comprise nanofibers which have an aspect ratio of at least 200, and an areal fill ratio of at least 30%.

The nanostructured conductive electrode may comprise a regular array (e.g., a deterministic placement, or self-organizing regular arrangement) of features, or irregular (non-deterministic, chaotic) arrangement of features.

The nanostructured conductive electrode surface may conformally correspond to an array of cylindrical bores in a substrate below the planar area.

The nanostructured conductive electrode surface may conformally correspond to an array of nanowires vertically extending from a substrate below the planar area.

The dielectric layer may comprise at least one of CaCu₃Ti₄O₁₂, (Ba,Sr) TiO₃, (Sr,Ba) TiO₃, BaTiO₃, SrTiO₃, TiO₂, Al₂O₃, SiO₂, Si₃N₄, SiO₂xNₓ, TiN, TiO₂₋ₓNₓ, Ta₂O₅, ZrO₂, HfO₂, HfSiO₄, ZnSiO₄, La₂O₃, Y₂O₃, a-LaAlO₃, Pr₂O₃, Gd₂O₃, Lu₂O₃, SrO, CaO, BaO, ZnO, and MgO.

The nanostructured conductive electrode may comprise a metal film overlaying a textured substrate.

The nanostructured conductive electrode may comprise a chemical vapor deposition formed metal film overlaying a textured substrate.

The stabilizing film may comprise a layer having a bandgap of at least 3.5 eV, 4 eV, 5 eV, 6 eV, 7 eV, 8 eV, 8.8 eV, 9 eV, 9.2 eV, or 10 eV. The plurality of layers of the stabilizing film may comprise layers each having a bandgap of at least 5 eV.

The capacitor may have a stored charge with a voltage potential of at least 1.5 V, 1.75 V, 2 V, 2.25 V, 2.5 V, 2.75 V, 3 V, 3.2 V, 3.5 V, 3.75 V, 4 V, 4.25 V, 4.5 V, 4.75 V, 5 V, 5.25 V, or 5.5 V, or more, between the nanostructured conductive electrode and the counter-electrode.

The dielectric layer has a thickness of 1 nm, 2 nm, 2.2 nm, 2.4 nm, 2.6 nm, 2.8 nm, 3 nm, 3.25 nm, 3.5 nm, 3.75 nm, 4 nm, 4.5 nm, 5 nm, 5.5 nm, 6 nm, 6.5 nm, 7 nm, 7.5 nm, 8 nm, 9 nm, 10 nm, 10-15 nm, 12-20 nm, 15-25 nm, 20-30 nm, or more.

The dielectric layer in isolation may have a breakdown voltage less of than 1 V, between 1 and 1.25 V, between 1.25 and 1.5 V, between 1.5 and 2 V, between 2 and 2.5 V, between 2.5 and 3 V, between 3 and 3.5 V, or of at least 3.2 V.

The different layers of the stabilizing film each have a thickness of less than 2 nm, between 1.5 nm and 2 nm, between 1.2 nm and 1.5 nm, between 1 nm and 1.2 nm, between 0.9 nm and 1 nm, between 0.8 nm and 0.9 nm, between 0.7 nm and 0.8 nm, between 0.6 nm and 0.7 nm, between 0.5 nm and 0.6 nm, between 0.4 nm and 0.5 nm, between 0.3 nm and 0.4 nm, 3 nm, between 0.25 nm and 0.35 nm, between 0.25 nm and 0.3 nm, between 0.2 nm and 0.25 nm, between 0.175 nm and 0.2 nm, between 0.15 nm and 0.175 nm, between 0.125 nm and 0.15 nm, between 0.1 nm and 0.125 nm, or less than 0.1 nm.

The different layers of the stabilizing film bay comprise at least two different types, and the at least two different types of layers may have the same thickness or different thicknesses.

The different layers of the stabilizing film may comprise at least two different types, and the at least two different types of layers have a thickness of 0.3 nm.

The different layers of the stabilizing film may have a thickness of 0.3 nm each, and be formed as between 10-15, 15-20, 20-25, 25-30, 30-35, 35-40, 40-45, 45-50, 50-55, 55-60, 60-65, 65-70, 70-75, 75-80, 80-85, 85, 90, 90-95, 95-100, 100-110, 110-120, 120-130, 130-140, 140-150, 150-165, 165-180, 180-195-195-210, 210-230, 230-250, 250-275, 275-300, 300-333, 333-367, 367-400, 400-440, 440-480, 480-525, or more sets of alternating layers, triplets, quartets, etc.

The surface may overly a conductive structure, or may be deposited of a conductive material (e.g., a metal film) over a non-conductive structure. For example, a silicon substrate would generally be non-conductive (unless doped), while carbon nanotubes or copper nanotubes would be conductive.

The stabilizing film layer may comprise any or all of TiO₂, SiO₂, Al₂O₃, in separate ALD deposited layers.

The stabilizing film layer may comprise a metal oxide insulating layer having a bandgap of 5 eV, 6 eV, 7 eV, 8 eV, 8.8 eV, 9 eV, 9.2 eV or more. The stabilizing film layer may comprise at least two different metal oxide insulating layers each having a bandgap of 5.0 eV or more.

The stabilizing film layer may comprise a metal oxide semiconducting layer has a bandgap of less than 4 eV, e.g., 3.5 and 3.2. The operating voltage of the capacitor may be e.g., at least 3 V, 3.3V, 3.5 V, 4 V, 4.5 V, 5 V, 5.5 V, or 6 V.

At least two layers of the stabilizing film may have a Gibbs free energy within 2% or higher of each other.

The invaginations may be formed over a regular array of cylindrical recesses in a substrate, or a regular array of carbon nanotubes, for example. The recesses may be formed by a subtractive manufacturing process, such as etching, ion beams, electron beams, etc. The nanotubes may be grown on a seed, e.g., nanoparticles deposited in a shallow recess, by e.g., chemical vapor deposition on platinum and/or cobalt nanoparticles in nanoholes.

The capacitor may have a capacitance of at least 5 μF/cm², 10 μF/cm², 20 μF/cm², 50 μF/cm², 75 μF/cm², 100 μF/cm², 150 μF/cm², 200 μF/cm², 250 μF/cm², 300 μF/cm², 400 μF/cm², 450 u F/cm², 500 μF/cm², 550 μF/cm², 600 μF/cm², 650 μF/cm², 700 μF/cm², 750 μF/cm², 800 μF/cm², 850 μF/cm², 865 μF/cm², 900 μF/cm², 1000 μF/cm², 1100 u F/cm², 1250 μF/cm², 1500 μF/cm², 1750 μF/cm², 2000 μF/cm², 2500 u F/cm², or more.

The nanotubes may be carbon nanotubes, and the stabilizing layer may comprise at least two metal oxide layers selected from the group consisting of TiO₂, SiO₂, and Al₂O₃. Since one of the layers is desired to be semiconductive, the TiO₂ fulfills this criterion, though another semiconductor may be employed.

The first electrode may comprise platinum, and the substrate may comprise silicon, with an oxidized niobium layer formed over the silicon substrate, and an anodized aluminum oxide layer formed over the oxidized niobium layer.

It is a further object to provide a capacitor comprising a first electrode; a nanoscale dielectric, defining the capacitor's capacitance; a current carrying nanolaminate layered on the dielectric, comprising alternating layers of two or more materials having different Gibbs free energy, comprising at least one insulator and at least one semiconductor, protecting and stabilizing the dielectric, and forming a dielectric-nanolaminate stack; a second electrode; the dielectric and the nanolaminate being disposed between the first electrode and the second electrode.

The dielectric or nanolaminate may be formed on the first electrode.

The second electrode may be formed on the dielectric or nanolaminate.

The nanolaminate may be formed on both sides of the dielectric.

Dielectric layers may be formed on both sides of the nanolaminate.

The capacitor may be planar.

The first electrode may have a depth pattern.

The nanolaminate may comprise at least ten alternating layers.

The first electrode and the second electrode may each be metal layers.

The first electrode may be formed on a substrate having a semiconducting surface.

The first electrode may be formed on a substrate having an insulating surface.

The capacitor may further comprise a substrate beneath the first electrode, having surface area enhancing structures.

The surface area enhancing structures may comprise at least one of trenches, holes, rods, needles, tubes, and tubules.

The surface area enhancing structures may comprise an ordered array or a non-ordered assemblage.

The surface area enhancing structures may comprise a heterologous material deposited on the substrate, beneath the first electrode.

The dielectric or nanolaminate may be conformal with the surface area enhancing structures.

The first electrode and the second electrode may each be conformal with the surface area enhancing structures.

The first electrode may comprise surface area enhancing structures.

It is a further object to provide a capacitor, comprising: a nanostructured conductive electrode, having a surface comprising nanostructured features, having a 3D surface area at least ten times greater than a projected surface area of the surface; a counter-electrode; a dielectric layer, conformed to the nanostructured features and being disposed between the nanostructured conductive electrode and the counter-electrode; and a conformal stabilizing film adjacent to the dielectric layer, comprising at least one insulating layer and at least one semiconducting layer.

The dielectric layer may be formed by atomic layer deposition on the nanostructured conductive electrode, and the conformal stabilizing film is formed by atomic layer deposition over the dielectric layer. The conformal stabilizing film may be formed by atomic layer deposition over the nanostructured conductive electrode, and the dielectric layer may be formed by atomic layer deposition on the conformal stabilizing film. The conformal stabilizing film may be formed adjacent to the nanostructured conductive electrode and a second conformal stabilizing film is formed adjacent to the counter-electrode, wherein the dielectric layer is disposed between the conformal stabilizing film and the second conformal stabilizing film. The dielectric layer may be formed adjacent to the nanostructured conductive electrode and a second dielectric layer is formed adjacent to the counter-electrode, wherein the conformal stabilizing film is disposed between the dielectric layer and the second dielectric layer.

The conformal stabilizing film may be a nanolaminate comprising alternating layers of at least two different materials including the at least one insulating layer and at least one semiconducting layer. The nanolaminate may comprises at least two of Al₂O₃, SiO₂, HfO₂, ZnO, SnO, ZrO, and TiO₂.

The conformal stabilizing layer may comprise the at least one insulating layer having a thickness of less than 1 nm and having a band gap of at least 8.8 eV, and the at least one semiconducting layer having a band gap of less than 3.5 eV, the at least one insulating layer and the at least one semiconducting layer having a difference in Gibbs free energy of at least 2%.

The nanostructured features may be dependent on at least one of zinc oxide nanorods, copper nanorods, and carbon nanotubes. The nanostructured surface may comprise a set of hollow elongated non-interconnected recesses.

The capacitor may be a stacked multilayer capacitor comprising a second capacitor, the second capacitor comprising: a second nanostructured conductive electrode, having a second surface comprising nanostructured features, having a 3D surface area at least ten times greater than a projected second planar area of the second surface; a second counter-electrode; a second dielectric layer, conformed to the nanostructured features and being disposed between the second nanostructured conductive electrode and the second counter-electrode; and a second conformal stabilizing film adjacent to the second dielectric layer, comprising at least one insulating layer and at least one semiconducting layer, wherein the second capacitor is superposed on one of the nanostructured conductive electrode and the counter-electrode.

The nanostructured features may have an aspect ratio of at least 10.

The nanostructured features may be disposed in a regular array.

The surface comprising nanostructured features may comprise an array of cylindrical bores in a substrate. The surface comprising nanostructured features may comprise an array of nanowires vertically extending from a substrate.

The conformal stabilizing film may comprise a layer having a bandgap of at least 5 eV.

The dielectric layer may have a breakdown voltage of between 1 and 2.5 V, and the capacitor may have an operating voltage of at least 3 V. Thus, the stabilizing layer increases the operating voltage of the capacitor with respect to a capacitor comprising the nanostructured conductive electrode, the counter-electrode, and the dielectric layer, but without the conformal stabilizing film.

The dielectric layer may have a breakdown voltage of at least 50 V, and for example may have a breakdown voltage of at least 50 V, 75 V, 100 V, 150 V, 200 V, 250 V, 500 V, 750 V, 1000 V, or more.

A projected surface area refers to the two-dimensional area of an object when it is projected onto a plane. For example, the projected surface area of a contoured nanostructured surface may correspond to its surface area when considering only microscale or larger features, but excluding surfaces at the nanoscale. For a planar nanostructured surface, the projected surface area is the area of the planar projection.

It is also an object to provide a capacitor, comprising: a nanostructured conductive electrode comprising protrusions or invaginations, having a 3D surface area at least ten times greater than projected surface area; a counter-electrode; a dielectric layer between the nanostructured conductive electrode and the counter-electrode; and a conformal stabilizing film adjacent to the dielectric layer and between the nanostructured conductive electrode and the counter-electrode, comprising a plurality of different layers, comprising at least one insulating layer and at least one semiconducting layer.

The protrusions or invaginations may comprise a set of axially-aligned carbon nanotubes having a diameter of 10-100 nm, e.g., 50 nm and length of at least 10 μm, e.g., 10 μm, 20 μm, 30 μm, 40 μm, 50 μm, 60 μm, 70 μm, 80 μm, 90 μm, 100 μm, or more. The conformal conductive layer may be formed over the set of nanotubes. The dielectric layer may comprise a conformal dielectric having a thickness of between 2-1000 nm, e.g., between 4 nm and 6 nm.

The conformal stabilizing film may comprise the at least one insulating layer having a thickness less than 1 nm and having a band gap of at least 8.8 eV, and the at least one semiconducting layer having a thickness of less than 1 nm and having a band gap of less than 3.5 eV, the at least one insulating layer and the at least one semiconducting layer having a difference in Gibbs free energy of more than 2%. The counter electrode may comprise a conductive layer formed over the conformal dielectric and the conformal stabilizing layer.

The capacitor may be a monolithically stacked capacitor, having a plurality of the capacitor structures repeated in the vertical array with respect to the plane of the layers. Therefore, the capacitor may further comprise a second capacitor, comprising: a second nanostructured conductive electrode, having a second surface comprising nanostructured features, having a second 3D surface area at least ten times greater than a projected surface area of the second surface; a second counter-electrode; a second dielectric layer, conformed to the nanostructured features and being disposed between the second nanostructured conductive electrode and the second counter-electrode; and a second conformal stabilizing film adjacent to the dielectric layer, comprising at least one insulating layer and at least one semiconducting layer, wherein the capacitor and the second capacitor are formed in a monolithic stack.

It is a further object to provide a method of forming a capacitor comprising: providing a nanostructured conductive electrode, having a 3D surface area at least 10 times a projected surface area of the nanostructured conductive electrode, on a substrate; depositing a dielectric layer conformed to the nanostructured conductive electrode by atomic layer deposition; depositing a stabilizing film comprising a plurality of different alternating layer types comprising an insulating layer type and a semiconducting layer type, by atomic layer deposition; forming a counter-electrode over the deposited dielectric layer and stabilizing film; and forming isolated electrical connections to the nanostructured conductive electrode and the counter-electrode.

The method may further comprise forming a stacked capacitor by providing a second nanostructured conductive electrode, having a 3D surface area at least 10 times a projected surface area of the second nanostructured conductive electrode, on the counter-electrode; depositing a second dielectric layer conformed to the second nanostructured conductive electrode by atomic layer deposition; depositing a second stabilizing film comprising a plurality of different alternating layer types comprising an second insulating layer type and a second semiconducting layer type, by atomic layer deposition; and forming a second counter-electrode over the deposited second dielectric layer and second stabilizing film. An insulating layer may be formed between the nanostructured conductive electrode and the second counter-electrode, to isolate the layers. The nanostructured conductive electrodes and the counter-electrodes may be electrically connected in parallel to provide a larger capacitance value. The stacked capacitor may also be connected in series, e.g., by electrically connecting the nanostructured conductive electrodes and the second counter-electrode of each successive layer, to provide higher operating voltage. In some cases, series-parallel connections are provided to achieve increased operating voltage and high capacitance values. However, a more typical approach is to ensure that for feasible voltages, the intrinsic voltage rating of the capacitor exceeds the maximum operating voltage, and then provide sufficient surface area to achieve the desired capacitance. This intrinsic voltage rating is achieved by controlling the thickness of the layers, alternating repetitions of the stabilizing layer(s), and selection of layer materials.

Other embodiments are within the scope of the discussion here.

### BRIEF DESCRIPTION OF THE DRAWINGS

Reference is now made briefly to the accompanying drawings, in which:

FIG. 1A shows a UTCC cross-section of a planar configuration including the ultrathin dielectric and cushioning nanolaminate, not to scale.

FIGS. 1B and 1C depict the capacitance (nF/mm²) and breakdown voltage of a UTCC with respect to dielectric thickness.

FIGS. 2A-2D show Capacitance-frequency and current-voltage performance of 4 nm Al₂O₃ dielectric capacitor with nanolaminate (FIGS. 2A and 2B) and without nanolaminate (FIGS. 2C and 2D).

FIGS. 3A and 3B show the performance of UTCCs with 4 nm Al₂O₃ dielectric along with various thicknesses of nanolaminate cushion as defined by the number of ALD cycles, for a capacitor of area 5×x 5 mm².

FIGS. 3C and 3D show capacitor performance with varying dielectric thicknesses (4, 5 and 6 nm of Al₂O₃ dielectric), for a capacitor of area 5×x 5 mm².

FIGS. 4A-4H show stages in the production of a single layer UTCC for mass production. FIG. 4A shows the substrate. FIG. 4B shows a patterned metal film formed on the substrate. FIG. 4C shows an ALD dielectric coating over the patterned metal film. FIG. 4D shows an additional patterned metal film formed on the ALD dielectric coating, forming a capacitor with top metal layer slightly shifted compared to the bottom layer. The shift is necessary to make sure the capacitors are connected in series without shorting. FIG. 4E shows a dicing pattern of the substrate with a single layer UTCC. FIG. 4F shows the individual UTCC die. FIG. 4G shows an individual UTCC after pad formation. FIG. 4H shows the application of a resin coating on the completed capacitor.

FIGS. 4I-4L showcase the process for multiple-layer UTCC devices, designed to enhance capacitance. FIG. 4I shows repeated deposition of patterned metal layers and ALD dielectric coating to form a multilayer structure. FIG. 4J shows the substrate with multilayer structure diced into individual devices. FIG. 4K shows contact pad formation on the dice. FIG. 4L shows the application of a resin coating on the completed multilayer capacitor.

FIGS. 5A-5C show examples of nanostructures, including Zinc oxide nanorods (FIG. 5A), Copper nanorods (FIG. 5B), and carbon nanotubes (FIG. 5C).

FIGS. 6A and 6B show the design of a high-energy density 3D capacitor using nanostructures grown on a substrate and utilizing a patterned substrate through photolithography.

FIGS. 7A-7I show stages in the production of a 3D capacitor according to the present invention, having nanostructures for increased volumetric efficiency. FIG. 7A shows the substrate, which is conductive. FIG. 7B shows deposition of nanostructures, e.g., nanorods, on the substrate. FIG. 7C shows deposition of an ALD dielectric coating on the nanostructures. FIG. 7D shows deposition of a top metal layer, patterned with a shadow mask, on the ALD dielectric. FIG. 7E shows the substrate diced into individual devices. FIG. 7F shows formation of a first contact pad on one side of the die, not contacting the top metal layer. FIG. 7G shows formation of an insulating coating over the bottom electrode (the substrate) to avoid shorting. FIG. 7H shows formation of a second contact pad on the other side of the die, contacting the top metal layer and insulated from the substrate. FIG. 7I shows the application of a resin coating on the completed capacitor.

FIGS. 8A-8D depicts a cross section schematic diagrams of embodiments of a capacitor, with different arrangements of the dielectric with respect to the ALD nanolaminate cushion. FIG. 8A shows the ALD dielectric deposited over the nanolaminate cushion. FIG. 8B shows the ALD dielectric deposited under the nanolaminate cushion. FIG. 8C shows the ALD dielectric deposited between layers of the nanolaminate cushion. FIG. 8D shows the ALD dielectric deposited both over and under the nanolaminate cushion.

FIG. 9 shows a planar design capacitor.

FIG. 10 shows an electron micrograph of a regular array of nanorods.

FIG. 11 shows an electron micrograph of an irregular array of nanostructures.

FIG. 12 shows a schematic cross section of a capacitor.

FIGS. 13, 14, and 15 depict examples of structure for a laminate of the capacitor.

FIG. 16 depicts an energy band diagram of an example of the capacitor of FIG. 12.

FIG. 17 depicts an Ellingham diagram of Gibbs free energy of materials for use in the capacitor;

FIG. 18 depicts a schematic diagram of an example of the capacitor of FIG. 12.

FIG. 19 depicts the extent of enhanced surface area for various nanorod coverages (density of nanostructures) as a function of height-to-diameter ratio for the capacitor of FIG. 18.

FIGS. 20A-20D depict a flow diagram of an exemplary embodiment of a method to manufacture for use, for example, to manufacture the capacitor with an ordered array of structures of FIGS. 12 and 18.

FIGS. 21A-21C depict various images of an example of the fabrication of the capacitor of FIGS. 12 and 20A-20F showing possible template nano-holes in FIG. 21A and FIG. 21B and structure for carbon nano-tubes in FIG. 21C.

FIG. 22 depicts an image of an example of an ordered array of structures for the capacitor of FIGS. 10 and 20A-20F; the structure comprising carbon nano-tubes that are vertically aligned and of about 240 μm in height.

FIG. 23 depicts a schematic diagram of an example of an ordered array of carbon nanotubes of the capacitor of FIGS. 10 and 20A-20F having structures on two-sides of the substrate.

FIG. 24 depicts a plan view from the top of an example structure showing uniformly spaced nano-apertures formed in the base substrate.

FIG. 25 depicts an elevation view for the cross-section of the example capacitor formed using the structure of FIG. 24.

FIG. 26A-26D depicts a flow diagram of an exemplary embodiment of a method to manufacture the capacitor, for example, to manufacture the capacitor with an ordered array of structures of FIGS. 24 and 25.

FIGS. 27A and 27B illustrate the application of dielectric stacking (dielectric layer+stabilizing film) beyond capacitor use.

FIG. 28 shows the application of UTCC not only as discrete components but also embedded and integrated within a chip package. As shown in FIG. 28, a substrate may be bump-bonded to a circuit board (not shown), and an interposer, which itself has through vias and optional other circuitry. The UTCC dies are bump-bonded to the interposer, to form a multi-UTCC module.

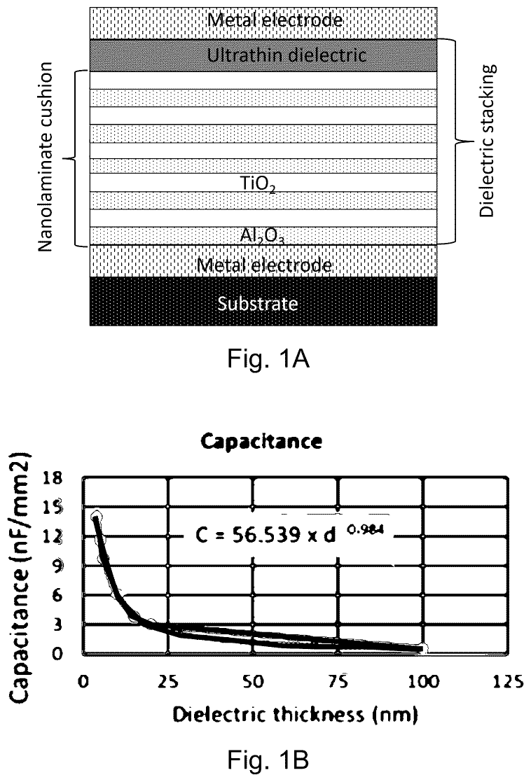

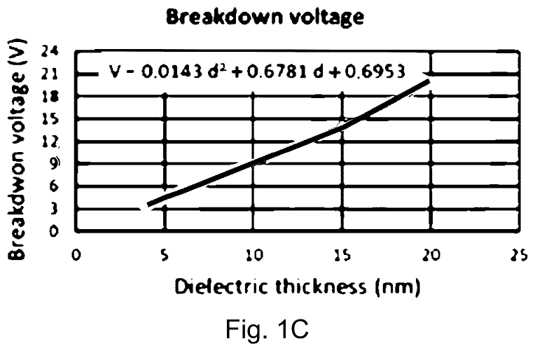

Where applicable like reference characters designate identical or corresponding components and units throughout the several views, which are not to scale unless otherwise indicated. The embodiments disclosed herein may include elements that appear in one or more of the several views or in combinations of the several views. Moreover, methods are exemplary only and may be modified by. for example, reordering, adding, removing, and/or altering the individual stages.

### DETAILED DESCRIPTION OF THE PREFERRED EMBODIMENTS

This invention encompasses methods that allow fabricating ultra thin ceramic capacitors with enhanced surface area electrodes. If a dielectric film is very thin, it can easily suffer breakdown during fabrication, handling and electrical biasing. But a thin dielectric will result in high capacitance because of inverse relationship between its thickness and capacitance. We have developed a nanolaminate cushion that contains a set of nanoscale multilayers of ceramic materials that makes the manufacturing of capacitors with an ultra-thin dielectric material. These unique non-electrolytic dry dielectric capacitors can be either stacked monolithically to make multilayer capacitors or deposited on 3D nanostructures to achieve a desired specific capacitance for specific applications.

Modern electronics requires small size reliable capacitors. The current commercial MLCCs have challenges to be scaled down and thus smaller size MLCCs become expensive. To our understanding, only a handful of companies are making smaller size MLCCs because of the complexity of manufacturing and the resulting higher cost. Our technology inherently allows easy fabrication of small size devices without increasing cost. The major technique used for our capacitors is atomic layer deposition (ALD), which is known for coating defect-free ultrathin materials in multiple nanolaminate configuration with atomic scale precision. Because our technology uses ceramics, they are very reliable as well. The markets that our technology can have application is in high frequency communications where small capacitors (with small specific capacitance values) with minimal use of metal electrodes (required to reduce inductance and thus insertion loss at high frequency).

In addition, the capacitors according to the present technology can replace electrolytic capacitors such as tantalum, which also happens to be a strategic material. The electrolytic capacitors like tantalum are not very reliable but they do come in high capacitance value, which makes them desirable for power stabilization. The technology is non-electrolytic but can be monolithically stacked or coated on nano-structure electrode for higher capacitance. The capacitors will be a non-electrolytic alternative to tantalum capacitors.

In high-frequency applications like RF circuits and high-speed digital systems, the performance of capacitors is crucial. To achieve a high self-resonant frequency, it is desirable to use capacitors with low equivalent series inductance. While Multilayer Ceramic Capacitors (MLCCs) are commonly used in these applications, the demand for high-frequency capacitors has increased with the growth of 5G/6G technology. However, in MLCCs, the amount of metal electrode used contributes to the inductance of the capacitors. Therefore, reducing the number of layers in multilayered capacitors can help decrease the metal electrode, improving their high-frequency performance. This reduction in layers poses a challenge because achieving higher capacitance with fewer layers requires making the ceramic thickness very thin. However, this can lead to issues such as higher leakage current, lower yield, and lower breakdown voltage.

The present technology provides ultrathin ceramic capacitors (UTCC) that offer both high capacitance and optimal reliability. Furthermore, 3D structures are incorporated to further enhance their performance. Reliable ultrathin ceramic capacitors are made possible through the utilization of specially engineered nanolaminate oxide films. These films act as a protective cushion for the thin dielectric, preventing breakdown even at nanometer-scale thickness. The nanolaminate cushion can exist without adding effective thickness to the oxide layer while serving as a current-carrying medium.

A capacitor may be formed from a thin dielectric and a nanolaminate stack deposited on a planar electrode or conformally deposited on a structured electrode. The nanolaminate stabilizes the dielectric allowing it to be thin; thereby increasing the capacitance and reducing the leakage current. The latter increases the capacitor's breakdown and operating voltages. The nanolaminate comprises alternating layers of a semiconductor and an insulator, and is configured with a sufficient number of alternating layers that ensures dielectric stability. In one embodiment, the layers are interdigitated, rather than alternating. That is, the transitions are parallel to the surface, rather than parallel to it. Excess layers do not significantly degrade performance (except based on increased thickness), The capacitance may be increased by forming the first electrode with surface area enhancing structures which increase the effective area. This increases the capacitance per footprint area or specific capacitance. The area enhancing structures can be conductive, semiconducting or insulating, and are not limited by shape or structure. The surface area enhancing structures may be nanotubes or nanorecesses (nanopores), and are preferably formed normal to a surface of a substrate. The normality facilitates manufacture, and may avoid artifacts and capacity reduction due to non-orthogonality.

Incorporation of 2-D and 3-D structures increases the effective area of capacitors leading to higher capacitance per footprint area, or smaller footprint area for a given capacitance. A capacitor may be configured with a combination of a thin dielectric and a nanolaminate composed of multiple alternating layers of two materials. The thin dielectric determines the capacitance and breakdown voltage of the capacitor. The nanolaminate protects the thin-dielectric enhancing its stability and lifetime.

The materials forming the nanolaminate may include oxides, such as titanium oxide (TiO₂), oxygen deficient titanium oxide (TiO₂₋ₓ), aluminum oxide (Al₂O₃), silicon dioxide (SiO₂), or barium titanate (BaTiO₃). The nanolaminate may be configured of alternating layers of a semiconductor material and an insulating material including materials as in U.S. Pat. No. 11,664,172, expressly incorporated herein by reference. The materials may include Al₂O₃, TiO₂ and TiO₂₋ₓ. The protective effect depends on the number of layers in the nanolaminate, and on the materials of both the nanolaminate and the thin-dielectric.

The desired capacitor characteristics determine the required materials and thickness of the thin dielectric. The capacitor may be configured on a substrate which may be planar or structured to increase the area of the capacitor. The area enhancing structures may include ordered or non-ordered arrays of tubes, tubules, rods, trenches, or holes. The tubes and tubules may be carbon, silicon, or boron nanotubes, or compounds of silicon and/or carbon and/or boron. The rods may be metals, semiconducting materials, carbon, zinc oxide or other metal oxides, metal nitrides, metal carbides, or combinations thereof. The trenches or holes may be etched, additively manufactured, subtractively manufactured, displacement manufactured, lithographed or transfer printed.

The material of the area enhancing structures may be an insulator, a semiconductor, induced semiconductor, or a conductor. Area enhancing materials may include microscale or nanoscale zinc oxide (ZnO) rods and needles, carbon rods or fibers, and metal rods or fibers such as copper. One of the capacitor's electrodes may be coated on the planar substrate or conformally on an area enhanced structured substrate, or configured from conducting area enhancing structures. The nanolaminate and thin-dielectric may be conformally coated on the first electrode including its 2-D and 3-D structures. The nanolaminate and thin dielectric may be conformally coated on the first electrode. The second electrode may be conformally coated on the thin-dielectric/nanolaminate stack. This sequential process may form the capacitor termed here the ultrathin ceramic capacitor (UTCC).

The ultrathin ceramic capacitors (UTCC) are made through the utilization of specially engineered nanolaminate oxide films. These films act as a protective cushion for the thin dielectric, preventing breakdown even at nanometer-scale thickness. The unique characteristic of the nanolaminate cushion is its ability to exist without adding effective thickness to the oxide layer while serving as a current-carrying medium.

The nanolaminate cushion is typically made up of alternating layers of two or more oxides, which could include but are not limited to, one insulating oxide and one semiconducting oxide. The insulating oxide could be Al₂O₃, SiO₂, or other options, while the semiconducting oxide could be TiO₂ or other oxides or doped materials. The semiconducting layer may comprise doping with recombination centers, such as gold. The semiconducting layer may be n- or p-doped. These two layers are repeated multiple times, to form the nanolaminate. The nanolaminate possesses properties that enable it to behave like a “dielectric cushion”. These properties arise from the optimized thickness of each individual oxide layer. Typically, the Al₂O₃ type oxide layer is very thin (˜0.1 nm to ˜1 nm), while the TiO₂ type oxide layer can vary in thickness (˜0.1 nm to ˜500 nm). The repeated layering of these oxides results in the desired thickness for the nanolaminate cushion. By using defective Al₂O₃ layer and semiconducting TiO₂ layer, the nanolaminate is able to acquire conductive properties without affecting the capacitance when combined with the dielectric, thus appearing as if no additional substance has been introduced. The capacitance and the breakdown voltage results from the dielectric thickness. Increasing the nanolaminate thickness does not affect the capacitance or the breakdown voltage. The ALD appears to be the most appropriate technique for growing this nanolaminate cushion, although molecular beam epitaxy (MBE), pulse laser deposition (PLD) and other methods are also possible.

The preferred capacitor is made on a planar or nanostructure surface. The basic device structure is conductive electrode followed by nanolaminate cushion, the dielectric layer and the second conductive electrode. The dielectric layer can be placed before the nanolaminate cushion, after the nanolaminate cushion or in between the two nanolaminate cushions, or on both sides of the nanolaminate cushion. The stabilizing function of the nanolaminate cushion permits use of dielectric layers that may be infeasible without it.

Concepts advanced with respect to U.S. Pat. No. 11,664,172 and manufacturing processes for capacitors are disclosed.

Capacitors are conceptually composed of two conducting electrodes separated by a dielectric material. Energy is stored in an electric field across the dielectric, and the electrodes provide a convenient mechanism to supply and withdraw electrical charge. The energy stored in the electric field is proportional to the capacitance, and quadratic with respect to the magnitude of the electric field. The capacitance of a capacitor is determined by the dielectric constant of the dielectric material, its thickness, which corresponds to the separation of the electrodes, and the area of the electrodes and dielectric. Thus, thinner dielectrics increase the capacitance since capacitance scales inversely with the thickness of the dielectric. The capacitance also scales directly with the area of the capacitor. The disclosed capacitors, referred to as ultrathin ceramic capacitors (UTCCs) have decreased thickness and increased area with respect to typical capacitors, thereby significantly increasing the capacitance. For a given footprint, the disclosed capacitors will have greater capacitance than conventional technologies, or for the same capacitance they will have a smaller footprint.

Another important parameter is the capacitor's operating voltage, which is associated with the dielectric material's dielectric strength. Dielectric strength is the voltage difference applied across the capacitor at which a specified current is passed through the material per unit thickness of the material. (the standardized current for measurement may not be the same as the functional limit on a real-world device). When a direct current (DC) voltage is applied across the capacitor, ideally the capacitor would pass zero electrical current. In practice, this is not the case. If a DC voltage across the capacitor is increased, at some voltage, determined by the dielectric strength of the dielectric material, a measurable current will be detected. This current is defined as the leakage current. When the leakage current reaches a value accepted by convention, the voltage is termed the breakdown voltage, i.e. the voltage at which the capacitor ceases to meet its functional specifications. The maximum operating voltage is then specified as some fraction of the breakdown voltage. For a given dielectric material, the breakdown voltage increases as the dielectric thickness increases, but the tradeoff is that the capacitance decreases as the thickness increases. In most cases, current practice limits the dielectric thickness to a few micrometers. This also limits the capacitance.

Configurations and fabrication processes are disclosed for UTCCs that allow the dielectric thickness to be reduced while maintaining acceptable leakage currents, i.e., creating conditions of acceptable breakdown and operating voltages. This is achieved by the disclosed current-carrying nanolaminate composed of alternating layers of semiconducting and insulating materials specifically configured in combination with the dielectric material that defines the capacitor characteristics. This combination produces a capacitor whose characteristics are defined by the thin dielectric with dielectric constant and strength characteristic of its bulk material.

The dielectric thicknesses may be a few nanometers, combined with a nanolaminate. The capacitance values are consistent with the dielectric constant of the dielectric material and the breakdown voltages are consistent with its dielectric strength.

Forming electrodes with large numbers of structures that are smaller than the footprint area of the capacitor is a way of increasing capacitor area relative to its footprint. Such structures are not restricted to any specific dimensional requirement, but smaller structures can be present in larger numbers per unit footprint area thereby increasing the area by a larger factor. Increasing the area of a capacitor directly increases its capacitance. UTCCs are configured by coating the surface area enhanced first electrode with the dielectric/nanolaminate combination, and coating the combination with the second electrode. This further miniaturizes UTCCs, especially since the UTCCs are thinner than current typical capacitors. Examples given below demonstrate large numbers of surface area enhancing structures with dimensions on the nanoscale.

Current practice, particularly in multilayered ceramic capacitors (MLCCs), is to stack multiple capacitor units into a single package. UTCCs, both planar and surface area enhanced, are also stackable, but the package can be thinner for a given capacitance and breakdown voltage because each unit within the package is thinner, leading to even larger scale miniaturization.

Capacitors have intrinsic electrical characteristics other than just capacitance, which limit their functionality. Each capacitor has an equivalent series inductance and equivalent series resistance making each capacitor a resonant network or RLC circuit. This means that capacitance decreases with increasing frequency. Operation at higher frequencies is a factor limiting the advancement of state-of-the-art electronics. Capacitors with higher specific capacitance will have less intrinsic inductance. as they will have lower metal content, leading to a higher self-resonance frequency, and thereby higher operating frequencies.

In high-frequency applications like radio frequency (RF) circuits and high-speed digital systems, the performance of capacitors is crucial. To achieve a high self-resonant frequency, it is desirable to use capacitors with low equivalent series inductance. While MLCCs are commonly used in these applications, the demand for high-frequency capacitors has increased with the growth of 5G/6G technology. However, in MLCCs, the amount of metal electrode needed contributes to the inductance of the capacitors adversely affecting their performance. Therefore, reducing the number of layers in MLCCs decreases the total amount of metal forming the electrode, improving their high-frequency performance. This reduction in layers poses a challenge because achieving higher capacitance with fewer layers requires making the ceramic thickness very thin. However, this can lead to issues such as higher leakage current, lower yield, and lower breakdown voltage.

To address the challenge of improving capacitor performance, the present technology provides ultrathin ceramic capacitors (UTCCs) that offer both higher capacitance in a significantly smaller volume and optimal reliability. Furthermore, 3D structures are incorporated to further enhance UTCC performance. This allows achieving the desired high-frequency characteristics while maintaining optimal capacitance values.

Reliable UTCCs have been made possible through the utilization of specially engineered nanolaminate oxide films. These films act as a protective cushion for the ultrathin dielectric, while improving breakdown, i.e. low leakage currents, even at nanometer-scale thickness. The unique characteristic of the nanolaminate cushion is its protective ability without adding effective thickness to the dielectric oxide layer, while serving as a current-carrying medium. Although the cushion is composed of a combination of different oxides, its properties differ from those of the traditional transparent conducting oxide (TCO).

The nanolaminate cushion may be made up of alternating layers of two oxides 114 & 116, which could include but are not limited to, one insulating oxide and one semiconducting oxide. As an example, the insulating oxide could be Al₂O₃, SiO₂, or other options, while the semiconducting oxide could be TiO₂ or other oxides. The conductivity of the semiconducting oxide is preferably sufficient to redistribute charge evenly within a region of the capacitor, under operating conditions. In some cases, for example, the conductivity may be modulated, for example by photon excitation, voltage potential, or the like. In a further embodiment, the semiconducting oxide may be formed into one or more active devices, e.g., analogous to silicon thin film transistors (TFT).

As noted above, three or more different oxide layers may be provided. The nanolaminate could be a combination of any oxides that differ in their Gibb's free energy. The nanolaminate is not limited to two alternating layers or sets of alternating layers, and could include a larger number of different layers, and the layers need not have a strictly repeating pattern. For example, there may be three different types of layers forming triplets or other organized layer structures. The layers may also be interdigitated. Therefore, the structure comprises interfaces between portions of layers having different characteristics, e.g., Gibbs free energy.

The technology may be used to create pick and place devices with side contacts; capacitors with top and bottom contacts; high voltage breakdown devices; devices with high capacitance; low insertion loss MIM capacitor; and capacitors directly coated on silicon chip, for example. The technology provides devices that are light weight, easy to produce, cost effective, feasible to scale down to smaller size capacitors, are low insertion loss capacitors for high speed chips, and are adaptable to various specs.

The technology advances capacitor energy storage by significantly increasing the surface area of the electrodes, the increases the dielectric constant of the insulating layer, and increases the breakdown voltage with a very thin dielectric layer.

The surface area is maximized by fabricating oriented nanostructures on a small footprint area. These structures, coated with a thin film of high dielectric constant nanolaminates, represent an electrode of the capacitor, and produce improved voltage operations and very high capacitance compared to the present capacitors.

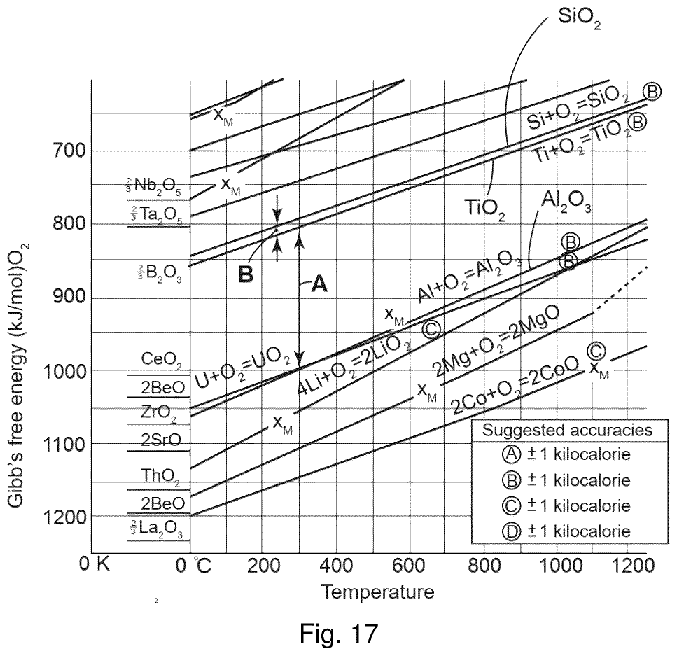

A nanolaminate dielectric material is stacked on nanostructures using an advanced ALD technique. The materials for the nanolaminate cushion can be chosen to have different Gibb's free energy of formation. If the Gibb's free energy is chosen to be higher than 2% (case for TiO₂/Al₂O₃), the nanolaminate stack will only behave as a cushion to allow for the thinnest dielectric layer for a stable thin film capacitor. (FIG. 17)

This results in low current leakage, providing high energy density capacitors that have smaller footprints and higher breakdown voltage than commercially available ones.

This technology has the potential to significantly impact consumer electronics market as a component in electronic circuits and small scale energy storage technologies such as wearable devices, sensors, and battery-capacitor hybrids for power stabilization.

### Example 1

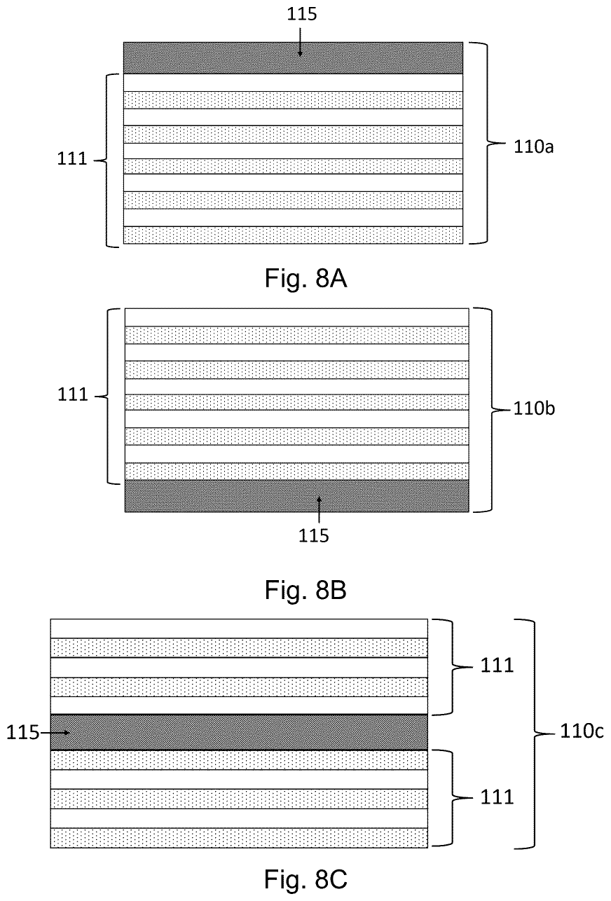

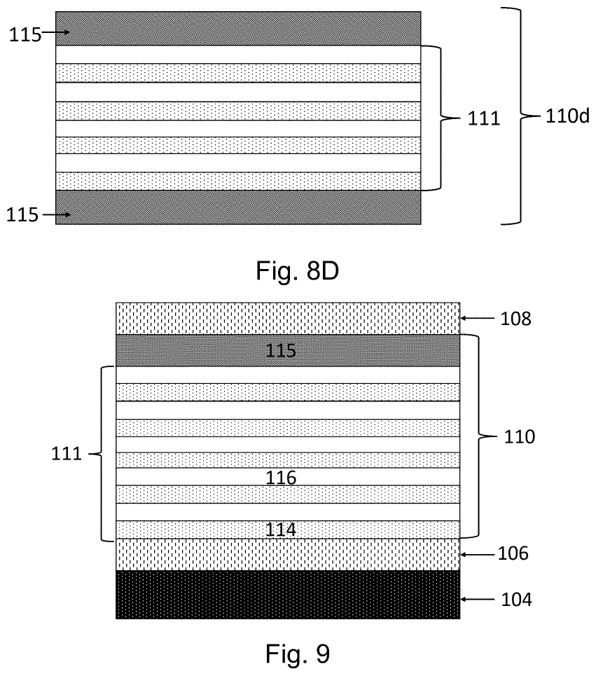

With respect to the alternating layer embodiment, these two layers are repeated multiple times, as seen in FIGS. 8A-8D, to form nanolaminate 111. The nanolaminate possesses properties that enable the nanolaminate to behave like a “dielectric cushion” without adding significant thickness of the actual capacitor dielectric. These properties arise from the optimized thickness of each individual oxide layer. Typically, the Al₂O₃ type oxide layer is very thin (0.1-1 nm), while the TiO₂ type oxide layer can vary in thickness, ranging from 0.1 nm to thicker options. The repeated layering of these oxides results in the desired thickness for the nanolaminate cushion. By using an oxide like Al₂O₃ layer and defective semiconducting TiO₂ layer that differ in Gibb's free energy, the nanolaminate is able to acquire conductive-like properties without affecting the capacitance when combined with the dielectric, thus appearing as if no additional substance has been introduced. ALD appears to be the most appropriate technique for growing this nanolaminate cushion, although MBE and other methods are also possible.

Nanolaminate cushion 111 is advantageous for safeguarding thin-film dielectric 115 in FIGS. 8A-8D, which is the capacitance defining dielectric, examples of which are Al₂O₃, SiO₂, nitrides, and barium titanates. The nanolaminate/dielectric stack 110a, 110b, 110c, 110d is thin and conformal with minimum or no pinholes. One way to grow such monolithic thin films is by ALD. The dielectric positioning options include on top of 110a (FIG. 8A), at the bottom 110b (FIG. 8B), in between on both sides of the nanolaminate cushion 110c (FIG. 8C), or any combination of these approaches 110d (FIG. 8D).

The nanolaminate cushion paired with a dielectric material 115 can create a capacitor design that is either planar or 3D structured on the meso-, micro- or nano-scale levels. For planar designs as shown in FIG. 9, capacitors can be formed on various substrates 104 such as rigid/flexible materials as well as PCB board, silicon wafers, or interposers. The bottom electrode 106 comprised of conducting metal or oxides is created through processes such as evaporation, sputtering, or ALD, can be directly grown onto the substrate 104. This is followed by the nanolaminate cushion/dielectric stack 110, and then a top electrode 108, made of metal, any conductive material, or conducting oxides. Different interface metals can also be added to improve adhesion or interfaces.

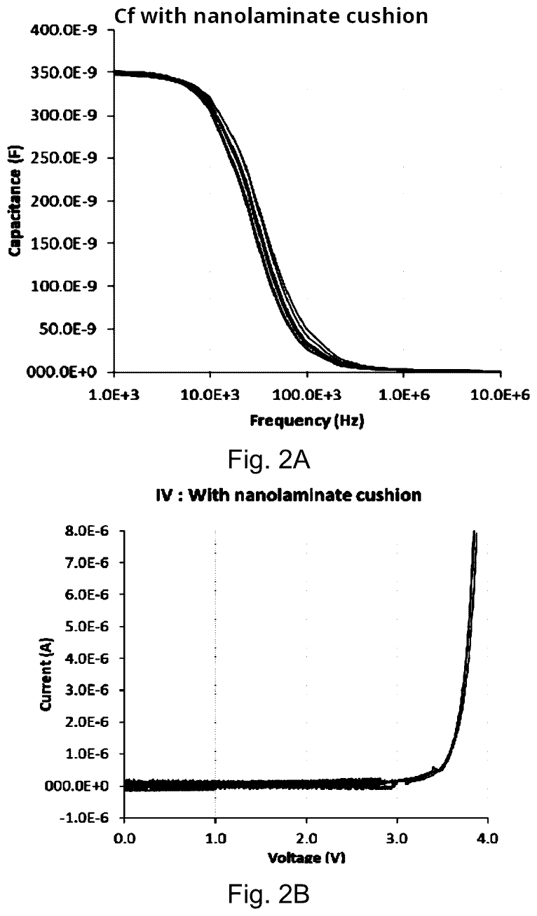

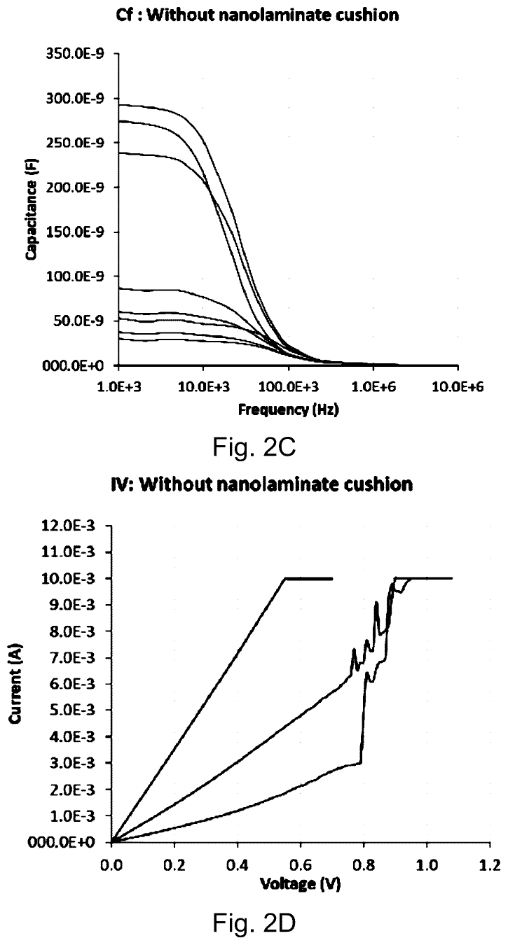

The significance of the nanolaminate cushion can be observed in FIGS. 2A-2D, which compares the performance of a planar capacitor (5×5 mm²) made with a 4 nm Al₂O₃ dielectric, both with and without the incorporation of the nanolaminate cushion composed of Al₂O₃ (0.3 nm)/TiO₂ (0.3 nm)×166 cycles, deposited by ALD. Capacitors without the nanolaminate cushion exhibited rapid breakdown, very high leakage current (FIG. 2D), and inconsistent performance (FIG. 2C). In contrast, the cushion-supported capacitors demonstrated stable and repeatable performance (FIG. 2A), with a higher yield and increased breakdown voltage (FIG. 2B).

Layer 106 and layer 108 are metal or any including transparent conductive layers and substrate 104 is provided if necessary.

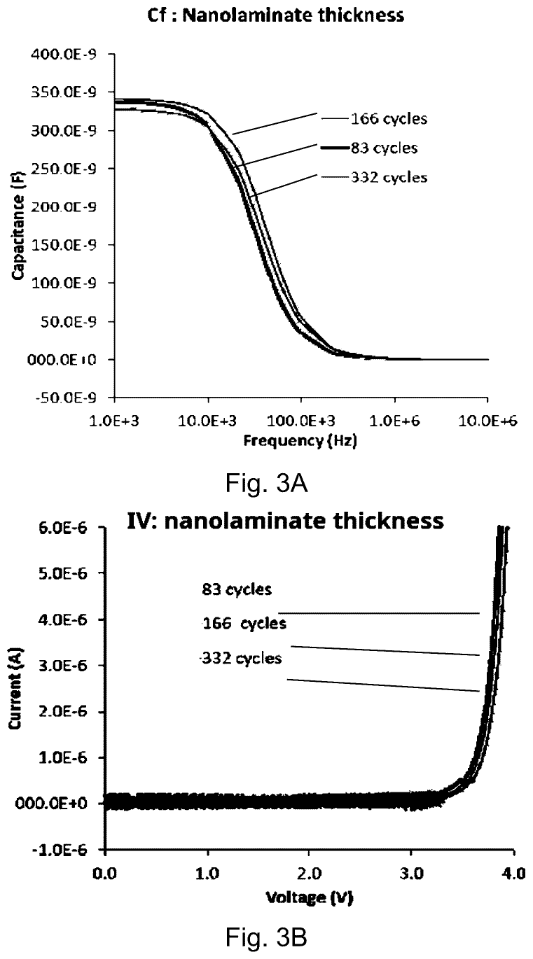

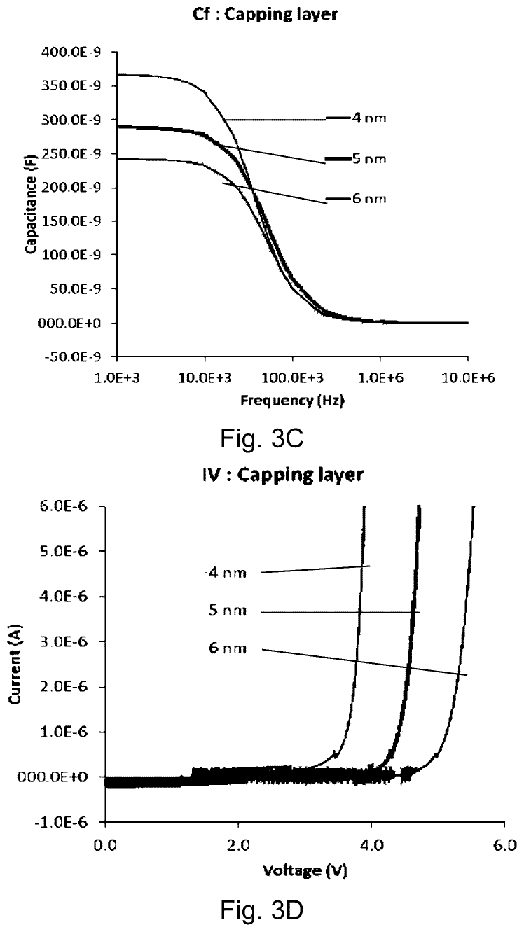

To demonstrate that the nanolaminate cushion has no adverse effect on capacitor performance, tests were conducted to examine the impact of varying cushion thicknesses on capacitor performance. Different cushion thicknesses (50 nm, 100 nm, and 200 nm) achieved by repeating ALD cycles (83, 166, and 332 cycles of Al₂O₃ (0.3nm)/TiO₂ (0.3nm)) were used for a capping dielectric material comprised of 4 nm of Al₂O₃ also deposited by ALD. The results, as depicted in FIGS. 3A-3B, showed that all capacitors exhibited the same capacitance and breakdown voltage due to the 4 nm of Al₂O₃ capping dielectric layer. The thickness of the nanolaminate cushion (50 nm, 100 nm, and 200 nm) didn't affect the performance. Thus, within this range, the number of alternating layers in the nanolaminate cushion layer can be adjusted based on the performance stability is required, which may vary with the number of ALD layers. For example, a suitable minimum may be 20 layers, though a lesser or greater number may be provided with corresponding decreases or increases in stability. Typically, a minimum of 10 pairs of layers is provided (20 total ALD deposition steps).

The breakdown voltage and capacitance of the capacitor can be optimized by adjusting the thickness of the dielectric layer alone, without the need to modify the nanolaminate cushion. Since this manufacturing process is monolithic, it ensures a streamlined and efficient production. A wide range of dielectric thicknesses, for example spanning from a few nanometers to several microns, can be grown to obtain desired values of breakdown voltage and capacitance.

The plots shown in FIG. 3C-3D demonstrate the performance of capacitors with varying thicknesses of dielectric, while keeping the nanolaminate thickness constant. Specifically, the dielectric thicknesses tested were 4 nm, 5 nm, and 6 nm of Al₂O₃. It can be observed that thicker dielectric films exhibit higher breakdown voltage, highlighting the impact of dielectric thickness on capacitor performance.

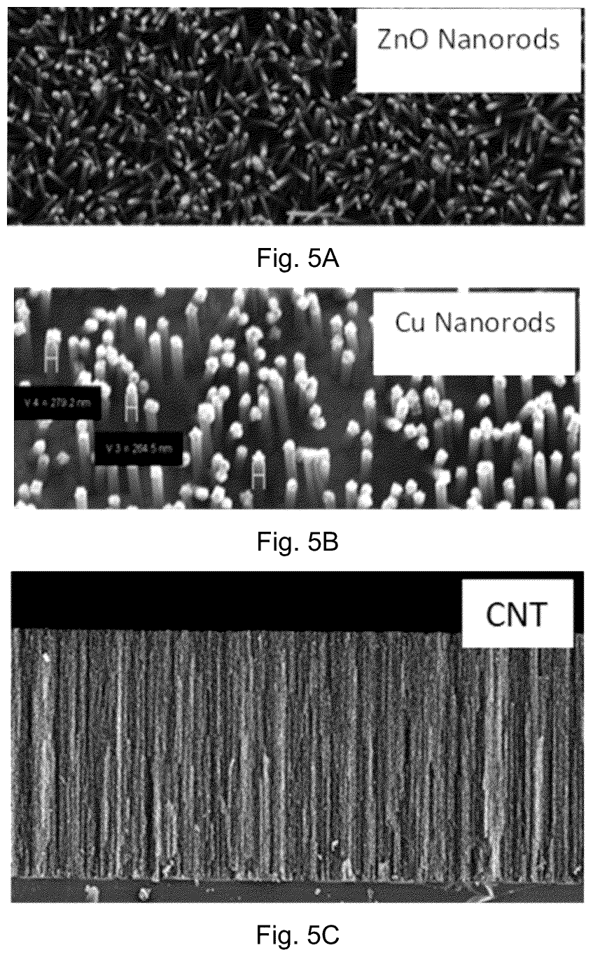

If a higher capacitance is required, the solution lies in fabricating 3D structures to dramatically increase the effective area of the capacitor in comparison with the capacitor's footprint area, such structures could be meso-, micro-or nano-structures. The latter offers the largest increase in capacitance per footprint area due to the significantly larger surface area of its nanostructures. Because capacitance is directly proportional to surface area, implementing such structures within the device's current footprint enables higher capacitance while minimizing capacitance volume. Examples of nanostructures that can achieve this 3D effect zinc oxide (ZnO) nanorods (FIG. 5A), copper (Cu) nanorods (FIG. 5B), include carbon nanotubes (CNT) (FIG. 5C), patterned silicon, and the like. Additionally, it is possible to construct this 3D capacitor on a die with through silicon vias and to embed capacitors into the circuit board or into silicon substrates such as interposers.

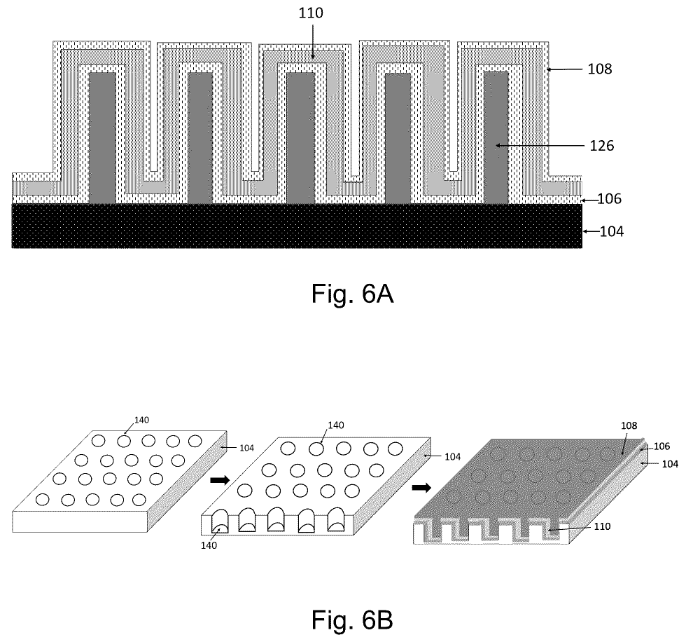

FIG. 6A showcases a first design approach for 3D capacitors with nanostructures grown on a substrate. The process starts with creating nanostructures 126 on a substrate 104. Nanostructures can range from nanorods, nanopillars, and nanofibers to nano/micro bumps. These nanostructures are conveniently multiwalled carbon nanotubes. This is followed by applying a bottom electrode 106 (which can be made of Cu or any other conductive material), depositing a nanolaminate cushion along with dielectric oxide 110, and coating a top contact electrode 108. This can be achieved through multiple deposition techniques, such as ALD, sputtering, evaporation, or others.

A second design approach for 3D capacitors involves the formation of intricate patterns directly on the substrate. For instance, one method is to etch a silicon wafer and create various patterns such as nano-microcavities or apertures, trenches or vias, upon which the capacitors can be placed/developed, as shown in FIG. 6B. This technique allows for the integration of nanostructures into the substrate, enabling the fabrication of 3D capacitors with enhanced capabilities.

In this design, as illustrated in FIG. 6B, the process begins by patterning 140 nanostructures on a substrate 104. The pattern 140 can consist of cylindrical holes like through-silicon vias (TSV), or any shape and size of holes, as well as other rough patterns or 3D structures. Subsequently, metal contacts 106, dielectric stacks 110, and top contacts 108 can be deposited on these structures using techniques such as atomic layer deposition (ALD) or any other standard deposition/growth process. When these capacitors are formed within the nanostructures, they form on a large surface area, which leads to an increased total capacitance. However, through sequential etching and coating processes, it is possible to selectively connect some of these capacitors in series or parallel to create desired capacitance and voltage as demanded by specific applications.

The following single layer packaging scheme may be used.

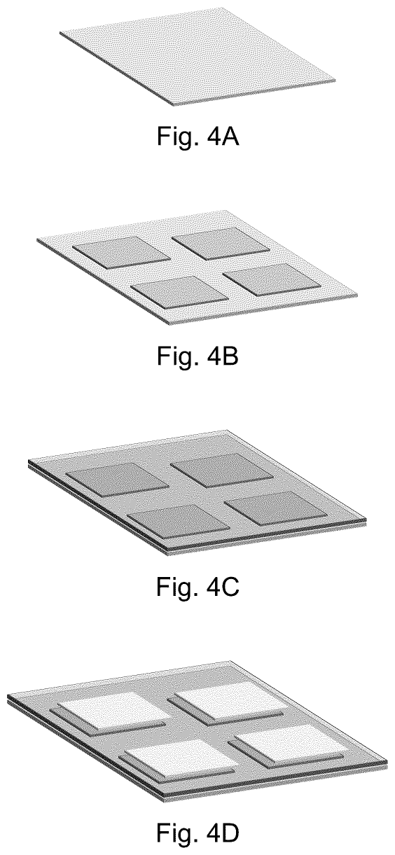

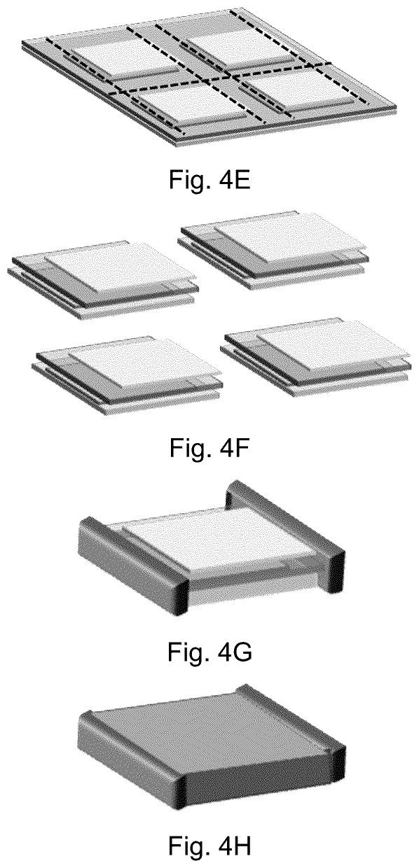

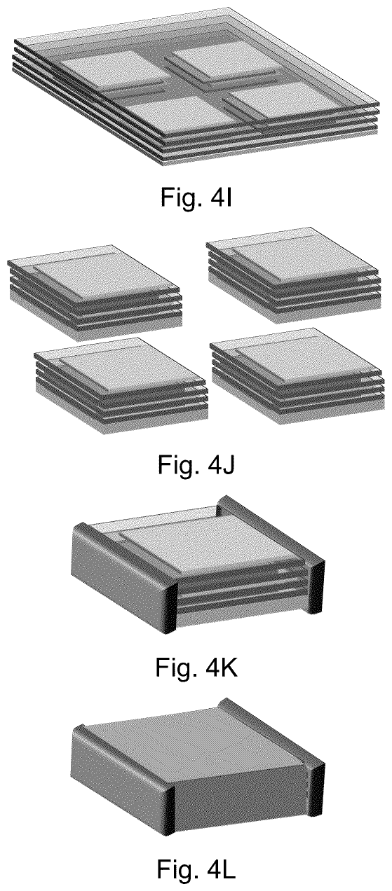

The synthesis of UTCC supported by ALD can be scaled up for mass production. FIGS. 4A-4H show the production flow starting with substrate to final packaging, suitable for mass production for single layer and multilayer UTCC. Notably, this process doesn't necessitate high-temperature sintering steps, unlike an MLCC, which minimizes thermal impact and the cost. Additionally, this process is compatible with flexible substrates due to its low growth temperature (<300° C.), making it conducive for flexible electronics applications. The process provides a substrate (FIG. 4A) coated with a conductor (e.g., metal) patterned as a lower electrode (FIG. 4B). An ALD dielectric is formed over the substrate (FIG. 4C), and metal electrodes formed over the lower electrode, slightly offset (FIG. 4D). In contrast to the multilayer design, the process proceeds to dicing the wafer (FIG. 4I), which should be over the bottom electrode (on the left) to expose it on the left side edge and over the top electrode (on the right) to expose it on the right side edge for making contacts on the side contact pads. After dicing (FIG. 4H) the bottom and top electrodes are exposed, and contact pads formed (FIG. 4K). The resulting device is then coated with reason (FIG. 4H).

FIGS. 41-4L show the multilayer stacking of several thin single layer UTCCs for higher capacitance. Because of all the stacked capacitors are in parallel contacts, the capacitance is proportional to the number of individual devices stacked. The same scheme can also be used for single layer nanostructured UTCCs to further increase the capacitance to a massive amount. To improve the breakdown voltage, thicker dielectric layers or use a series interconnection of the stacked or individual devices may be used. All of the monolithically stacked capacitors in FIGS. 4I-4K are in parallel so that capacitance is proportional to the number of individual devices stacked.

A rigid or flexible substrate is provided. A metal film is patterned as a set of lower electrodes by screen or 3D printing. An ALD dielectric coating is provided over the metal electrodes. This layer need not be patterned, for simple capacitors. A top metal electrode is then screen or 3D printed over the ALD dielectric. The bottom electrode and top electrode are advantageously offset to provide isolated electrical connections. Multiple layers of dielectric and metal may be formed in a stack, with portions of alternate electrodes extending from either side of the stack. The separate stacks are then diced, and contract pads formed connecting sets of alternate electrodes to provide parallel connections and increased capacitance over that of a single layer. A resin coating is typically provided to protect and isolate the capacitor.

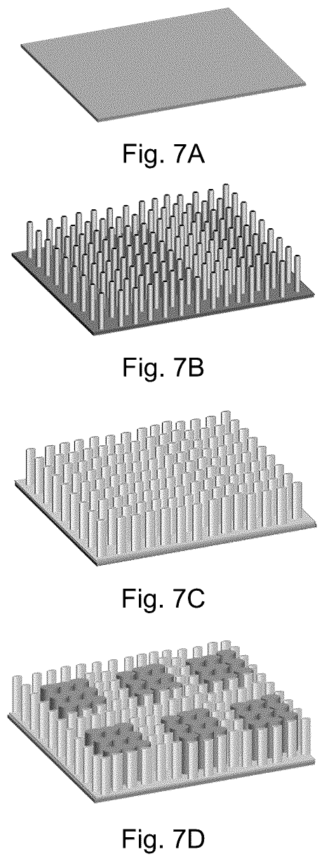

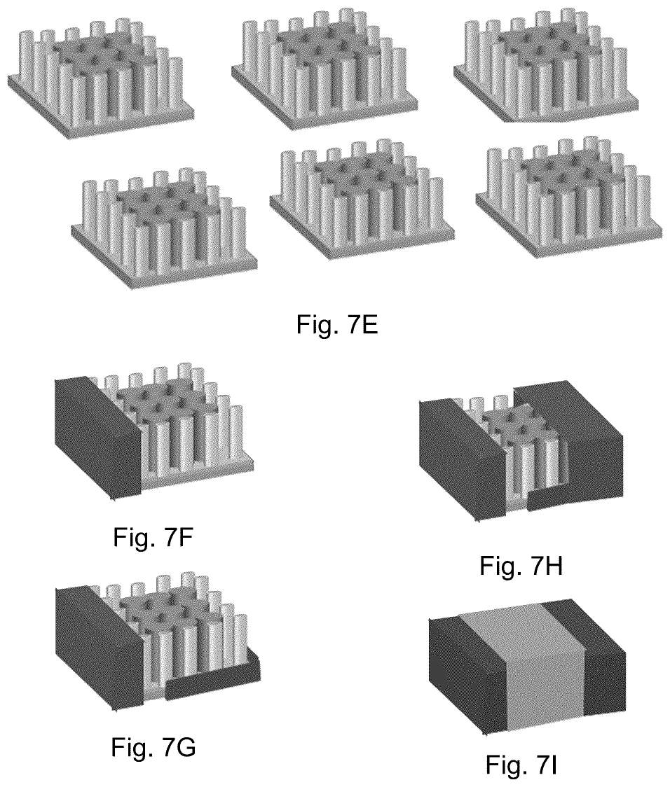

As shown in FIGS. 7A-7I, a device is provided that avoids a stack of separate capacitive layers, and rather provides a 3D electrode with nanostructures extending in the vertical direction. In this embodiment, an undivided metal electrode is formed on the substate (FIG. 7A), conductive nanorods are formed (FIG. 7B). This concept can further be applied to a divided and/or patterned substrate. The nanorods may be formed in a regular array, for example by patterning the metal electrode surface and then employing a self-assembling technology to selectively grow structures in the vertical direction, or permit random or irregular growth over the entire surface. The nanorods are grown to maximize surface area while ensuring open space for a subsequent ALD process. The ALD process is then conducted to deposit an ALD dielectric coating over the entire metal and nanorod surface (FIG. 7C). The nanorods may extend many microns in the vertical dimension (i.e., have an aspect ratio of 20-500), and are typically nanoscale in diameter, e.g., 1-100 nm. After the ALD dielectric coating is applied, a set of top electrodes is deposited using a shadow mask to provide isolated top electrodes (FIG. 7D). The substrate is then diced between top electrode boundaries (FIG. 7E). One contact is formed on an edge of a die, connecting the lower metal electrode (FIG. 7F). An insulating coating is then provided over the exposed portion of the lower electrode to prevent shorting in the subsequent step (FIG. 7G). Another contact is provided on an opposite edge of the die, over the insulating coating, connecting to the upper electrode (FIG. 7H). A resin coating is then provided over the device to complete the device (FIG. 7I).

According to this design, only a top metal electrode and a bottom metal electrode are provided, with the high capacitance provided by the large surface area nanorods, rather than a larger effective planar area. Further, the surface area of the nanorods may be higher than the surface area of corresponding planar layers, permitting a reduced thickness. The multistep ALD process is conducted once for the structure. The growth of the nanorods may be conducted in a continuous process. Therefore, as compared to a stacked capacitor, the production process may be faster.

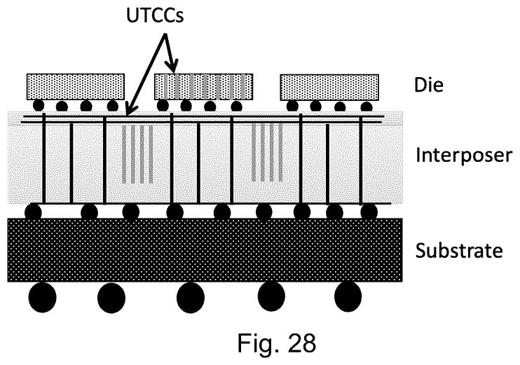

In addition to discrete capacitor components, this dielectric stacking exhibits great potential in embedded or integrated capacitors, such as those in chips, PCBs, etc. FIG. 28 illustrates the schematic of a chip package, where dies are initially placed on an interposer that is then attached to the substrate. Capacitors can be created as chip capacitors on the die level or embedded in the interposer via Through-Silicon Vias (TSV) using a stabilizing film along with a thin dielectric layer deposited by atomic layer deposition.

### Example 2

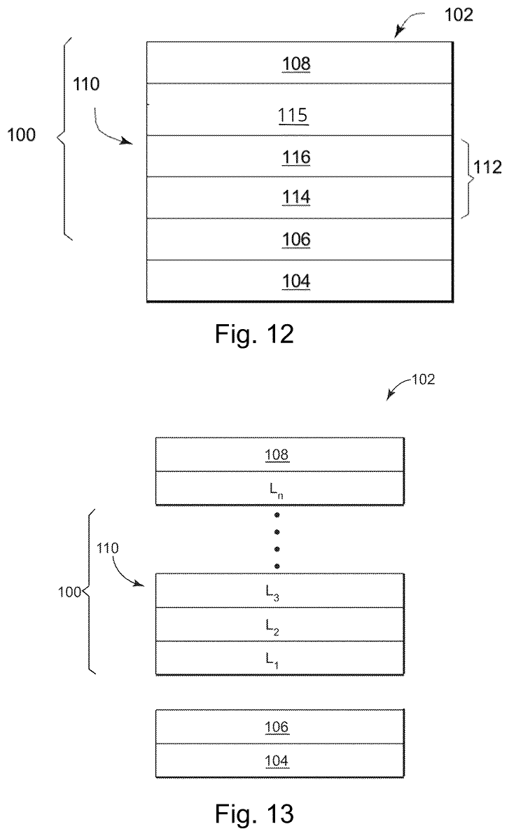

FIG. 12 depicts a schematic diagram of an exemplary embodiment of a capacitor 100 in very general form. This embodiment is part of a device 102 that can store and discharge energy much like MLCC ceramic capacitors and like technology. The device 102 may have a substrate 104 that supports the structure of the capacitor 100. This structure may include a pair of electrodes (e.g., a first electrode 106 and a second electrode 108) with a dielectric laminate 110 disposed therebetween. The dielectric laminate 110 may comprise one or more layered “units” 112 that reside between the electrodes 106, 108. The units 112 may comprise material layers (e.g., a first layer 114 and a second layer 116).

Broadly, the capacitor 100 is configured to store energy at capacities that rival MLCC ceramic capacitors and related storage medium. These configurations can maximize charge storing surface area, dielectric constant, and breakdown strength while minimizing dielectric thickness according to parallel plate capacitor theory, shown as Equation (3) below:

$$C = \frac{{ε}_{o} k A}{t} , \qquad ( 3 )$$

where, C is capacitance, k is dielectric constant, A is surface area, εₒ is electric constant, and t is the thickness of the dielectric laminate 110. The result is devices that allow effective tradeoffs between energy storage, specific capacitance, size, and operational electric currents and voltages. The devices may be manufactured at scale as part of integrated circuits, as discrete electronic components of any size, and as large scale devices for very high energy storage and buffering applications as might find use on vehicles or commercial energy storage.

The device 102 may be configured to store and discharge energy. The devices have a form factor that offers comparable energy density at significant weight advantages over conventional batteries. Such reductions in size and weight may make electronic devices, like radios, laptops, GPS, and even night vision goggles, much more portable and easy to transport. Notably, the device 102 may also scale as appropriate for use in circuitry as a circuit component or in vehicles, for large scale storage, and other large scale application. As thin-films, the devices are also very durable. Plus, unlike batteries and electrolyte capacitors, the devices contain no chemicals that are likely to degrade or leak-out over time. These features may prove very useful for military personnel, for example, that may carry several electronic devices into the field, often in harsh conditions or environments (including underwater), for long periods of time and typically without any reliable or ready access to a power source. The thin-film devices have a power density designed to work in situations that require short, intense bursts of power, like cold engine starting. For military use, the power density comports with high-fire discharge that may benefit advances in electromagnetic rail-guns and related weapons technology, which may offer personnel potentially safer alternatives to gunpowder.

The substrate 104 may be configured to promote these form factors. These configurations may include hard materials (e.g., silicon wafers or glass) or flexible substrates made of metals (e.g., Cu, Al, etc.), polyimide, PEEK, conductive polyester, or like plastic or flexible materials. These materials are compatible with various types of electronics devices, including electronics that employ “hard” or inflexible substrates, solid-state or high-speed silicon electronics, hybrid flexible electronics (HFE), or for fully flexible or stretchable electronics.

The electrodes 106, 108 may be configured to receive electric potential that energizes the capacitor 100. These configurations may employ structural units to maximize surface area (A) of the device. The first electrode 106 may comprise structural units to significantly magnify the surface area of the electrode 106 and dielectric stack 110 at minimal cost to overall footprint of the device 102. In one implementation, the electrode 108 will be conformal to the increased area structures and the dielectric stack 110 of electrodes 106. Examples of these structural units may be ordered or non-ordered, of varying sizes, including dimensions in micrometers (“micro-scale”) or smaller including nanometers (“nano-scale”), and may accommodate materials that comport with manufacture techniques to scale the device 102 for different applications (e.g., from integrated circuits to vehicles to large scale electrical systems).

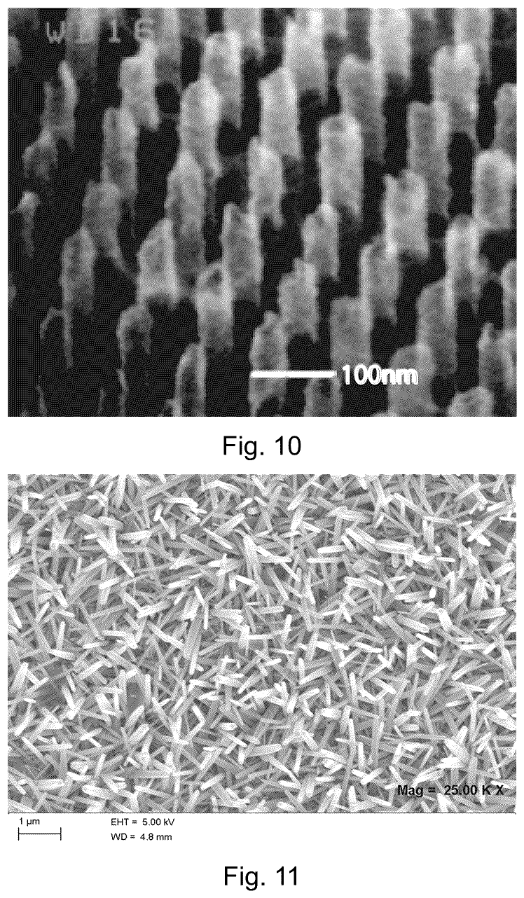

FIGS. 10 and 11 depict images for examples of the structural units. FIG. 10 illustrates an ordered structure, which may comprise carbon nanotubes (CNTs). CNTs often have a tubular form factor that provides electron transport or conductivity. FIG. 11 depicts irregular or non-ordered structures. These examples may include members, for example, elongate tubules. However, these structures may lack consistent spatial arrangement with each other, often overlapping or contacting with adjacent or neighboring members to form a “mesh”-like network on the substrate 104. Care may be given to manufacture both ordered and non-ordered structures to allow material layers (e.g., layers 114, 116) to form a coating of uniform thickness, which is important to optimize capacitor performance. For example, one requirement may be that surface area of materials per footprint area is repeatable to ensure performance parameters are uniform across different areas of the device 102 and from one device 102 to another. For non-conducting structures of electrode 106, a conformal coat may be disposed on the structures, for example, of conducting material, prior to depositing the dielectric laminate 110.

The dielectric laminate 110 may be configured to allow proper energy density of the capacitor 100. These configurations may conformally coat the first electrode 106 at a thickness that comports with structure for the electrodes 106. Generally, the dielectric laminate 110 may comprise any number of materials layers (e.g., layers 114, 116). The unit 112 may include any number of material layers, as well. For example, units 112 may be “stacked” to provide a plurality of the material layers 114, 116 on the device 102.

FIGS. 13, 14 and 15 depict additional configurations for the construction of the capacitor 100.

In FIG. 13, the construction may include many layers (e.g., L₁, L₂ . . . . Lₙ), which may be of the same or different materials, have the same or different thickness, or have the same or different parameters in general.

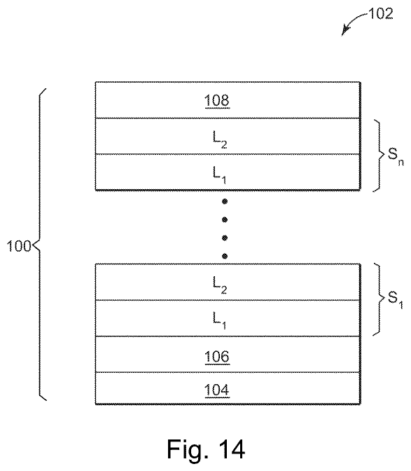

FIG. 14 shows construction that leverages many units (e.g., S₁ . . . Sₙ), each having two layers (e.g., L₁, L₂).

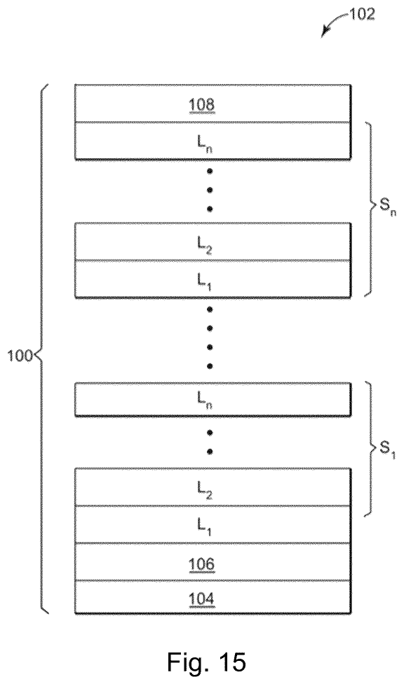

FIG. 15 depicts a construction that leverages many units (e.g., S₁ . . . Sₙ), where each of the units Sₙ comprises many layers (e.g., L₁, L₂ . . . Lₙ). Selection of the number and order of layers within the dielectric laminate 110 may rely on Maxwell-Wagner relaxation (to increase the dielectric constant). Materials for the layers may rely on Gibbs free energy (to lower the leakage current).

Properties for the material layers may benefit the overall characteristics for the device 102. These properties include material as well as dimensions (e.g., thickness). Notably, properties of the material layers may vary independently of each other, as well as independently of other material layers, or other material layers found in other stacked units, as well. This allows for characteristics of the capacitor 100 to be varied, effectively to fine tune the storage or circuit device 102 in connection with its application. Some implementations may benefit from very thin individual layers that minimize thickness of the stacked units to maximize specific capacitance. Other implementations may leverage materials with particularly good breakdown characteristics in layers that are thicker or thinner than other materials in the stacked unit(s) to selectively increase the breakdown strength, potentially at cost to specific capacitance.

Any material layers may be configured with materials that favorably influence both the energy density and the breakdown voltage of the capacitor 100 of the device 102. These configurations include dielectric materials, like titanium dioxide (TiO₂), aluminum oxide (Al₂O₃), and silicon dioxide (SiO₂). Other materials include Si₃N₄, SiO₂₋ₓNₓ, TiN, TiO₂₋ₓNₓ, Ta₂O₅, SrTiO₃, ZrO₂, HfO₂, HfSiO₄, ZnSiO₄, La₂O₃, Y₂O₃, a-LaAlO₃, Pr₂O₃, Gd₂O₃, Lu₂O₃, BaTiO₃, SrO, CaO, BaO, ZnO, and MgO. Mixed oxides, such as barium strontium titanate may also be used. Suitable materials may have properties that, when in combination, afford the laminate 110 with appropriate high dielectric constant (k) and breakdown voltage. Materials may also exhibit properties, like bandgap, dielectric strength, and Gibbs free energy, that promote lower leakage current, as well. This feature may afford the laminate 110 with better breakdown voltage. Preference may be given to materials that exhibit both high bandgap values (e.g., at or above 8.8 or 9 eV) and high dielectric strength (e.g., at or above 20 MV/cm). The design may also benefit from bulk materials that have similar but distinct Gibbs free energy of formation, e.g., within 2%, 2.5%, 3%, 4%, 5%, 5%, 7%, 8%, 9%, 10%, or 20% of each other. Preferably, the materials have a Gibb's free energy that differs by more than 2%.

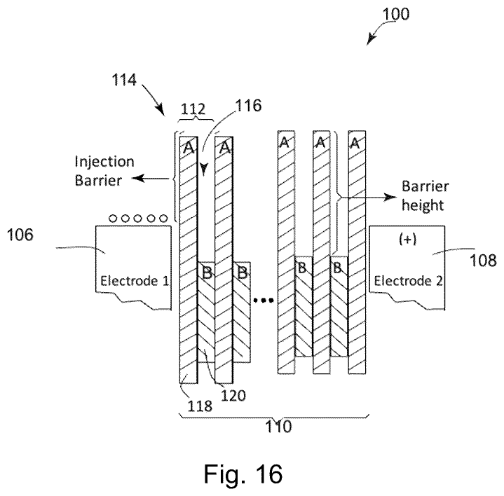

FIG. 16 depicts, schematically, an energy band representation of the capacitor 100 to inform discussion of favorable bandgap values. The layers 114, 116 may operate as a barrier 118 and a semiconductor 120, respectively. The semiconductor 120 may comprise material having a high dielectric constant (k), like TiO₂. Materials for the barrier 118 control leakage current. However, thickness of the laminate 110 must be carefully controlled because, as layers 114, 116 become thinner, they become less insulating mainly due to tunneling that allows charge “hopping” between the semiconductor 120 in adjacent units 112. This phenomenon may significantly increase leakage current. Probability of tunneling, for example, may be determined in accordance with Equation (4) below:

$$Tunneling Probability \approx \frac{16 E ( {U}_{0} - E )}{{U}_{0}^{2}} exp \{ - 2 W \sqrt{\frac{2 {m}^{*} ( {U}_{0} - E )}{{ℏ}^{2}}} \} , \qquad ( 4 )$$

where, (U₀−E) is barrier height and W is the barrier width.

Equation (4) suggests tunneling current at high field gradients may increase in response to changes in dimensions of the barrier 118, typically reductions in barrier width or barrier height. Even if the physical thickness of the layer 118 is very large, the “effective” thickness of the layer 118 that blocks charge injection may be only several nanometers, where a 0.1 eV change in barrier height may result in about 50 MV/m of change in the critical field and a change of dielectric constant by an order of magnitude may change the critical field by about 100 MV/m.

High bandgap materials may form the largest energy barrier 118 possible, but still allow for barrier width or the layer thickness that comports with use on nano-structures (e.g., CNTs) for the first electrode 106. Al₂O₃ between TiO₂ layers, for example, effectively blocks leakage current because of its very high bandgap, 8.8 eV, and favorable resistivity. SiO₂ has an even higher bandgap, 9.2 eV, than Al₂O₃. TiO₂ has a bandgap of 3.2 eV.

FIG. 17 depicts a plot of Gibbs free energy for various materials, including Al₂O₃, TiO₂, SiO₂. Notably, SiO₂ has also has free energy that is much more closely aligned with TiO₂ (e.g., within 2% of each other) than Al₂O₃ (as indicated by arrow A). This feature may limit oxygen diffusion between SiO₂/TiO₂ layers (e.g., layers 114, 116) because of the similarity of energy of formation. By comparison, the very large deviation (indicated by arrow B) between Al oxidation with Ti can lead to oxygen vacancies in the TiO₂ layer of an Al₂O₃/TiO₂ laminate. These vacancies may promote oxygen diffusion toward Al₂O₃ because of its lower free energy for oxidation. This diffusion may be responsible for positive carriers due to Maxwell-Wagner (MW) relaxation (that is responsible for high dielectric constant) that increases conductivity of the TiO₂ layer and, thus, may result in severe leakage current. To limit the oxygen diffusion and consequently reduce the leakage current, SiO₂ pairs well with TiO₂ as SiO₂/TiO₂ or with Al₂O₃/TiO₂ laminate as SiO₂/Al₂O₃/TiO₂. One benefit of the concepts herein is to increase dielectric constant (k) by virtue of MW relaxation and, in turn, mitigate the resulting higher leakage current by pairing materials with similar free energy.

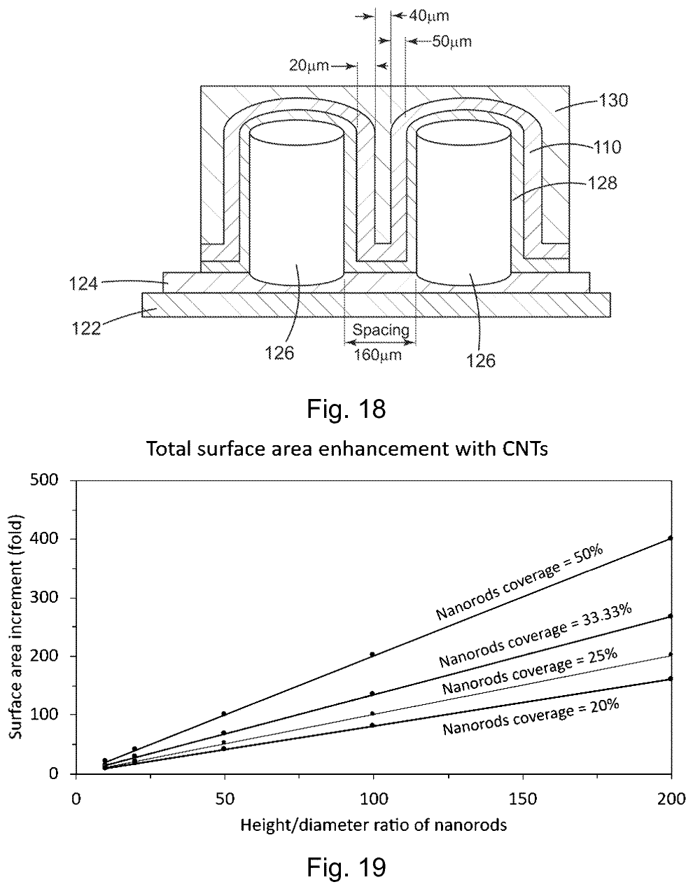

FIG. 18 depicts a schematic diagram of an example of the capacitor 100. This example includes a base 122, for example silicon as the base material for the device 102. A supporting layer 124 may reside on the silicon base 122 to prevent cracking. Niobium (Nb) may prove useful for this purpose; although materials with similar thermal expansion coefficient may suffice as well. The first electrode 106 may comprise an array of ordered structures 126, for example, electrically conducting tubules or CNTs that populate the silicon base 122. The design may also benefit from a contact coating 128, like a thin layer of metal (e.g., platinum (Pt)), which interposes between the tubules 126 and the dielectric laminate 110. This thin layer may resolve manufacturing defects that can affect conductivity or adhesion of the dielectric to structures 126 and reduce performance of the device 102. The second electrode 108 may form a top contact 130, also made of platinum (Pt) or like conductive material.

The CNTs 126 may be part of a much larger ordered arrangement (or “array”) that covers the base 122. Generally, it benefits the design to size the CNTs 126 for the array to optimize total surface area of the capacitor 100, often in conjunction with steps to optimize deposition of other material layers, including dielectric and conducting materials. Values for total surface area increment may correspond with Equation (5) below:

$$Total surface area increment ( fold ) = \frac{π dh + \frac{π {d}^{2}}{4} + \frac{π {d}^{2}}{4} ( \frac{1}{θ} - 1 )}{\frac{π {d}^{2}}{4} + \frac{π {d}^{2}}{4} ( \frac{1}{θ} - 1 )} = 1 + 4 \frac{h}{d} θ \qquad ( 5 )$$

where, d is the diameter of the CNTs 126, h is the height of the CNTs, and θ is CNTs coverage on the substrate in %. πdh represents the curved surface area of the CNTs.

$$\frac{π {d}^{2}}{4}$$

corresponds to the tip area of CNTs.

$$\frac{π {d}^{2}}{4} ( \frac{1}{θ} - 1 )$$

accounts for the void area between CNTs on the substrate. Solving the Equation (5) yields the term 1+4h/dθ, where the ‘1’ accounts for the base (footprint) area, and the second term reflects the extra surface area contributed by the nanostructure.

FIG. 19 depicts a plot of total surface area increment as a function of height-to-diameter ratio of CNTs 126 of FIG. 18. The plot shows that nanostructures like CNTs have a larger surface area compared to planar counterparts. This increase in surface area is due to the sidewalls of nanostructures, and it depends on two factors: (a) aspect ratio and (b) density of nanostructures. For instance, a 200:1 aspect ratio (height to diameter ratio) and nanostructures occupying ¼ of the total space can result in a 200-fold increase in surface area. At least a 100-fold increase in surface area is feasible with a 100:1 aspect ratio of nanorods.

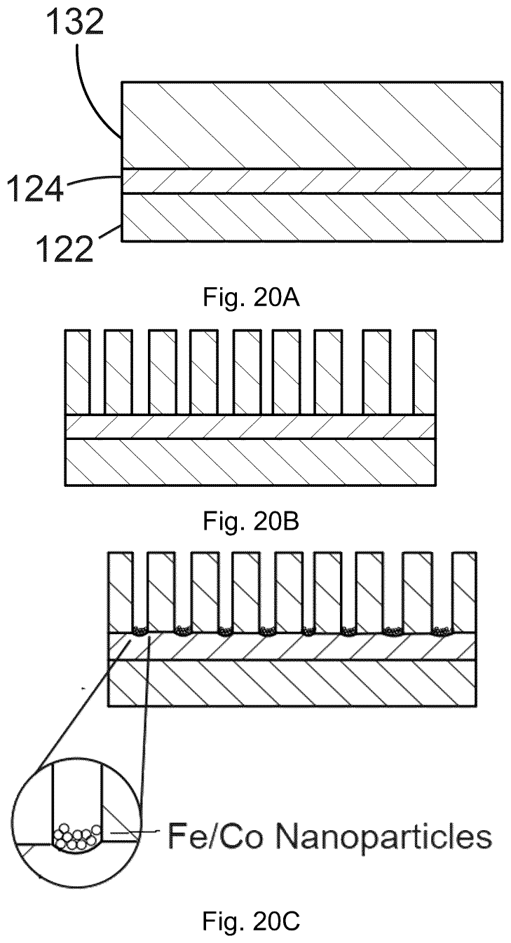

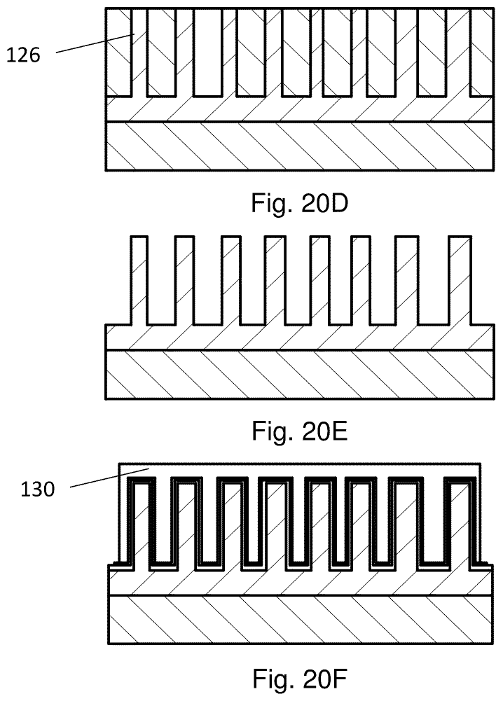

FIGS. 20A-20F depict a manufacturing process for a method that results in an example of the capacitor 100. Generally, this embodiment may result in high-aspect ratio and isolated CNTs 126 grown in an anodized aluminum oxide (AAO) template by chemical vapor deposition (CVD). AAO templates are particularly useful to synthesize nano-wire and nano-tube arrays by oxidation of aluminum in acid electrolyte. The result is a packed array of columnar hexagonal nano-channels perpendicular to the silicon base 122 that feature uniform pore wall thickness. This approach may also facilitate self-assembled structures with high aspect ratios, which are difficult or costly to form using a conventional lithographic process.

As shown in FIG. 20A, an Al film (132) is grown on a silicon substrate. An e-beam evaporator may be useful for this purpose. Since the nanostructure of AAO template affects the orientation and arrangement of CNTs, it is very important to achieve a thermally stable AAO template for high temperature CVD processes. A temperature between 600° C. to 800° C. may be required for the CNT growth. This high temperature may put significant strain on the thin-films. The thin layer 124 of niobium (Nb) may prevent cracking since the thermal expansion coefficient is close to that of alumina. Stability analysis of the AAO templates have revealed that alumina has cracked for substrates without a Nb supporting layer at temperatures from 300° C. to 400° C. The Nb layer 124 also helps make the bottom of nano-channels more conductive which results in lower working voltage for catalyst electrodeposition such as iron (Fe) or cobalt (Co) shown in FIG. 20C.

As shown in FIG. 20B, a set of features is etched into the aluminum film 132.

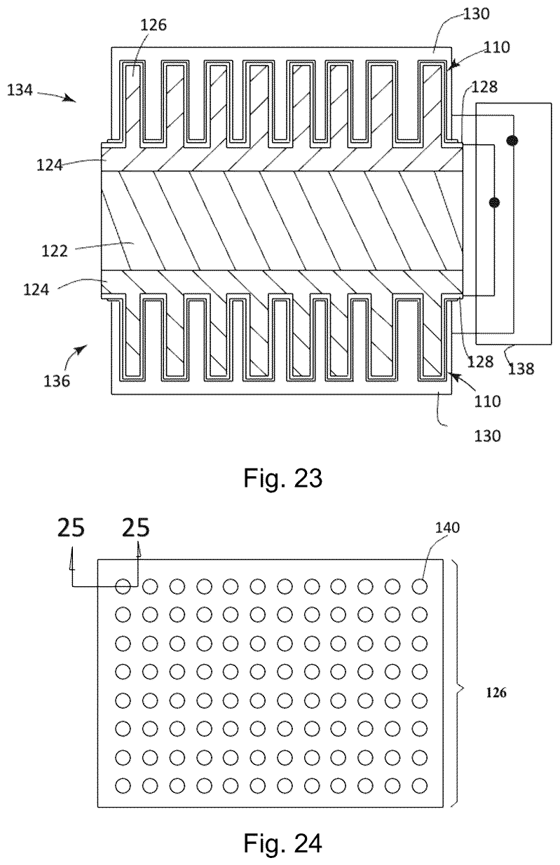

It is important that the catalyst (e.g., Fe/Co nanoparticles) is only at the bottom of the nano-channel to avoid growth of the CNTs 126 from the sidewalls. At high temperature, Nb oxidizes to Nb₂O₅, which is insulating. A pre-thermal treatment at 500° C. in 2% H₂ and 98% He reduced the insulating Nb₂O₅ formed during anodization to semiconducting NbO₂ favoring more conductive pathways for uniform electrodeposition. Highly-doped (100) wafers 122 may be used as substrate 104. This stage may include stages to deposit an aluminum film 132 on the Nb layer 124, preferably at a thickness of 100 to 200 μm to allow trenches of 100 to 200 μm depth. This stage may occur on one side of the wafer 122, but additional stages for the other side (FIG. 23) may benefit the design to allow structure for a second capacitor to form on the substrate 104.

The stages may include stages to anodize the Al layer 132 in oxalic acid. For example, the wafer 122 may be partially dipped into solution, with aluminum as the anode and a platinum plate as the cathode, until all of the aluminum is converted into alumina. This process may be done using a “two-stage” growth process, which may include both mild and hard ionization to form long nano-channels of appropriate length. In one implementation, anodization is stopped when approximately half of the Al layer 132 is consumed. Then the wafer 122 is immersed in a mixture of chromic acid and phosphoric acid (e.g., at 60° C.) to remove porous alumina formed by the prior stage. This second stage leaves behind the footprint for the final template. The remaining Al layer 132 will be anodized using, for example, the same conditions as in the second stage. This stage results in an AAO template with better uniformity and improved nano-channel ordering. The nano-hole diameter can be adjusted by a pore-widening treatment using phosphoric acid. This pore-widening treatment may also help to reduce the thickness of any remaining alumina barrier layer below the bottom tip of the nano-channels, making the base more conductive for catalyst electrodeposition.

The method can be optimized to achieve desired nano-channel depths and diameters. Generally, interpore distance may be proportional to the anodization voltage and the pore depth may be proportional to anodizing time. Processes using high voltage (100-140 V) and higher growth rates (50-100 μmh⁻¹) when compared to mild anodization (MA) at 25 V (2-6 μmh⁻¹) may benefit growth of nano-channels, for example, as long as 110 μm by a hard anodization technique (HA). For 200 μm long channels, it will be important to control structural parameters such as pore size, interpore distance, and aspect ratio of nanopores. A protective aluminum oxide layer generated by mild anodization followed by hard anodization (with increase in voltage at a certain rate) has generated highly ordered hexagonal nanochannels.

As shown in FIG. 20C, Fe/Co nanoparticles may be electrodeposited at the bottom of nano-holes. A three-electrode system may be useful for this purpose. This stage may include stages for electrochemically depositing Co nanoparticles of 100-200 nm by AC electrolysis in an electrolyte containing CoSO₄, HBO₃ and ascorbic acid. This process may form a cluster of Co nanoparticles with high aspect ratio for efficient catalysis. The Co containing AAO templates may be placed in a tube furnace for reduction (e.g., at 600° C. for 1 hour) in a flow of Ar/H₂ mixture before starting CNT growth. Some embodiments may also use Fe as a catalyst, where the process will be the same except that the precursor solution will be iron sulfate.

As shown in FIG. 20D, the CNTs 126 may be grown. Water assisted chemical vapor deposition may be useful for this purpose. The stages may include stages for placing the substrate in a quartz tube furnace with Ar and H₂ (e.g., at 500 sccm and 10 sccm, respectively,) to create an oxygen free environment. The furnace is then heated (e.g., to 800° C.). Once the temperature is maintained, the Ar/H₂ mixture and ethylene gas mixture is passed through the chamber, which decomposes on the catalyst and creates supersaturation, resulting in CNT growth. Once the required height is obtained, the ethylene flow and heating is stopped while Ar/H₂ flushing is continued. The substrate 122 is removed once it reaches room temperature and treated with mild sulfuric acid to etch residual Fe or Co particles.

The thin alumina at the bottom tip of nano-channels helps as a barrier layer which prevents the Fe/Co nano-particles at high temperature from diffusing into the substrate. This helps decomposition of carbonaceous materials on the catalyst for efficient CNT growth. The AAO template might act as a catalyst media for CNT growth. This may stop the CNT growth once it reaches the edge of AAO template. Thus the CNTs will have the same size and shape as the AAO template.

As shown in FIG. 20E, the method may etch the aluminum oxide off. This stage may expose the bare CNTs 126 to dilute NaOH solution. Any residual Fe/Co around the CNTs may be removed, for example, with mild sulfuric acid. Etching of the aluminum oxide can be optimized to make sure that the alumina barrier layer at the bottom of the nano-channels is not etched away, thus guaranteeing that the CNTs are intact.

The method may coat the CNTs 126 with the thin layer 128 of platinum (Pt). Electroplating may be useful for this purpose, particularly, with the high-aspect ratio of the CNTs, because traditional metallization methods (e.g., thermal evaporation, sputtering, etc.) may not fully cover the CNT array. This stage may correct certain defects, for example, that may result from “non-perfect” etching of all Al₂O₃ that can leave behind a thin layer of Al₂O₃ at the bottom of the carbon nano-tubes. This thin layer could prove an obstacle for charge transport, which can limit use of the CNTs 126 as the back electrodes for the capacitor, as they are conducting material. The Pt layer 128 shown in FIG. 23 may be useful to operate as the back electrode because this material works well with nano-scale coatings like laminate 110.

The method may grow the conformal, laminate 110 on the CNTs 126. ALD may be useful for this purpose. This process may avoid “hot spots,” that can occur in chemical texturization and rolling processes that practices-to-date employ to increase surface area of capacitors. These hot spots may reduce breakdown strength. On the other hand, ALD may deposit the oxide layer(s) uniformly over the CNTs 126 to allow even electric field in all locations to prevent localized hot spots. The uniformity of ALD-deposited layers is also desirable to avoid defects and lower defect density. This feature may avoid trap-assisted tunneling (TAT) or multi-step trap-assisted tunneling (MTAT), both of which may lead to a percolation event that causes electrical breakdown of the insulator at critical defect density. Fewer defects in the oxide layer(s) can also avoid Fowler-Nordheim tunneling (or “field assisted thermionic emission”) that can contribute to leakage by allowing tunneling through the oxide in response to high electric fields (e.g., >10⁷ V/cm). The oxide layer(s) from ALD can also avoid Poole-Frenkel effects that occur when both defects and high electric fields exist, which can also contribute to leakage because the reduction in potential barrier around the trap state in a high electric field allows trapped electrons to tunnel out from the trap state.

As shown in FIG. 20F, the method may form the top contact 130. Electroplating may be useful for this purpose. However, this process may require a seed layer with a certain conductivity to achieve uniform deposits on non-conducting materials such as the dielectric nano-laminate 110. Electroless plating techniques may also apply for ohmic contacts to n- and p-doped silicon. In one implementation, the stages may include stages for depositing platinum (Pt) (or another metal or conducting material) as the top contact 130 for the capacitor 100. Electroless deposition of porous platinum on alumina may be carried out using precursor such as PtCl₂(sty)₂. These films adhere to the substrate very well with tunable sheet resistance of over 5 orders of magnitude. With this process, the Pt nanoparticles assemble themselves into a densely packed, electrically conducting film with nanometer-sized pores, thereby eliminating the need for an additional electrically conducting matrix material.

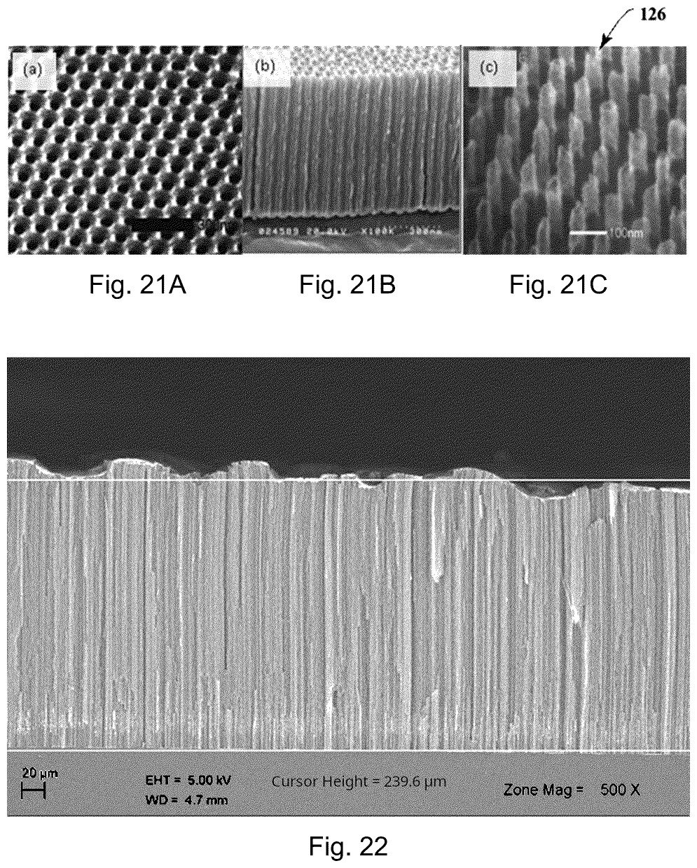

FIGS. 21A-21C and 22 depict images of exemplary structure that may result from use of the method noted above.

FIGS. 21A-21C shows an arrangement of the CNTs 126 as uniform, well-separated, isolated structures. This arrangement is important to exploit the unique structural and electronic properties of the CNTs 126. Exemplary process may, for example, grow CNTs 126 by the decomposition of ethylene on iron (Fe) or cobalt (Co) catalyst within hexagonal anodized aluminum oxide templates. This process may allow for controllable and scalable growth of the CNTs 126, as well as a precisely packed structure with controllable spacing of the same.

FIG. 22 depicts a typical SEM cross-section of CNT film grown with Fe as a catalyst and a 50 nm Al₂O₃ barrier layer. The CNTs are narrow and about 240 μm in vertical height. The compactness of the CNT film stems from the thin film of Fe (˜5 nm) on top of the Al₂O₃ barrier layer. The growth time for the 240 μm tall CNTs was only 2 hrs. It follows that uses of the method could, in turn, result in 100 to 200 μm tall CNTs, as well.

FIG. 23 depicts a schematic diagram of an example of the device 102. This example includes a pair of capacitors (e.g., a first capacitor 134 and a second capacitor 136), one each disposed on either side of the silicon base 122, although other base materials might be used in the process. Coupling mechanism 138 may electrically connect the capacitors 134, 136 in parallel. Table 2 below describes functional properties of the device 102, where the laminate 110 has a thickness of 50 nm:

TABLE 2

| | | | | Estimated areal | Estimated |
|---|---|---|---|---|---|
| | | | | energy density | areal energy |
| Height of | Diameter of | | Breakdown | (J/cm²) for | density (J/cm²) |
| the CNTs | the CNTs | Capacitance | field | single-sided | for double- |
| (μm) | (nm) | μF/cm² | (V/cm) | capacitor | sided capacitor |
| 100 | 50 | 865 | 1 × 10⁶ | 2162.5 | 4325 |
| 150 | 50 | 1297 | 1 × 10⁶ | 3242.5 | 6485 |
| 200 | 50 | 1728 | 1 × 10⁶ | 4320 | 8640 |
| 100 | 50 | 865 | 2 × 10⁶ | 8650 | 17300 |
| 150 | 50 | 1297 | 2 × 10⁶ | 12970 | 25940 |
| 200 | 50 | 1728 | 2 × 10⁶ | 17280 | 34560 |

The discussion turns next to another example of the capacitor 100. As noted herein, form factors for the ordered structure 126 may vary as necessary to improve performance of the capacitor 100. These form factors may include elements that perforate one or more surfaces of the substrate 104. Like CNTs, this “nano-perforation” significantly increases the surface area of the substrate 104 and can receive the conformal coating of dielectric laminate 110.

FIG. 24 depicts an example of a structure designed to effectuate this nano-perforated design for the capacitor 100. In this example, the ordered structures 126 may embody a pattern 140 of apertures that penetrate into the base 122, which may be aluminum. The pattern 140 of apertures may populate all or part of the top (or bottom) of the aluminum base 122. This arrangement may employ spacing and pitch between adjacent apertures of the pattern 140 of various dimensions. However, it may benefit the design (or be subject to manufacture constraints) to arrange the pattern 140 of apertures with uniform spacing in one or more directions along the surface of the substrate 104.

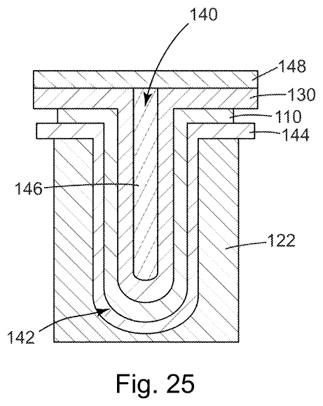

FIG. 25 depicts an elevation view of the cross-section of the example of FIG. 24. The pattern 140 apertures may embody “blind” holes that terminate at a closed end 142. But some designs may also benefit from “through” holes that penetrate the entire thickness of the aluminum base 122 to form a pair of open ends. In one implementation, the structure may also include an intermediary contact layer 144 that interposes between the aluminum base 122 and the dielectric layer 110 that conformally coats the pattern 140 of holes. The top contact layer 130 may reside on the dielectric layer 110. In one example, the top contact layer 130 may comprise material that fills any interstitial spacing of the hole, as identified by the cross-hatched area enumerated by the numeral 146. The capacitor 100 may also include a prep layer 148, like silver paste or other material that resides on the top contact layer 130. These materials can prepare the device for post-process steps (e.g., soldering) or, more generally, to receive contacts, terminals, or other discrete electrical components.

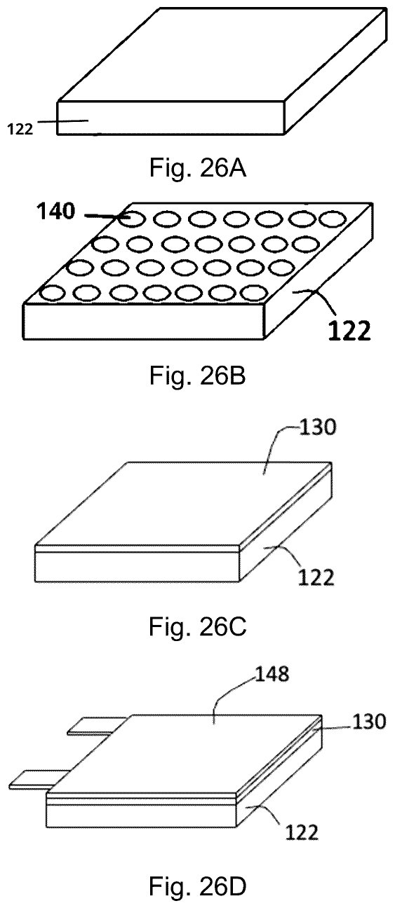

FIGS. 26A-26D depict the manufacturing steps for a method that may result in an example of the capacitor 100 with the pattern 140 of apertures. The method may include, as shown in FIG. 26A, forming the aluminum substrate, as shown in FIG. 26B, forming the pattern 140 of apertures and metalizing them, and as shown in FIG. 26C, preparing the capacitor 100 for post-processes.

As shown in FIG. 26A, the method may affix the Al layer 132 onto the silicon substrate. This step may grow or deposit the Al film; however, in one implementation, the aluminum layer may alternatively consist of aluminum foil that adheres (using adhesive) to a surface of the silicon substrate. The thickness for the aluminum layer may correspond with a desired depth for the pattern 140 of troughs, for example, from about 100 μm to about 350 μm. To increase surface area, the Al layer 132 may be found on multiple surfaces (e.g., top and bottom) of the silicon substrate.

The Al layer 132 may be anodized to form the pattern 140 of troughs. These steps may provide a well-ordered, uniform arrangement of the pattern 140 of troughs. In one implementation, the first step of the process may require dipping at least part of the silicon substrate into a bath of 0.3M oxalic acid at 15° C. at 40V with aluminum as the anode and platinum as the cathode. The substrate may remain for a period until half of the aluminum converts into alumina. The second step of the process may immerse the partially-anodized aluminum-on-silicon substrate into a bath of chromic acid and phosphoric acid (at 60° C.). This bath can remove any porous alumina that forms during the first step. The process may also repeat the first step to anodize any remaining aluminum. In one implementation, the process may include steps to adjust dimensions for the pattern 140 of troughs, for example, by treating the anodized silicon substrate in 5 wt % phosphoric acid.

As shown in FIG. 26B, the method may deposit various layers into the pattern 140 of apertures. This stage may include steps to add the intermediary or “back” contact layer 144, typically Cu deposited using electroplating. The stage also includes steps to add the conformal laminate 110. As noted above, ALD may prove beneficial for this purpose, but other processes may work as well., for example, sputtering, CVD, MBE, etc. The steps may deposit porous platinum (Pt) as the top contact layer 146, for example, by electroless electroplating. This process may convert [PtCl₂(tly)₂] precursor in toluene at 80° C. into a nanoporous, electrically conductive Pt film on the dielectric laminate 110. Alternatively, ALD techniques may deposit metal, metal-like or transparent conductor material to form the top contact layer 146.

As shown in FIG. 26C, the method may deposit solder paste onto the device. This stage may also include other post-processing steps, for example, steps to attach peripheral or discrete electronics devices to the capacitor 100. These steps may prepare the device for additional packaging operations, like overmolding or mounting one or more of the capacitor 100 into or as part of a bigger assembly.

As shown in FIG. 26D, a prep layer 148, like silver paste or other material that resides on the top contact layer 130 may be provided, and contacts connected to the upper and lower electrodes.

As interpreted herein, a numeric value shall be presumed substantially different from another numeric value if they differ by more than 20%, unless otherwise stated herein or rebutted. Thus, for example, a dielectric constant of 100 is presumably not substantially different from a dielectric constant of 110, but is presumably different from a dielectric constant of 130.

In light of the foregoing discussion, the improvements herein result in ultra-high capacitance solid state capacitors that may reliably replace battery storage. These devices include very high surface area electrodes in a small footprint. These electrodes may comprise nano-structures, like nano-tubes or nano-holes. A specialized dielectric resides on the structures and between the electrodes. This dielectric may embody a conformal coating or laminate with material layers, each made of materials with very high dielectric constant and dielectric strength. Thickness of this laminate balances any tradeoff between capacitance and breakdown voltage.

Manufacture of the embodiments herein may include steps for forming carbon nano-tubes or nano-holes on a substrate; conformally coating the carbon nano-tubes or nano-holes with a dielectric laminate; metalizing the carbon nano-tubes or nano-holes with conducting material that interposes between the carbon nano-tubes or nano-holes and the dielectric laminate; metalizing the dielectric laminate; depositing aluminum on the substrate; etching the aluminum to form a template for the carbon nano-tubes; and depositing aluminum oxide in the template.

### Example 3

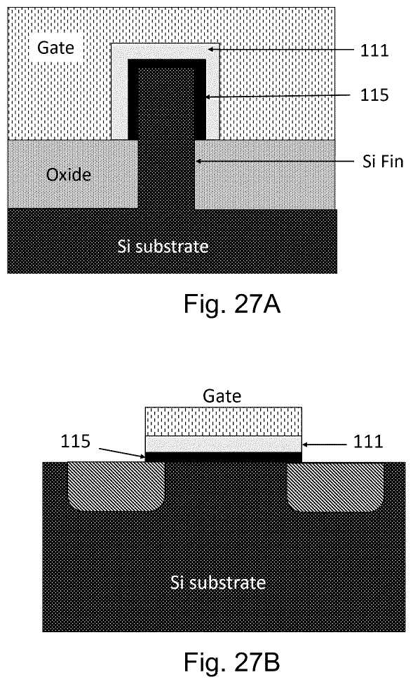

The role of the stabilizing film can extend beyond the realm of capacitors. As discussed earlier, this film plays a crucial role in stabilizing the thin dielectric, thereby enhancing performance. Its applications can be broad, including in MOSFETs, FinFETs, or any scenario demanding a thin and stable gate dielectric. The stabilizing layer thus helps to miniaturize the gate dielectric. FIG. 27A presents a cross-section of a FinFET device utilizing the dielectric stacking, while FIG. 27B showcases its application in a MOSFET device.

FIG. 27A shows the stabilization of gate oxide 115 in FinFET device using the stabilization film 110. The films are coated around the fin created on Si substrate. The placement of oxide with respect to the stabilizing film can be varied as in FIGS. 8A-8D.

FIG. 27B shows the application of stabilizing film in a MOSFET. The gate oxide 115 is stabilized with the stabilizing film 110 before applying metal contact for gate. The position of oxide with respect to stabilizing film can be varied as in FIGS. 8A-8D.

This written description uses examples to disclose the invention, including the best mode, and also to enable any person skilled in the art to practice the invention, including making and using any devices or systems and performing any incorporated methods. An element or function recited in the singular and proceeded with the word “a” or “an” should be understood as not excluding plural said elements or functions, unless such exclusion is explicitly recited.

References to “one embodiment” of the claimed invention should not be interpreted as excluding the existence of additional embodiments that also incorporate the recited features. Furthermore, the claims are but some examples that define the patentable scope of the invention. This scope may include and contemplate other examples that occur to those skilled in the art. Such other examples are intended to be within the scope of the claims if they have structural elements that do not differ from the literal language of the claims, or if they include equivalent structural elements with insubstantial differences from the literal language of the claims. Where quantitative values are specified for a parameter, this disclosure is to be interpreted as encompassing each value, as well as any span or range involving the set of parameters. Where “less than” a specified amount is required, that amount shall include the upper limit, and shall extend down to a minimum of one atom thickness or otherwise to meet the structural and functional claim language. Where “more than” or “at least” a specified amount is required, that shall include the specified amount, and any feasible larger amount. When a proper range is specified, it shall include both endpoints. Any specified distance or the word “about” shall be interpreted as ±10%, unless otherwise specified. The specification includes various embodiments which are exemplary, as well as optional disclosures, and invention may extend to any single embodiment or consistent combinations or subcombinations of features of multiple embodiments, in all of the available combinations and permutations.

Examples appear below that include certain elements or clauses one or more of which may be combined with other elements and clauses describe embodiments contemplated within the scope and spirit of this disclosure.

What is claimed is:

1. A capacitor, comprising:
a nanostructured conductive electrode, having a surface comprising nanostructured features, having a 3D surface area at least ten times greater than a projected surface area of the surface;
a counter-electrode;
a dielectric layer, conformed to the nanostructured features and being disposed between the nanostructured conductive electrode and the counter-electrode; and
a conformal stabilizing film adjacent to the dielectric layer, comprising at least one insulating layer and at least one semiconducting layer.

2. The capacitor according to claim 1, wherein at least one of:
the dielectric layer is formed by atomic layer deposition on the nanostructured conductive electrode, and the conformal stabilizing film is formed by atomic layer deposition over the dielectric layer; and
the conformal stabilizing film is formed by atomic layer deposition over the nanostructured conductive electrode, and the dielectric layer is formed by atomic layer deposition on the conformal stabilizing film.

3. The capacitor according to claim 1, wherein at least one of:
the conformal stabilizing film is formed adjacent to the nanostructured conductive electrode and a second conformal stabilizing film is formed adjacent to the counter-electrode, wherein the dielectric layer is disposed between the conformal stabilizing film and the second conformal stabilizing film; and
the dielectric layer is formed adjacent to the nanostructured conductive electrode and a second dielectric layer is formed adjacent to the counter-electrode, wherein the conformal stabilizing film is disposed between the dielectric layer and the second dielectric layer.

4. The capacitor according to claim 1, wherein the conformal stabilizing film is a nanolaminate comprising alternating layers of at least two different materials including the at least one insulating layer and at least one semiconducting layer.

5. The capacitor according to claim 4, wherein the nanolaminate comprises at least two of Al₂O₃, SiO₂, HfO₂, ZnO, SnO, ZrO, and TiO₂.

6. The capacitor according to claim 1, wherein the conformal stabilizing layer comprises the at least one insulating layer having a thickness of less than 1 nm and having a band gap of at least 5 eV, and the at least one semiconducting layer having a band gap of less than 4 eV, the at least one insulating layer and the at least one semiconducting layer having a difference in Gibbs free energy of at least 2%.

7. The capacitor according to claim 1, wherein the nanostructured features are dependent on at least one of zinc oxide nanorods, copper nanorods, and carbon nanotubes.

8. The capacitor according to claim 1, wherein the nanostructured surface comprises a set of hollow elongated non-interconnected recesses.

9. The capacitor according to claim 1, wherein the nanostructured features have an aspect ratio of at least 10.

10. The capacitor according to claim 1, wherein the nanostructured features are disposed in a regular array.

11. The capacitor according to claim 1, wherein the surface comprising nanostructured features comprises an array of cylindrical bores in a substrate.

12. The capacitor according to claim 1, wherein the surface comprising nanostructured features comprises an array of nanowires vertically extending from a substrate.

13. The capacitor according to claim 1, wherein the conformal stabilizing film comprises a layer having a bandgap of at least 5 eV.

14. The capacitor according to claim 1, wherein:
the nanostructured conductive electrode comprises 3D surface area increasing protrusions or invaginations; and
the conformal stabilizing film adjacent to the dielectric layer is disposed between the nanostructured conductive electrode and the counter-electrode, and comprises a plurality of different layers, comprising at least one insulating layer and at least one semiconducting layer.

15. The capacitor according to claim 1, further comprising:
a set of axially-aligned carbon nanotubes having a diameter of 10-100 nm and length of at least 10 μm provided as nanostructured features of the nanostructured conductive electrode; and
a conformal conductive layer is formed over the set of axially-aligned carbon nanotubes;
wherein:
the dielectric layer comprises a conformal dielectric has a thickness of between 2 nm and 1,000 nm;
the conformal stabilizing film comprises the at least one insulating layer having a thickness less than 1 nm and a band gap of at least 5 eV;
the counter electrode comprises a conductive layer formed over the conformal dielectric and the conformal stabilizing layer;
the at least one semiconducting layer has a thickness of less than 1 nm and a band gap of less than 4 eV; and
the at least one insulating layer and the at least one semiconducting layer have a respective difference in Gibbs free energy of more than 2%.

16. A method of forming a capacitor comprising:
providing a nanostructured conductive electrode, having a 3D surface area at least 10 times a projected surface area of the nanostructured conductive electrode, on a substrate;
depositing a dielectric layer conformed to the nanostructured conductive electrode;
depositing a stabilizing film comprising a plurality of different alternating layer types comprising an insulating layer type and a semiconducting layer type;
forming a counter-electrode over the deposited dielectric layer and stabilizing film; and
forming isolated electrical connections to the nanostructured conductive electrode and the counter-electrode.

17. A device, comprising:
a conductive or semiconducting lower layer;
a conductive electrode;
a dielectric layer; and
a conformal stabilizing film adjacent to the dielectric layer, comprising a plurality of alternating layers comprising at least one insulating layer and at least one semiconducting layer,
wherein the dielectric layer and the conformal stabilizing film are disposed between the conductive electrode and the conductive or semiconducting lower layer.

18. The device according to claim 17, wherein the conductive or semiconducting lower layer comprises a semiconducting lower layer, and wherein a potential applied to the conductive electrode modulates a property of the semiconducting lower layer.

19. The device according to claim 18, wherein the device comprises a field effect transistor having a channel conductivity modulated by a potential between the conductive electrode and the semiconducting lower layer.

20. The device according to claim 17, wherein the conductive or semiconducting lower layer comprises a conducting lower layer, and further comprising at least one second device, each second device comprising:
a second conductive electrode;
a second dielectric layer; and
a second conformal stabilizing film adjacent to the second dielectric layer, comprising a second plurality of alternating layers comprising at least one insulating layer and at least one semiconducting layer,
wherein the second dielectric layer and the second conformal stabilizing film are disposed between the second conductive lower layer and an underlying structure, and
the device and the at least one second device each being capacitors, formed in a monolithic stack, the monolithic stack having a number of second device adapted to achieve a desired capacitance value.
